(19) United States
(12) Patent Application Publication
(10) Pub. No.: US 2026/0348544 A1
(43) Pub. Date: Nov. 5, 2026

(54) LED LIGHTING DEVICE

(71) Applicant: JIAXING SUPER LIGHTING ELECTRIC APPLIANCE CO., LTD, Jiaxing (CN)

(72) Inventors: Yichuan Liu, Jiaxing (CN); Mingbin Wang, Guizhou (CN); Zixiang Zou, Shangrao (CN)

(21) Appl. No.: 19/109,152

(22) PCT Filed: Sep. 20, 2024
(86) PCT No.: PCT/CN2024/119953

§ 371 Date: Mar. 6, 2025

(30) Foreign Application Priority Data
Sep. 20, 2023 (CN) 202311223369.4
Sep. 27, 2023 (CN) 202311265259.4
Sep. 28, 2023 (CN) 202311278118.6
Dec. 8, 2023 (CN) 202311684075.1
Mar. 19, 2024 (CN) 202410311762.7
Sep. 14, 2024 (CN) 202411291428.6

(51) Int. Cl. F21S 9/02; F21V 3/04; F21V 5/00; F21V 7/22; F21V 15/01; F21V 23/00; F21V 23/06; F21Y 103/10; F21Y 115/10

(52) U.S. Cl. CPC F21S 9/022; F21V 3/049; F21V 5/002; F21V 7/22; F21V 15/01; F21V 23/005; F21V 23/008; F21V 23/06; F21Y 2103/10; F21Y 2115/10

(57) ABSTRACT

An LED lighting device, including: a support unit including a base and a back plate connected to the base and forms an accommodating space with the base; a photoelectric module connected to the support unit and including: a light-emitting unit including two light-emitting assembly, where the two light-emitting assemblies have two light output directions; a light processing unit disposed on a light output path of the light-emitting unit; one light-emitting assembly disposed on the base; and the other light-emitting assembly disposed in the accommodating space and having a light output direction toward the back plate.

### CROSS-REFERENCE TO RELATED APPLICATIONS

This application is a U.S. 371 national stage of prior application number PCT/CN2024/119953 filed on 2024 Sep. 20, which claims priority to the following Chinese Patent Applications Nos: CN 202311223369.4 filed on 2023 Sep. 20; CN 202311265259.4 filed on 2023 Sep. 27; CN 202311278118.6 filed on 2023 Sep. 28; CN 202311684075.1 filed on 2023 Dec. 8; CN 202410311762.7 filed on 2024 Mar. 19; CN 202411291428.6 filed on 2024 Sep. 14, the disclosures of which are incorporated herein in their entirety by reference.

### FIELD OF THE INVENTION

The invention relates to lighting apparatuses, particularly to an LED lighting device.

### BACKGROUND OF THE INVENTION

The LED lighting device is a kind of lamp with a light-emitting diode as a light source, which is widely used because of its advantages of energy conservation, long life, and the like. The flat panel lamp in the LED lighting device is a kind of lighting lamp that can be embedded in a ceiling, which is popular in people because of its characteristics of light weight, small thickness, large illumination area, and the like.

According to a flat panel lamp in the prior art, a light source is usually disposed in a middle region of the flat panel lamp, and an indoor environment is illuminated by light through a corresponding light output surface in the middle region. Such flat panel lamp has disadvantages that only one light output surface is provided, and the light in the illuminated indoor environment is not uniform, for example, the middle region is too bright and a peripheral region is relatively dim in the indoor environment.

To solve the problem of uneven light, a bat-wing diffusing film is added on lighting device to achieve a bat-wing light distribution. Such bat-wing diffusing film is a kind of diffusing film with a special microprism surface structure, which has high costs and poor appearance. Moreover, due to its double-sided microstructure, the bat-wing diffusing film needs to be fixed with a transparent plate as a support. To form a bat-wing light pattern, the bat-wing diffusing film also needs to be designed in position and curvature based on the light output surface of lighting device. Therefore, the structural design of the lamp is also relatively complex.

In addition, as the light source is disposed in the middle region of the flat panel lamp in the prior art, the light-emitting surface provides uneven illumination due to the light-emitting angle of light-emitting diodes, so that some regions (especially surrounding regions) on a base plate of the flat panel lamp are not illuminated by light, resulting in dark regions. To solve the problem of dark regions, generally a light-emitting direction of the light-emitting diodes is changed by adding lenses. However, this way of adding a lens structure makes the flat panel lamp complex in structural design and unattractive in appearance.

In the prior art, a lampshade is often connected to a lamp body after the overall structure of the lamp body is assembled, which has a problem of insufficient stability of connection.

In summary, considering the shortcomings and defects of the flat panel lamp in the prior art, how to design a flat panel lamp to form a uniform light pattern and/or avoid dark regions and improve the reliability of the lamp is an urgent technical problem that needs to be solved by the technical personnel in the present application.

### SUMMARY OF THE INVENTION

Many embodiments of the present application are briefly described herein. However, the term “the present application” is only for a description of some embodiments (whether to be already in the claims) disclosed in this specification, rather than a complete description of all possible embodiments. Some embodiments described above as various features or aspects of the present application may be combined in different ways to form an LED lamp or a part thereof.

An objective of an embodiment of the present application is to provide an LED lighting device, including:
a support unit including a base and a back plate that is disposed around the base and forms an accommodating space with the base; and
a photoelectric module connected to the support unit and including:
a light-emitting unit including at least two of a first light-emitting assembly, a second light-emitting assembly, or a third light-emitting assembly, where the at least two light-emitting assemblies have at least two light output angles;
a light processing unit disposed on a light output path of the light-emitting unit; the first light-emitting assembly disposed on the base; and
the third light-emitting assembly disposed in the accommodating space and having a light output direction facing the support unit.

In an embodiment of the present application, the support unit further includes a support structure vertically disposed on the base, and the third light-emitting assembly is disposed on the support structure.

In an embodiment of the present application, the support structure is configured as a support plate vertically fixed to the base, and has a first mounting surface and a second mounting surface.

In an embodiment of the present application, the third light-emitting assembly emits light towards the back plate.

In an embodiment of the present application, a center line of a light beam of the first light-emitting assembly is perpendicular to the base.

In an embodiment of the present application, a center line of a light beam of the third light-emitting assembly has an included angle with the center line of the light beam of the first light-emitting assembly.

In an embodiment of the present application, the center line of the light beam of the third light-emitting assembly is perpendicular to the center line of the light beam of the first light-emitting assembly.

In an embodiment of the present application, the first mounting surface and the second mounting surface are two opposite surfaces of the support structure, at least one group of the third light-emitting assemblies is disposed on the first mounting surface, and at least one group of the third light-emitting assemblies is disposed on the second mounting surface.

In an embodiment of the present application, the light processing unit includes a diffusing member and a shading assembly, where the diffusing member is connected and fixed to the shading assembly.

In an embodiment of the present application, the shading assembly includes a shading portion and a frame portion that may be set to be of an integrally formed metal frame structure.

An LED lighting device is provided in an embodiment of the present application, including:
a support unit including a base and a back plate disposed around the base; and
a photoelectric module connected to the support unit and including: a first light-emitting assembly and a second light-emitting assembly that are disposed on the base, where the second light-emitting assembly is located on a peripheral side of the first light-emitting assembly and is inclined relative to the first light-emitting assembly, so that light emitted from the second light-emitting assembly is distributed in a peripheral region of the first light-emitting assembly; and
a light processing unit including a diffusing member, where the diffusing member includes a first diffusing member disposed in a light output direction of the first light-emitting assembly, and a second diffusing member disposed in a light output direction of the second light-emitting assembly.

In an embodiment of the present application, the base has a bottom surface and a first bottom surface sidewall, the first bottom surface sidewall has a first inclination angle relative to the bottom surface, the first light-emitting assembly is disposed on the bottom surface, and the second light-emitting assembly is disposed on the first bottom surface sidewall.

In an embodiment of the present application, the first inclination angle is set to 15° to 45°.

In an embodiment of the present application, there are at least two groups of the first light-emitting assemblies arranged on the bottom surface in parallel.

In an embodiment of the present application, the base further has a second bottom surface sidewall connected to the first bottom surface sidewall and having a second inclination angle relative to the first bottom surface sidewall.

In an embodiment of the present application, the first light-emitting assembly includes a first circuit board and a first light-emitting body disposed on the first circuit board; and the second light-emitting assembly includes a second circuit board and a second light-emitting body disposed on the second circuit board.

In an embodiment of the present application, the diffusing member is configured to diffuse light emitted from the first light-emitting assembly and/or the second light-emitting assembly.

In an embodiment of the present application, the light processing unit includes a light beam control assembly disposed on a light output side of the second light-emitting assembly and configured to change a path of at least part of the light emitted from the second light-emitting assembly, so that the light emitted from the second light-emitting assembly and projected to an underlying region of the first light-emitting assembly is changed to be projected to the peripheral region of the first light-emitting assembly.

In an embodiment of the present application, the light beam control assembly includes a serrated lens.

In an embodiment of the present application, the light beam control assembly includes a total internal reflection lens.

An LED lighting device is provided in an embodiment of the present application, including:
a support unit including a base and a back plate stacked on the base, where the height of the base is greater than the height of the back plate; and
a photoelectric module connected to the support unit and including:
a light source board including a groove and an upper end surface symmetrical to the groove, where the upper end surface is provided with a first light-emitting assembly including a first circuit board and a first light-emitting body; and an outer sidewall of the groove is provided with a second light-emitting assembly including a second circuit board and a second light-emitting body; and
a light processing unit at least partially covering a light-emitting unit, where a surface of the light processing unit is provided with an optical microarray structure.

In an embodiment of the present application, the upper end surface and a surface of the groove are perpendicular to each other.

In an embodiment of the present application, a light output direction of the first light-emitting assembly is different from a light output direction of the second light-emitting assembly.

In an embodiment of the present application, the support unit further includes a back plate disposed on the support unit and provided with a reflective surface for secondary distribution of light emitted from the photoelectric module.

In an embodiment of the present application, the back plate has a protrusion, an accommodating cavity is formed between the protrusion and the base, and a power supply module is disposed inside the protrusion and fixed to the base.

In an embodiment of the present application, a sensing device is further included, where the sensing device senses an external environmental state to regulate light emitted from the lamp.

In an embodiment of the present application, the power supply module includes a power supply circuit board and an energy storage battery disposed on the power supply circuit board, where the power supply circuit board is further provided with an emergency power supply module including an emergency power supply and the energy storage battery that are disposed on the power supply circuit board, and the emergency power supply is electrically connected to the energy storage battery.

An LED lighting device is provided in an embodiment of the present application, including:
a support unit including a base, a back plate, and a sidewall, where the base has a bottom surface, the back plate is connected to the base, and the sidewall, the base, and the back plate are connected to form an accommodating space; and
a photoelectric module including a light-emitting unit and a light processing unit, where the light-emitting unit includes at least one first light-emitting assembly and at least one second light-emitting assembly, and the light processing unit includes a diffusing member that covers the light-emitting unit,
where the bottom surface has a bottom plate mounting portion with a top surface parallel to the bottom surface and a side surface inclined relative to the bottom surface, the first light-emitting assembly is disposed on the top surface, and the second light-emitting assembly is disposed on the side surface; and
at least a part of light emitted from the second light-emitting assembly is emitted from the diffusing member and projected to the back plate.

In an embodiment of the present application, the photoelectric module further includes a power supply module disposed on a back surface of the support unit, where the power supply module includes a power supply box and a junction box, and the power supply box is integrally formed with the junction box and is perpendicular to the junction box.

In an embodiment of the present application, two ends of the diffusing member are provided with diffusing member end caps, and the diffusing member end caps and the diffusing member form an enclosed space with the bottom surface.

In an embodiment of the present application, the diffusing member end cap is provided with a sensing device.

In an embodiment of the present application, a shortest distance from the light-emitting unit to a long edge of the diffusing member is La, and a vertical distance from the long edge of the diffusing member to an edge of the back plate is Lb, where 0.5≤Lb/La≤2.

In an embodiment of the present application, if a distance from the bottom surface to a highest point of the back plate is set to Lc, then 1<La/Lc≤2, or 1≤La/Lc≤6.

In summary, the LED lighting device disclosed in the present application is provided with the third light-emitting assembly of which the center line of the light beam faces the support unit of the LED lighting device, so that regions on the support unit that cannot be illuminated by the first light-emitting assembly can be illuminated, thereby improving the uniformity of light on the surface of the support unit, and avoiding dark regions.

Those skilled in the art can readily gain insight into other aspects and advantages of the present application from the detailed description below. The detailed description below only displays and describes exemplary embodiments of the present application. As will be recognized by those skilled in the art, the content of the present application enables those skilled in the art to make modifications to the disclosed specific embodiments without departing from the spirit and scope of the invention involved in the present application. Correspondingly, the descriptions in the drawings and specification of the present application are merely exemplary and not restrictive.

### BRIEF DESCRIPTION OF DRAWINGS

At least one specification heading is required. Please delete this heading section if it is not applicable to your application. For more information regarding the headings of the specification, please see MPEP 608.01(a).

### Detailed Description of the Invention

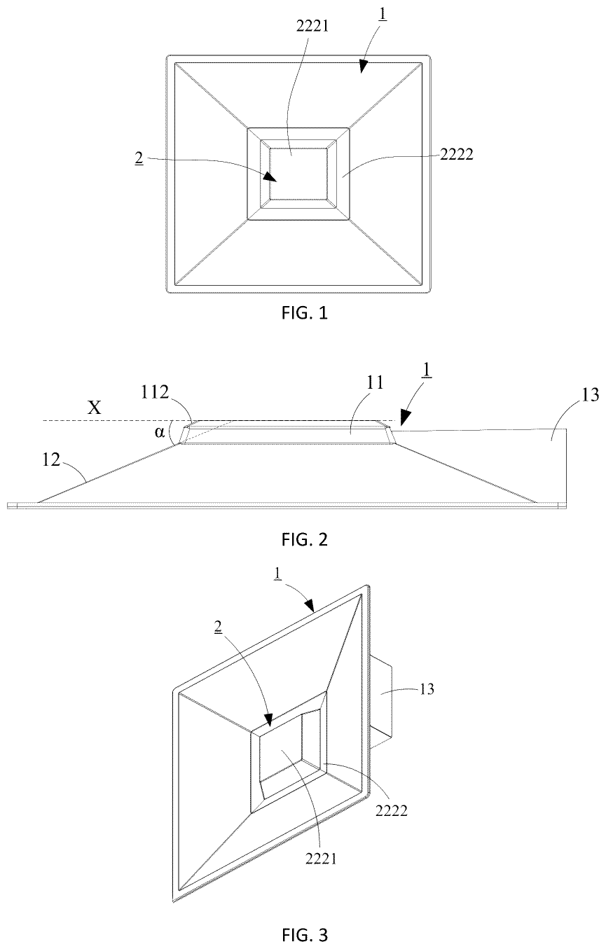

FIG. 1 shows a schematic front view of an LED lighting device in an embodiment of the present application;

FIG. 2 shows a schematic left view of an LED lighting device in an embodiment of the present application;

FIG. 3 shows a schematic diagram of a three-dimensional structure of an LED lighting device in an embodiment of the present application;

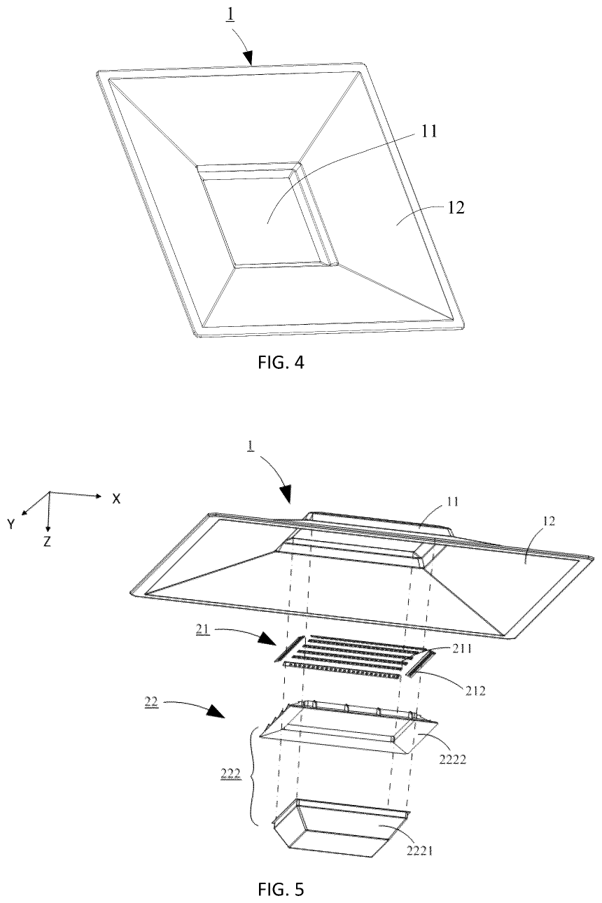

FIG. 4 shows a schematic diagram of a support unit in an embodiment of the present application;

FIG. 5 shows a schematic diagram of a split structure of an LED lighting device in an embodiment of the present application;

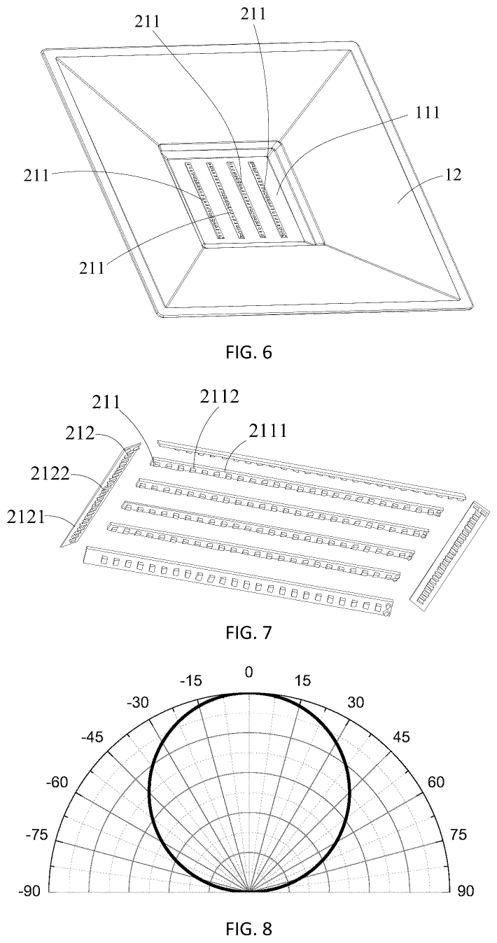

FIG. 6 shows a schematic diagram of a three-dimensional structure of combination of a light-emitting unit and a support unit in an embodiment of the present application;

FIG. 7 shows a schematic diagram of a three-dimensional structure of a light-emitting unit in an embodiment of the present application;

FIG. 8 shows a light pattern diagram of a first light-emitting assembly in an embodiment of the present application;

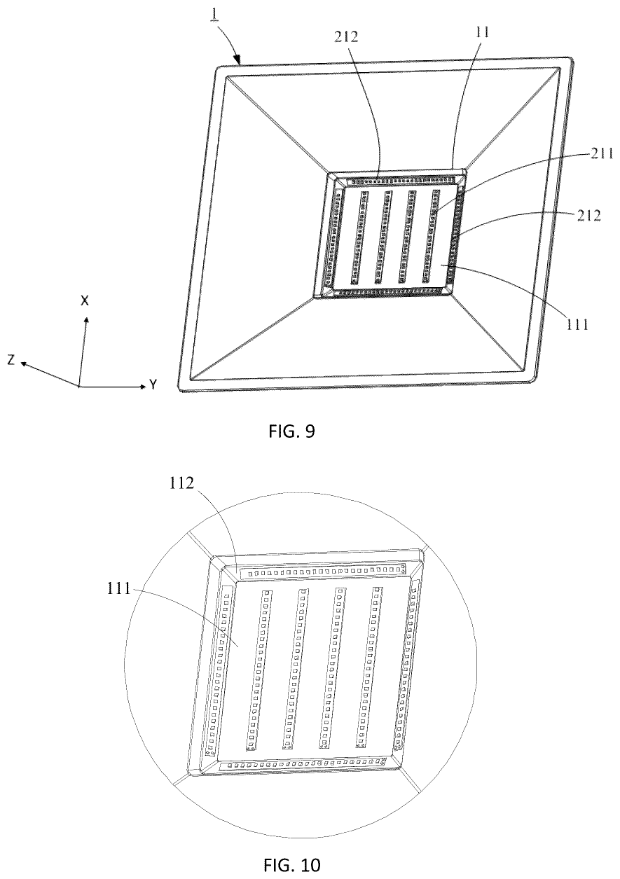

FIG. 9 shows a schematic diagram of a three-dimensional structure of combination of a light-emitting unit and a support unit in an embodiment of the present application;

FIG. 10 shows a partial enlarged view of a base and a light-emitting unit in the embodiment of the present application shown in FIG. 9;

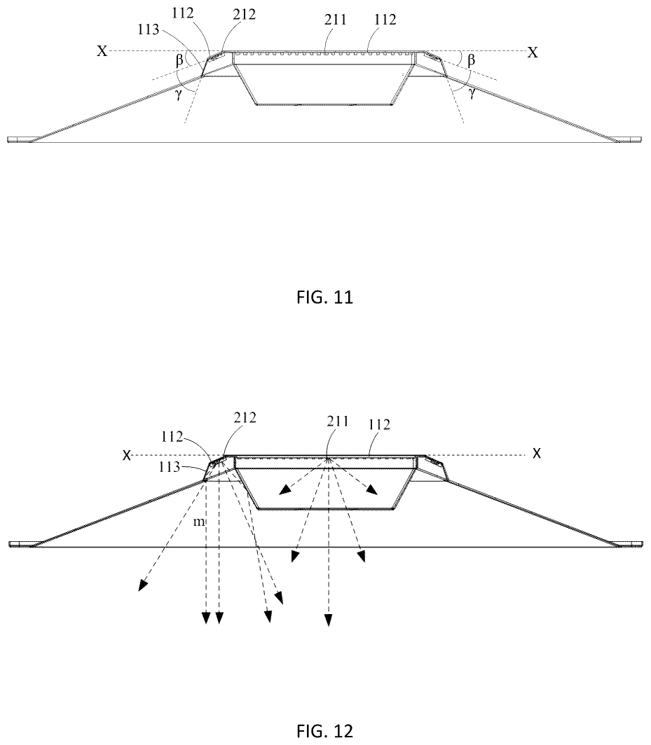

FIG. 11 shows a schematic diagram of a sectional structure of an LED lighting device along an X-axis direction in an embodiment of the present application;

FIG. 12 shows a schematic light-emitting diagram of an LED lighting device in the embodiment of the present application shown in FIG. 11;

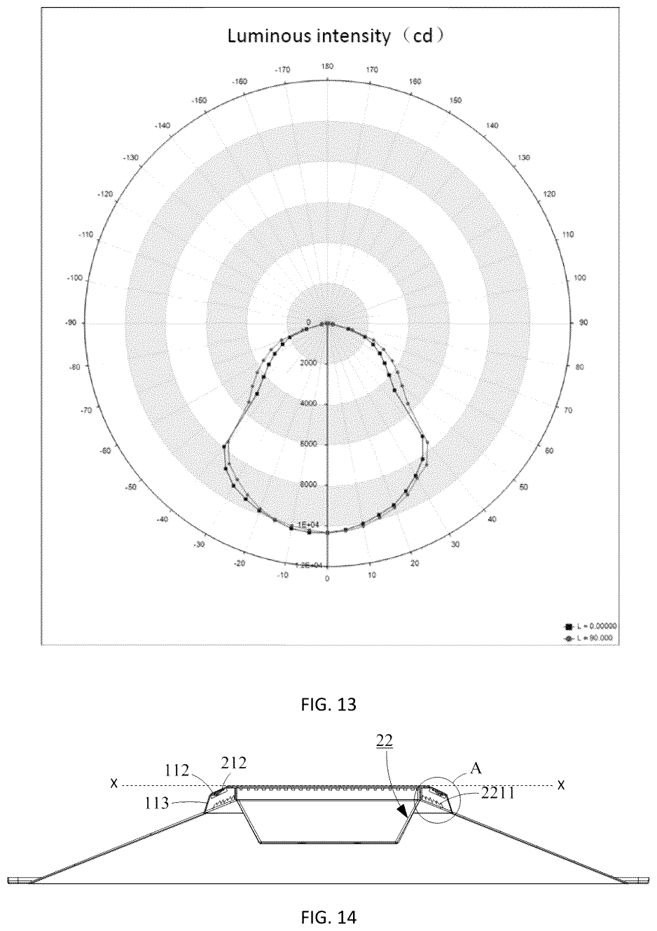

FIG. 13 shows a light pattern diagram of an LED lighting device in the embodiment of the present application shown in FIG. 11;

FIG. 14 shows a schematic diagram of a sectional structure of an LED lighting device with a light beam control assembly along an X-axis direction in an embodiment of the present application;

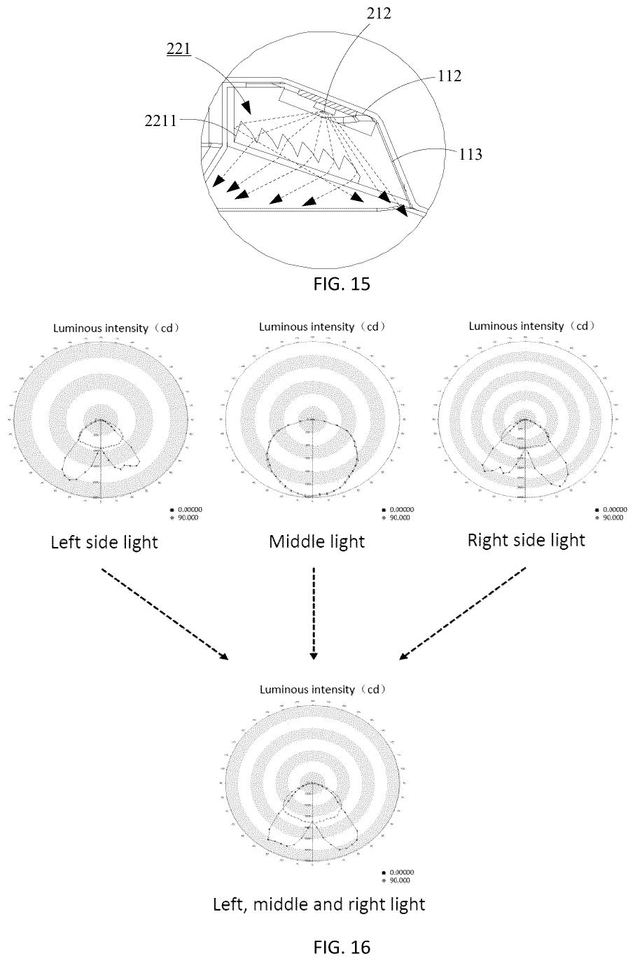

FIG. 15 shows a partial enlarged view of a part A in the embodiment of the present application shown in FIG. 14;

FIG. 16 shows a light pattern diagram of an LED lighting device in the embodiment of the present application shown in FIG. 14;

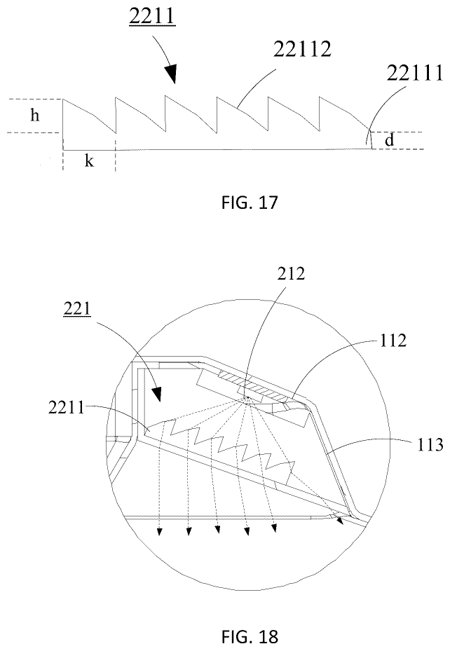

FIG. 17 shows a schematic structural diagram of a serrated lens in an embodiment of the present application;

FIG. 18 shows a schematic diagram of a partial structure of combination of a serrated lens and a second light-emitting unit in an embodiment of the present application;

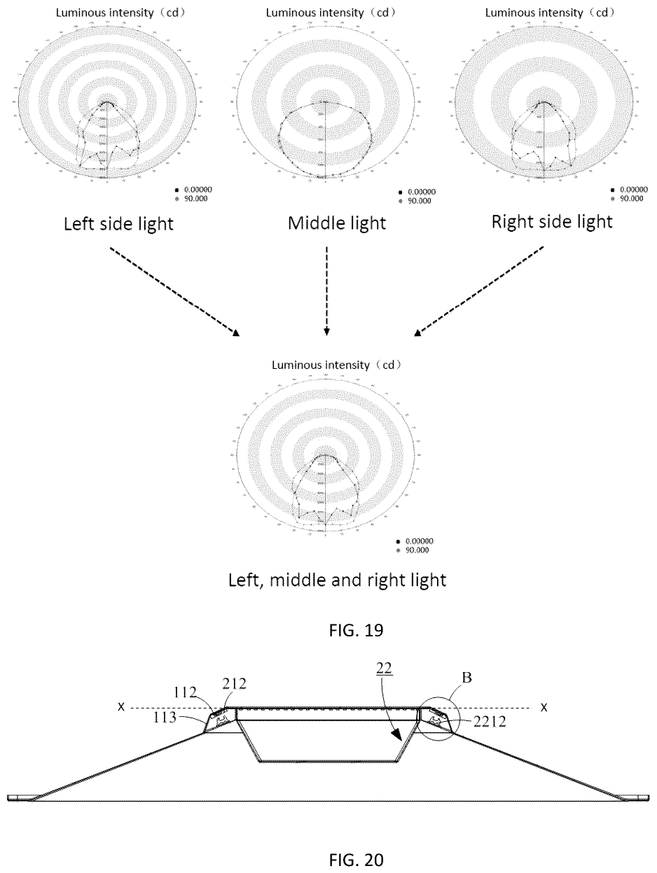

FIG. 19 shows a light pattern diagram of an LED lighting device in the embodiment of the present application shown in FIG. 18;

FIG. 20 shows a schematic diagram of a sectional structure of an LED lighting device with a light beam control assembly along an X-axis direction in an embodiment of the present application;

FIG. 21 shows a partial enlarged view of a part B in the embodiment of the present application shown in FIG. 20;

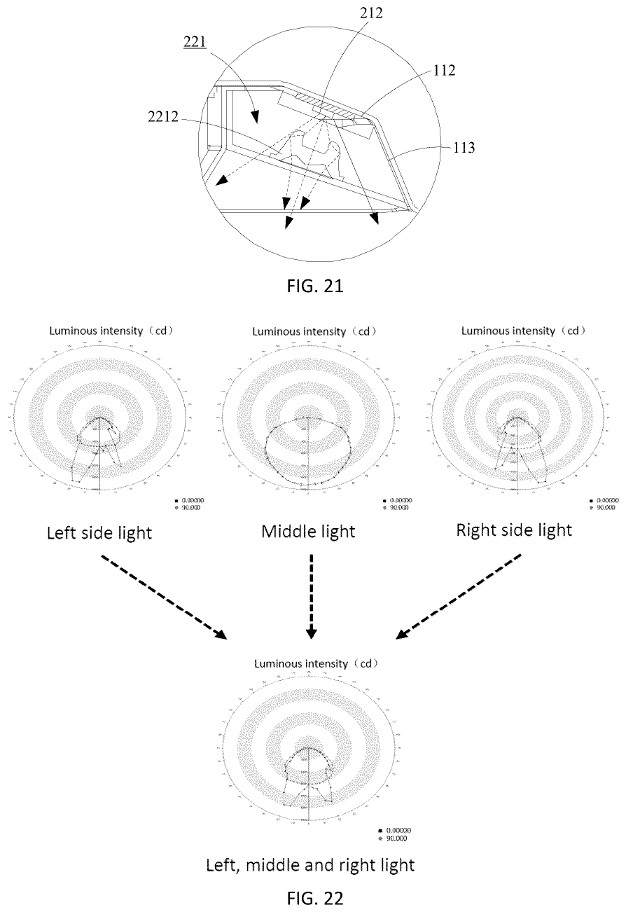

FIG. 22 shows a light pattern diagram of an LED lighting device in the embodiment of the present application shown in FIG. 20;

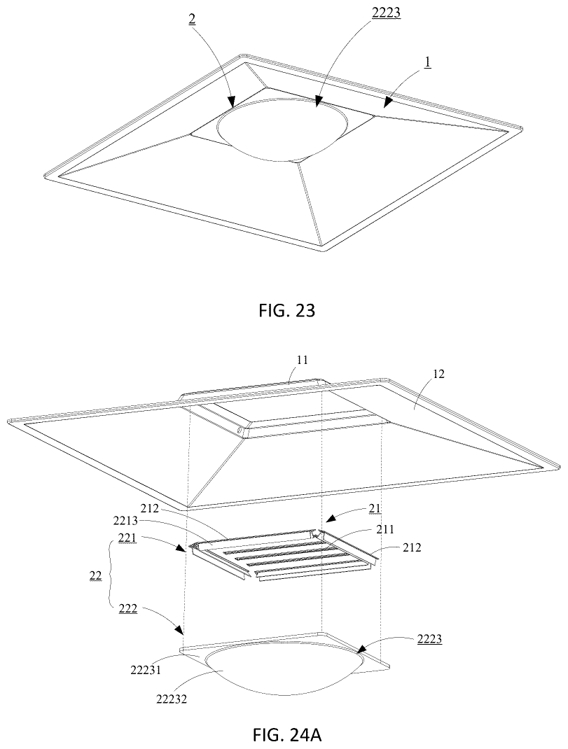

FIG. 23 shows a schematic diagram of a three-dimensional structure of an LED lighting device in an embodiment of the present application;

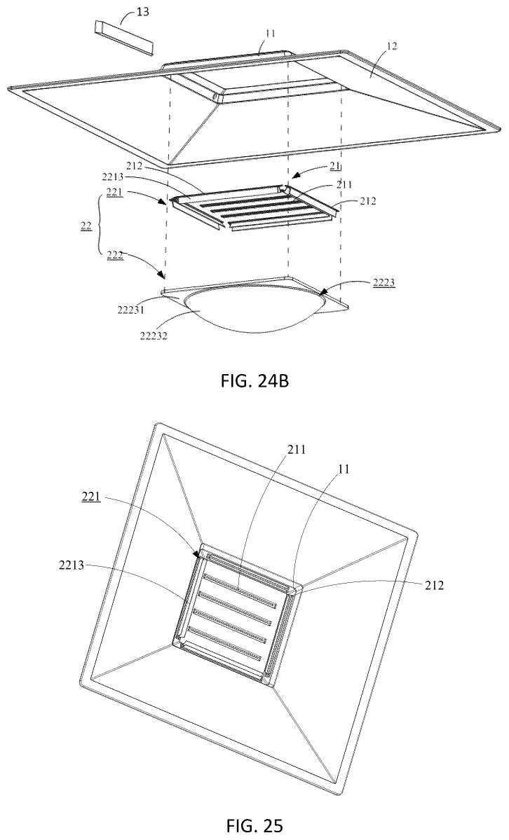

FIG. 24A shows a schematic diagram of a split structure of an LED lighting device in an embodiment of the present application;

FIG. 24B shows a schematic diagram of a split structure of an LED lighting device in another embodiment of the present application;

FIG. 25 shows a schematic diagram of a three-dimensional structure of combination of a light-emitting unit and a light beam control assembly and a support unit in an embodiment of the present application;

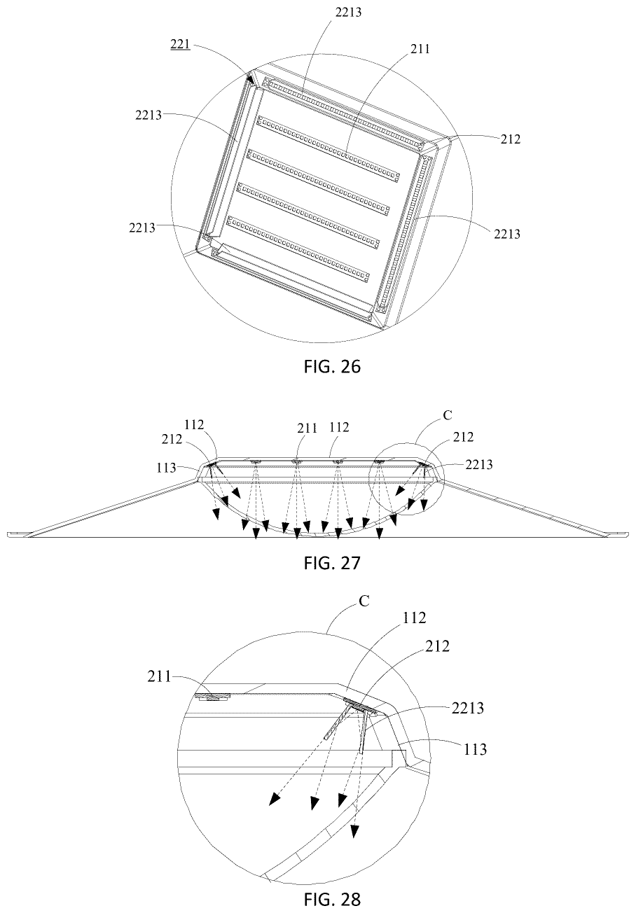

FIG. 26 shows a partial enlarged view of a base and a photoelectric module in the embodiment of the present application shown in FIG. 25;

FIG. 27 shows a schematic diagram of a sectional structure of an LED lighting device in an embodiment of the present application;

FIG. 28 shows a partial enlarged view of a part C in the embodiment of the present application shown in FIG. 27;

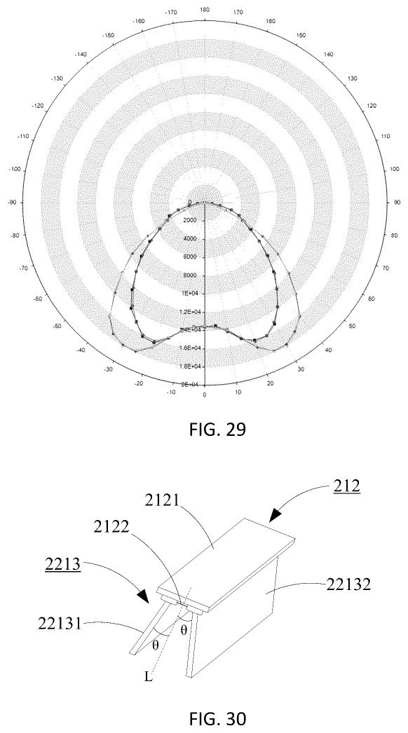

FIG. 29 shows a light pattern diagram of an LED lighting device in the embodiment of the present application shown in FIG. 27;

FIG. 30 shows a schematic diagram of a three-dimensional structure of combination of a light reflecting structure and a second light-emitting assembly in an embodiment of the present application;

FIG. 31A shows a light pattern diagram of an LED lighting device where a first inclination angle β is 45° and an inclination angle θ is 15°;

FIG. 31B shows a light pattern diagram of an LED lighting device where a first inclination angle β is 45° and an inclination angle θ is 25°;

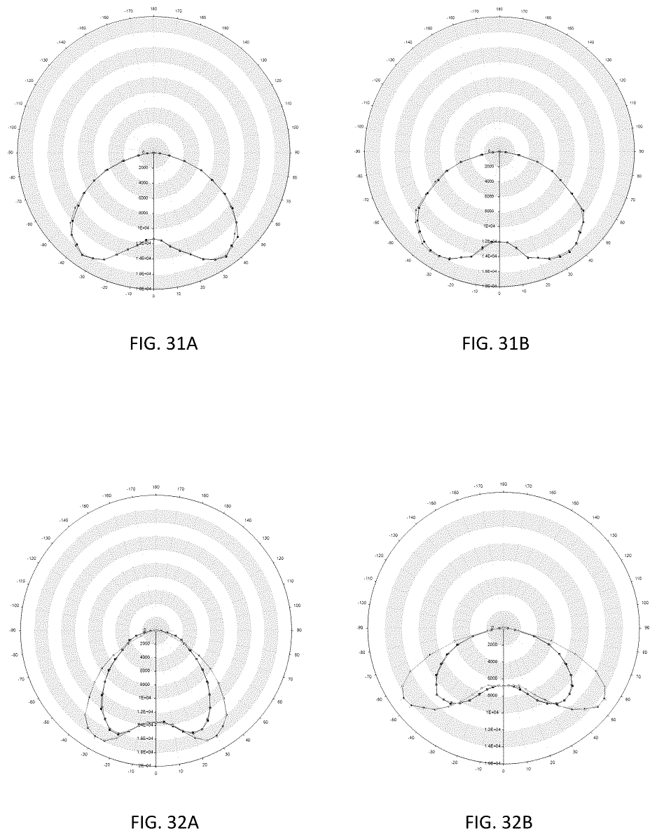

FIG. 32A shows a light pattern diagram of an LED lighting device with a first inclination angle β is 30°;

FIG. 32B shows a light pattern diagram of an LED lighting device with a first inclination angle β is 45°;

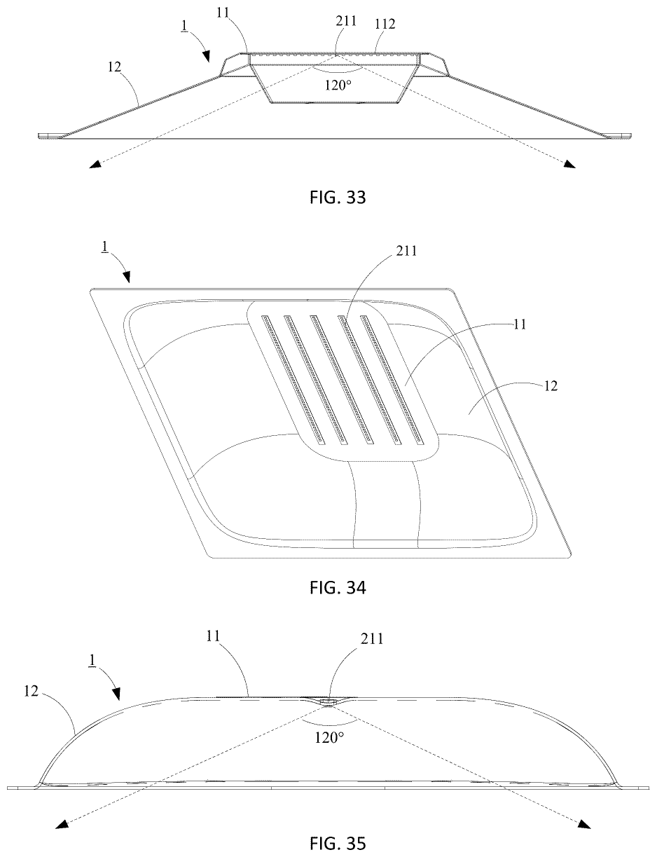

FIG. 33 shows a schematic diagram of light output from a first light-emitting assembly in the embodiment of the present application shown in FIG. 6;

FIG. 34 shows a schematic diagram of a three-dimensional structure of match between a first light-emitting assembly and a support unit in an embodiment of the present application;

FIG. 35 shows a schematic diagram of light output from a first light-emitting assembly in the embodiment of the present application as shown in FIG. 34;

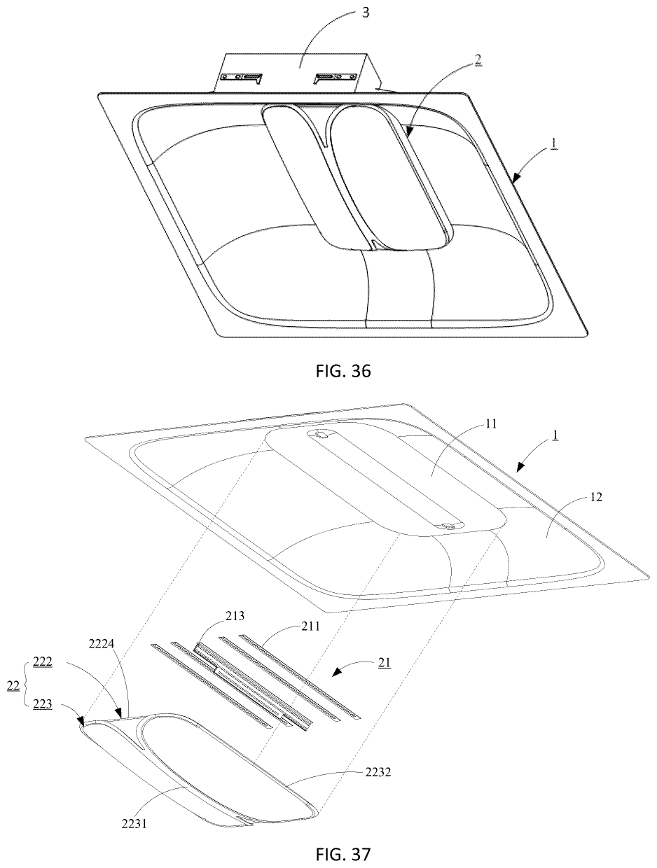

FIG. 36 shows a schematic diagram of a three-dimensional structure of an LED lighting device in an embodiment of the present application;

FIG. 37 shows a schematic diagram of a split structure of an LED lighting device in the embodiment of the present application shown in FIG. 36;

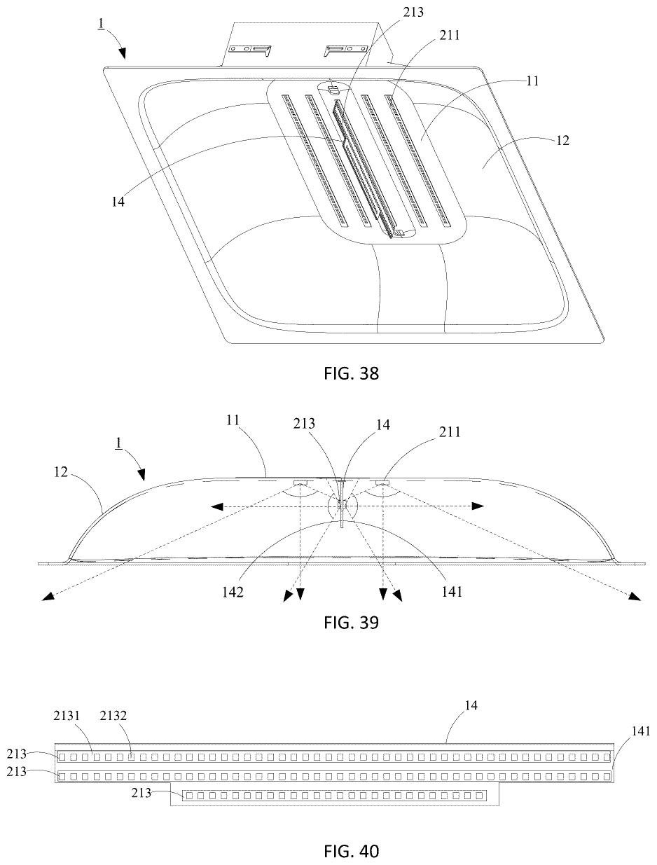

FIG. 38 shows a schematic diagram of a three-dimensional structure of combination of a third light-emitting assembly and a support unit in an embodiment of the present application;

FIG. 39 shows a schematic diagram of light output from a first light-emitting assembly and a third light-emitting assembly in the embodiment of the present application shown in FIG. 36;

FIG. 40 shows a schematic structural diagram of combination of a third light-emitting assembly and a support structure in an embodiment of the present application;

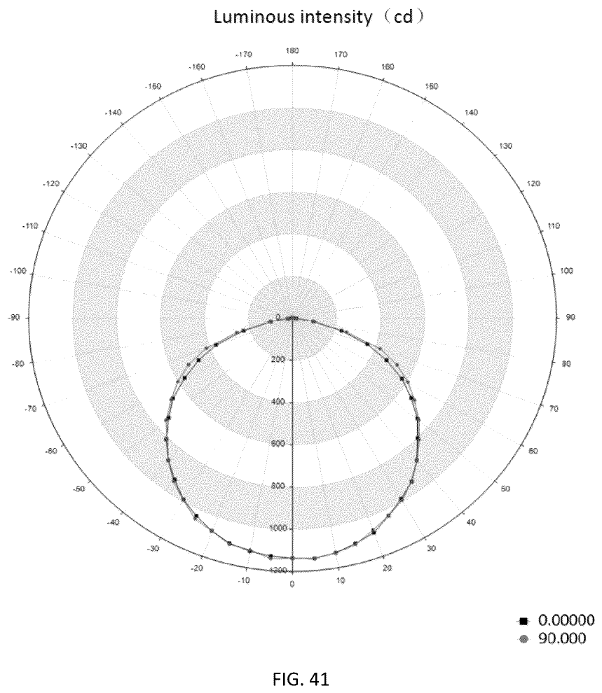

FIG. 41 shows a light pattern diagram of an LED lighting device in the embodiment of the present application shown in FIG. 36;

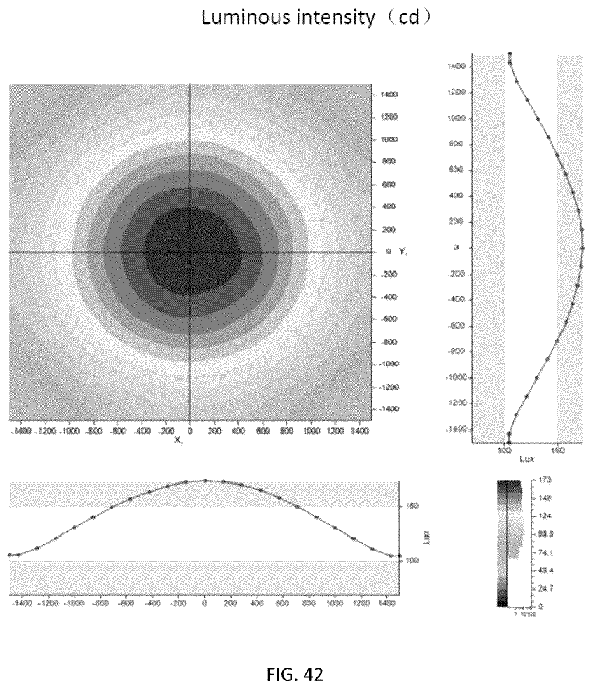

FIG. 42 shows an illuminance diagram of an illuminated surface at a part 2.5 m from an LED lighting device in the embodiment of the present application shown in FIG. 36;

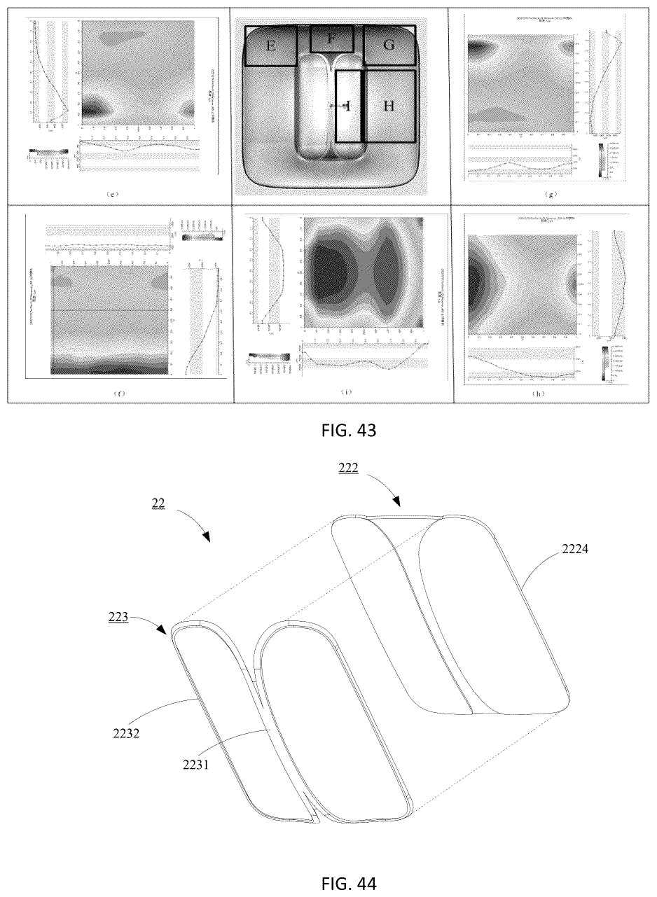

FIG. 43 shows an illuminance diagram of various regions in an LED lighting device in the embodiment of the present application shown in FIG. 36;

FIG. 44 shows a schematic diagram of a split structure of a light processing unit in the embodiment of the present application shown in FIG. 37;

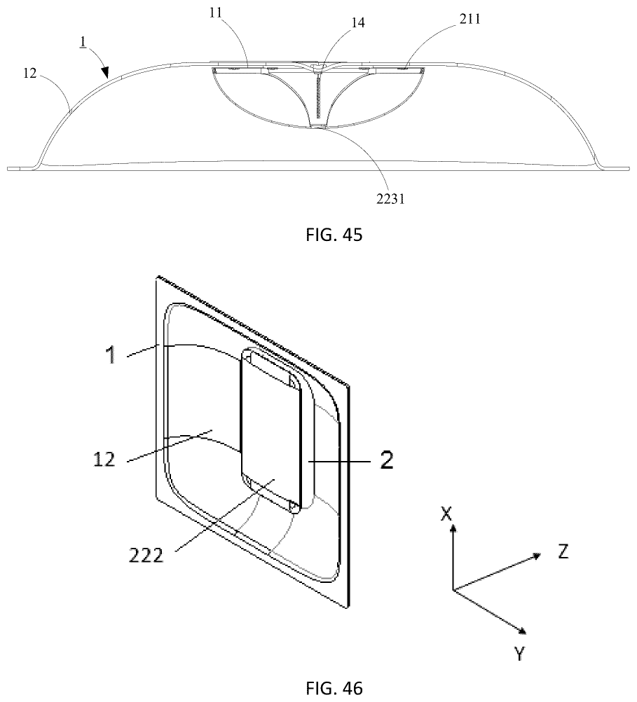

FIG. 45 shows a schematic diagram of a sectional structure of an LED lighting device in the embodiment of the present application shown in FIG. 36;

FIG. 46 is a schematic diagram of a three-dimensional structure of an LED lighting device in an embodiment of the present application;

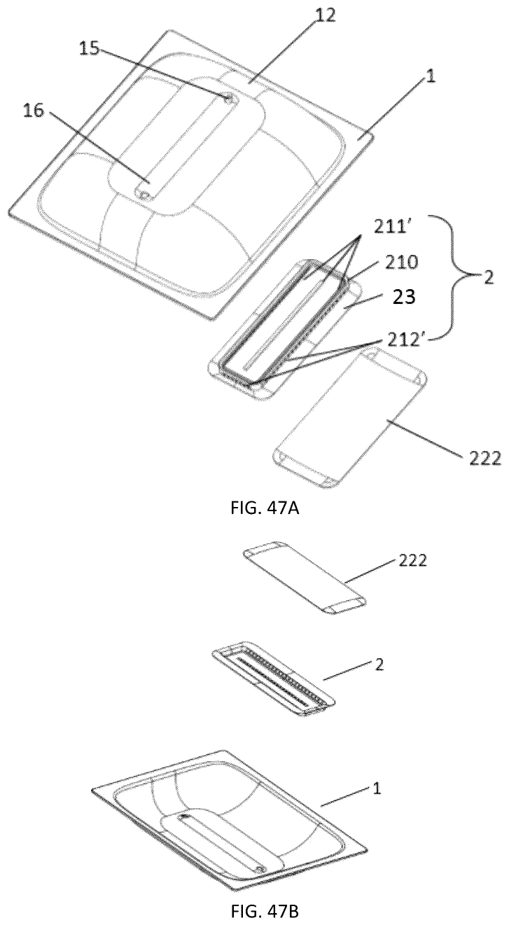

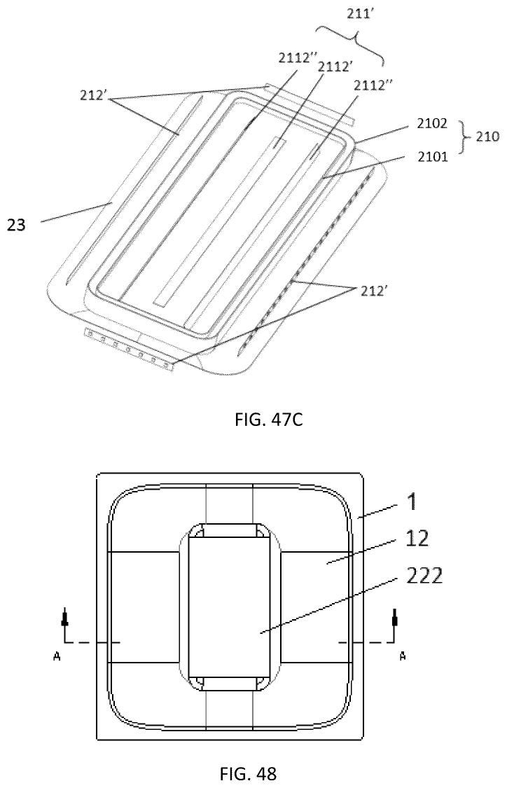

FIG. 47A is a schematic diagram of an exploded structure of an LED lighting device in an embodiment of the present application from one perspective;

FIG. 47B is a schematic diagram of an exploded structure of an LED lighting device in an embodiment of the present application from another perspective;

FIG. 47C is a schematic exploded view of a photoelectric unit of an LED lighting device in an embodiment of the present application;

FIG. 48 is a front view of an LED lighting device in an embodiment of the present application;

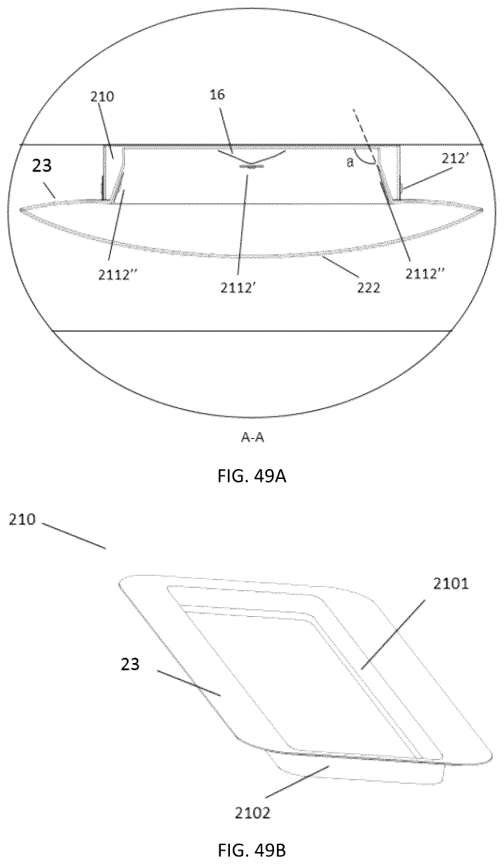

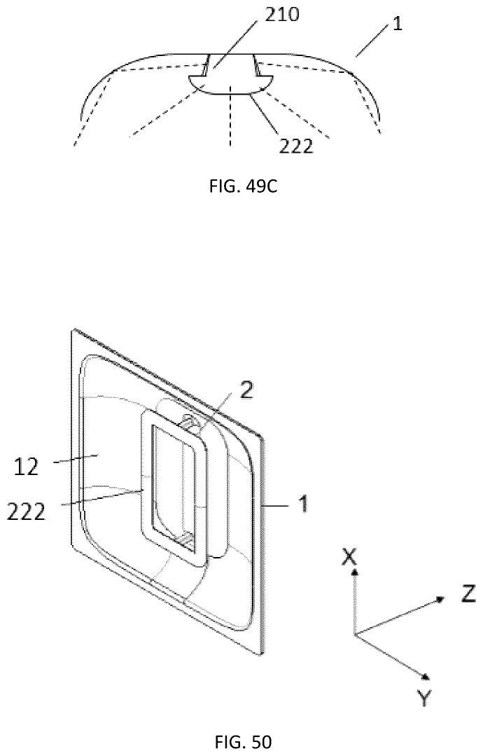

FIG. 49A is a sectional diagram of a partial sectional structure along A-A in FIG. 48;

FIG. 49B is a schematic structural diagram of a first bracket in an embodiment of the present application;

FIG. 49C is a schematic diagram of brief light emission in an embodiment of the present application;

FIG. 50 is a schematic diagram of a three-dimensional structure of an LED lighting device in an embodiment of the present application;

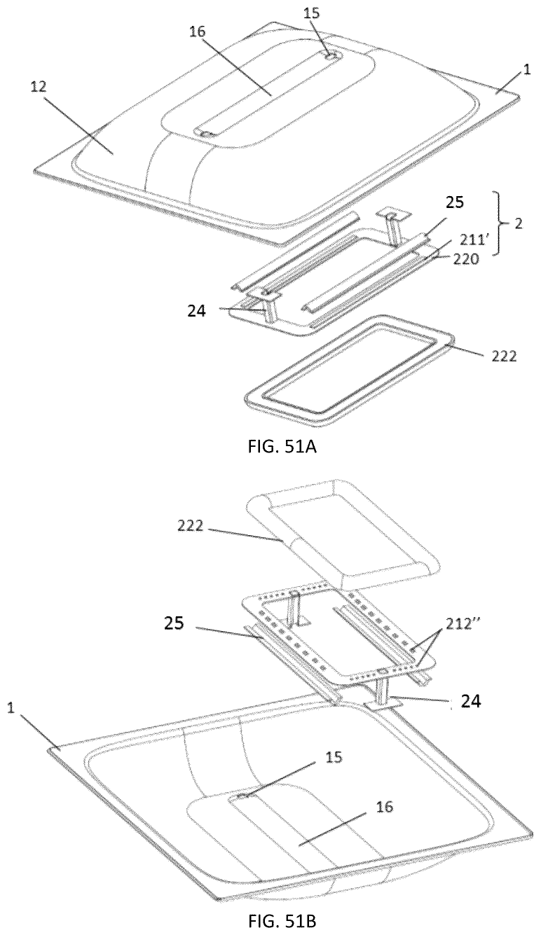

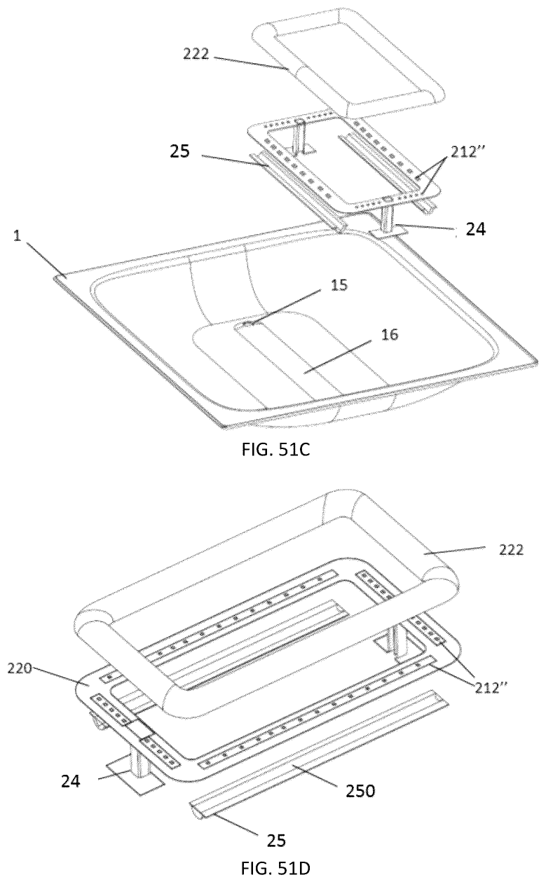

FIG. 51A is a schematic diagram of an exploded structure of an LED lighting device in an embodiment of the present application from one perspective;

FIG. 51B is a schematic diagram of an exploded structure of an LED lighting device in an embodiment of the present application from another perspective;

FIG. 51C is a schematic diagram of an exploded structure of other components of an LED lighting device without a support unit in an embodiment of the present application;

FIG. 51D is a schematic diagram of an exploded structure of an LED lighting device without a support unit in an embodiment of the present application from another perspective;

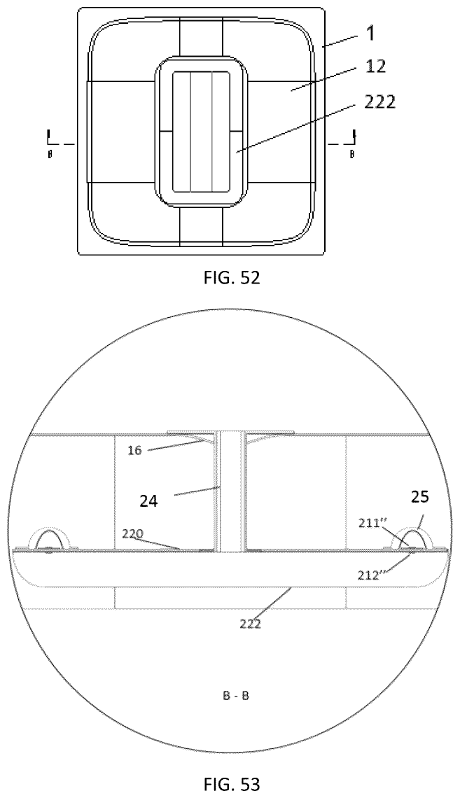

FIG. 52 is a front view of an LED lighting device in an embodiment of the present application;

FIG. 53 is a schematic diagram of a partial sectional structure along B-B in FIG. 52;

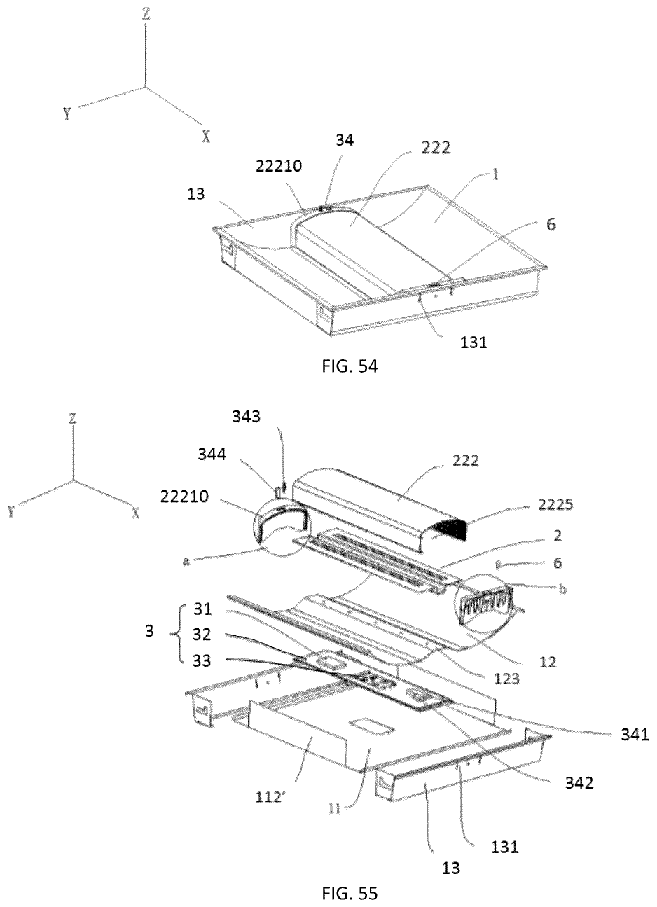

FIG. 54 is a schematic three-dimensional view of an LED lighting device in an embodiment of the present application;

FIG. 55 is a schematic diagram of an exploded structure of an LED lighting device in an embodiment of the present application;

FIG. 56 is a schematic partial enlarged view of part a in FIG. 55;

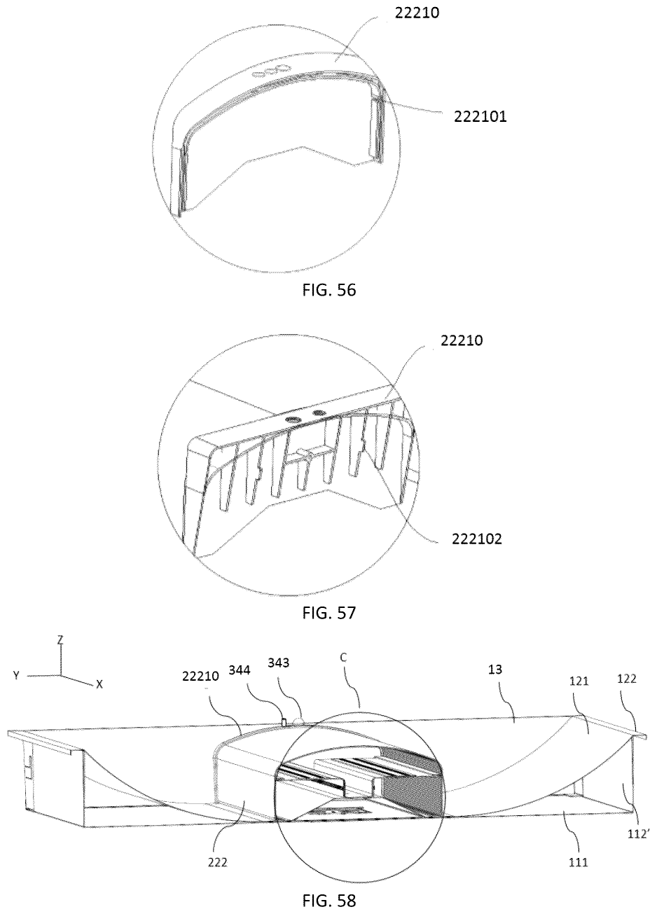

FIG. 57 is a schematic partial enlarged view of part b in FIG. 55;

FIG. 58 is a schematic diagram of a three-dimensional sectional structure of an LED lighting device in an embodiment of the present application;

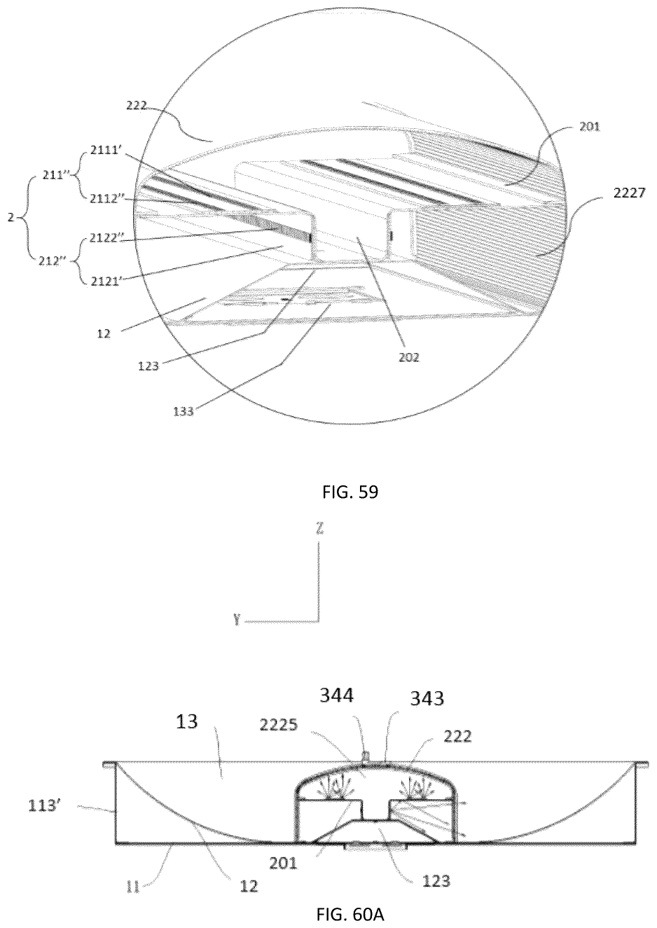

FIG. 59 is a schematic partial enlarged view of part c in FIG. 58;

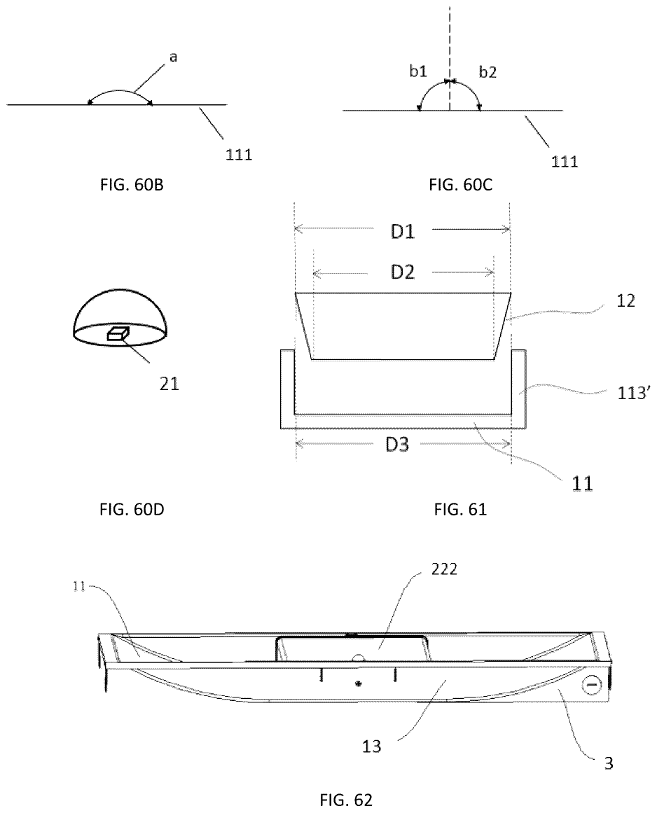

FIG. 60A is a schematic sectional view of an LED lighting device in an embodiment of the present application;

FIG. 60B is a schematic diagram of a coverage range of a light output angle in an embodiment of the present application;

FIG. 60C is a schematic diagram of a coverage range of a light output angle in an embodiment of the present application;

FIG. 60D is a schematic diagram of a coverage range of a light output angle in an embodiment of the present application;

FIG. 61 is a schematic diagram of a side structure of a base plate in an embodiment of the present application;

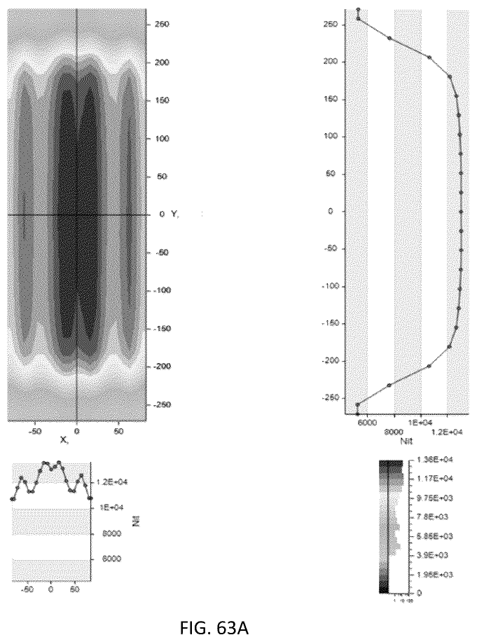

FIG. 62 is a schematic diagram of a three-dimensional structure of an embodiment of the present application;

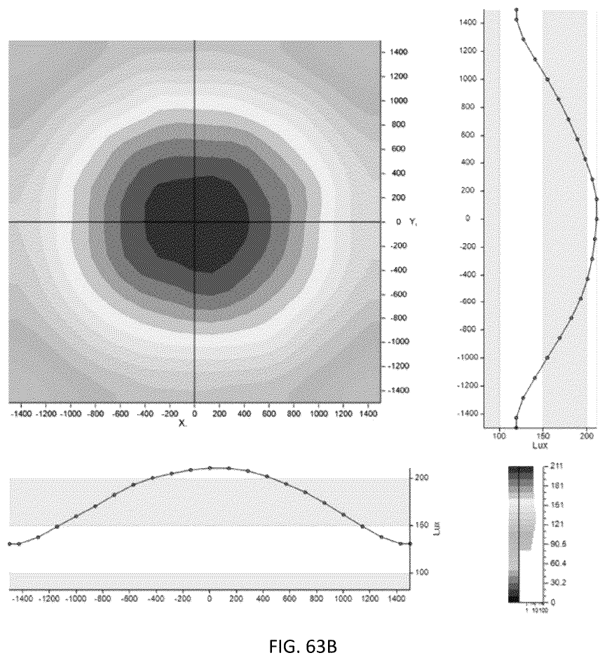

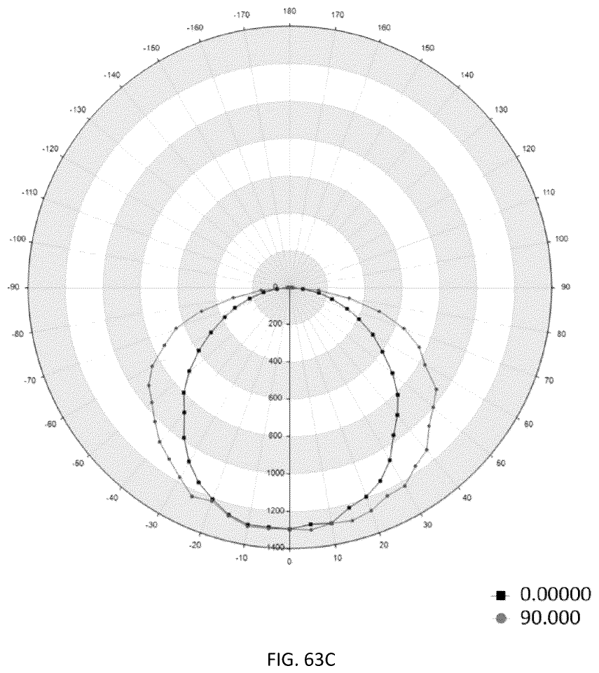

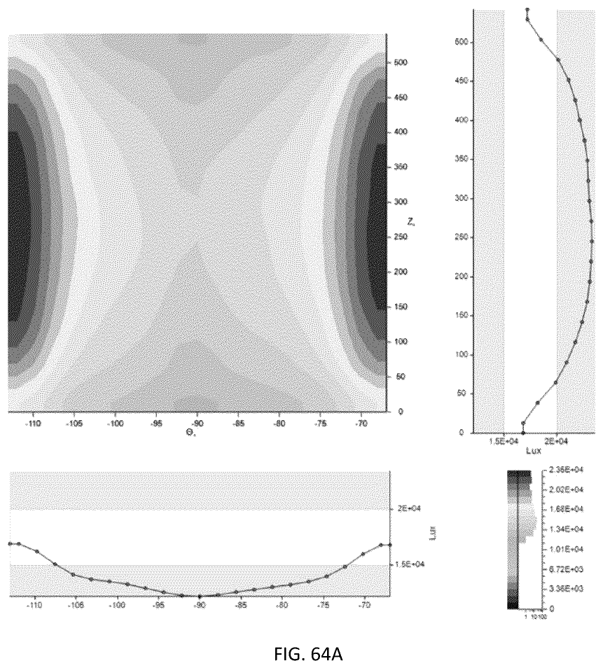

FIG. 63A is a schematic diagram of surface brightness of a lampshade in a square lampshade state in an embodiment of the present application;

FIG. 63B is a schematic diagram of illuminance of an illuminated surface at distance 2.5 m from a lampshade in a square lampshade state in an embodiment of the present application;

FIG. 63C is a schematic diagram of a light distribution curve in a square lampshade state in an embodiment of the present application;

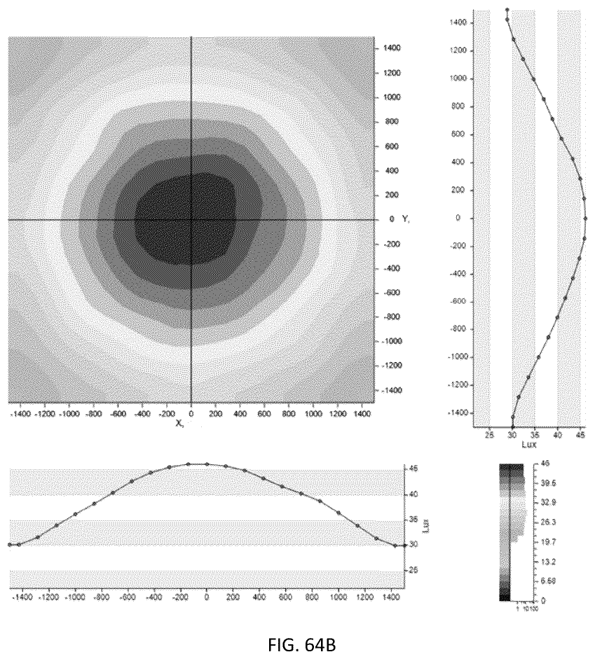

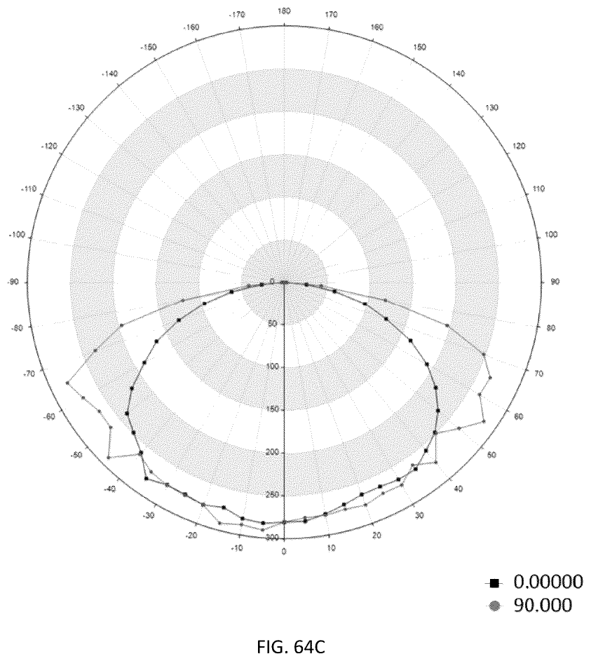

FIG. 64A is a schematic diagram of surface brightness of a lampshade in an arc-shaped lampshade state in an embodiment of the present application;

FIG. 64B is a schematic diagram of illuminance of an illuminated surface at distance 2.5 m from a lampshade in an arc-shaped lampshade state in an embodiment of the present application;

FIG. 64C is a schematic diagram of a light distribution curve in an arc-shaped lampshade state in an embodiment of the present application;

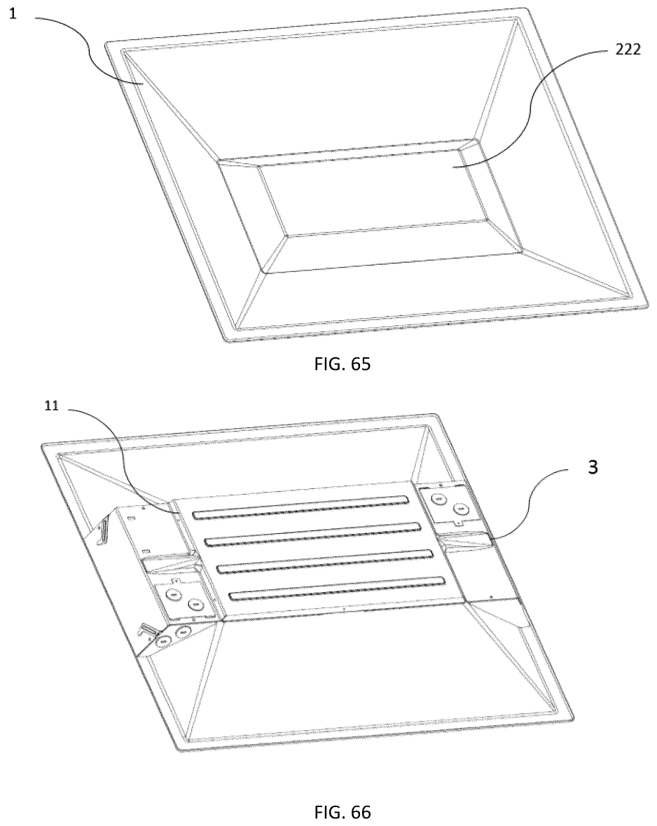

FIG. 65 is a schematic front view of an LED lighting device in an embodiment of the present application;

FIG. 66 is a schematic back view of an LED lighting device in an embodiment of the present application;

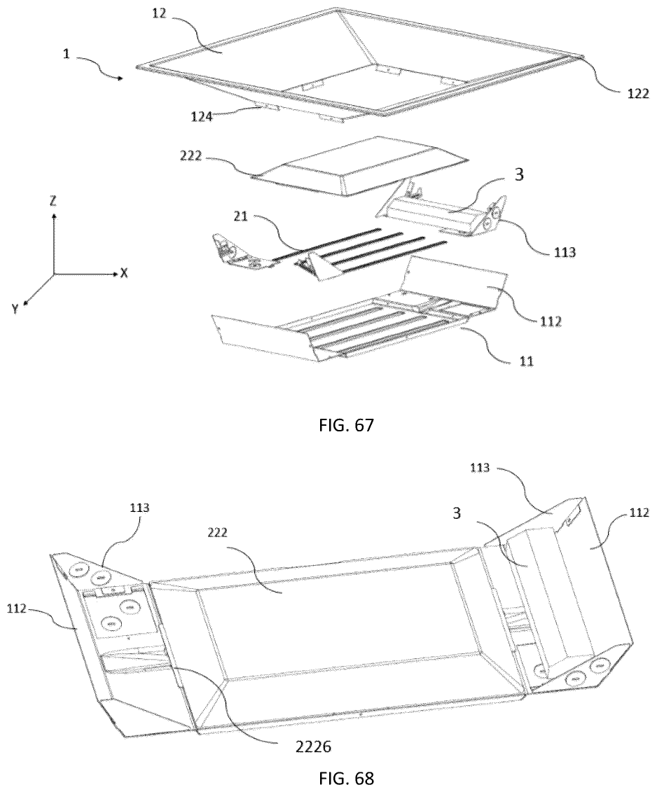

FIG. 67 is an exploded view of an LED lighting device in a front direction in an embodiment of the present application;

FIG. 68 is a schematic structural diagram of an LED lighting device after combination of a bottom plate and a diffusing member 222 in an embodiment of the present application;

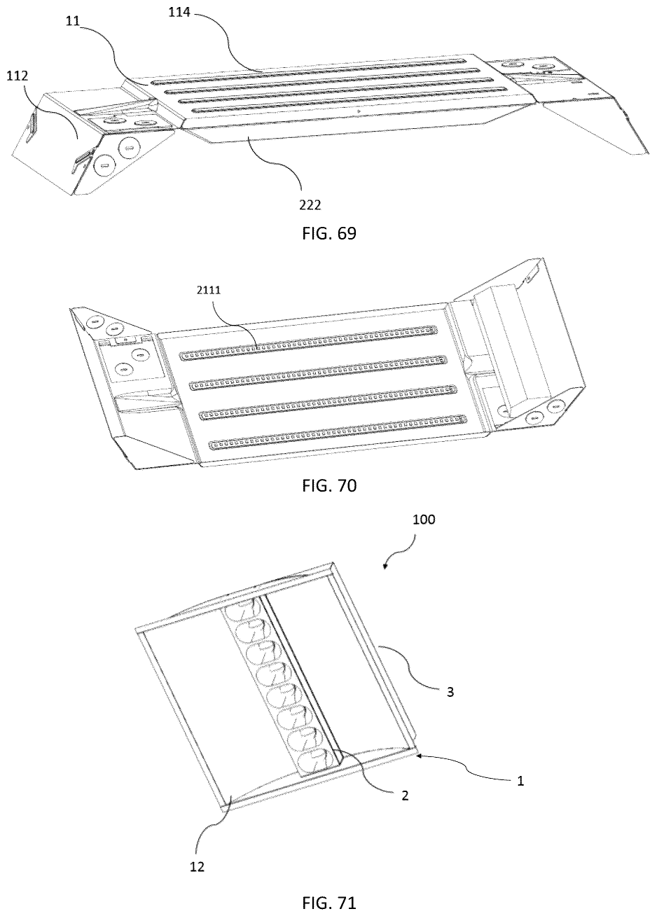

FIG. 69 is a schematic structural diagram of an LED lighting device after combination of a bottom plate and a diffusing member in an embodiment of the present application from another perspective;

FIG. 70 is a schematic diagram in which a light-emitting unit is disposed in a reinforcing structure in an embodiment of the present application;

FIG. 71 shows a schematic structural diagram of an LED lighting device in an embodiment of the present application;

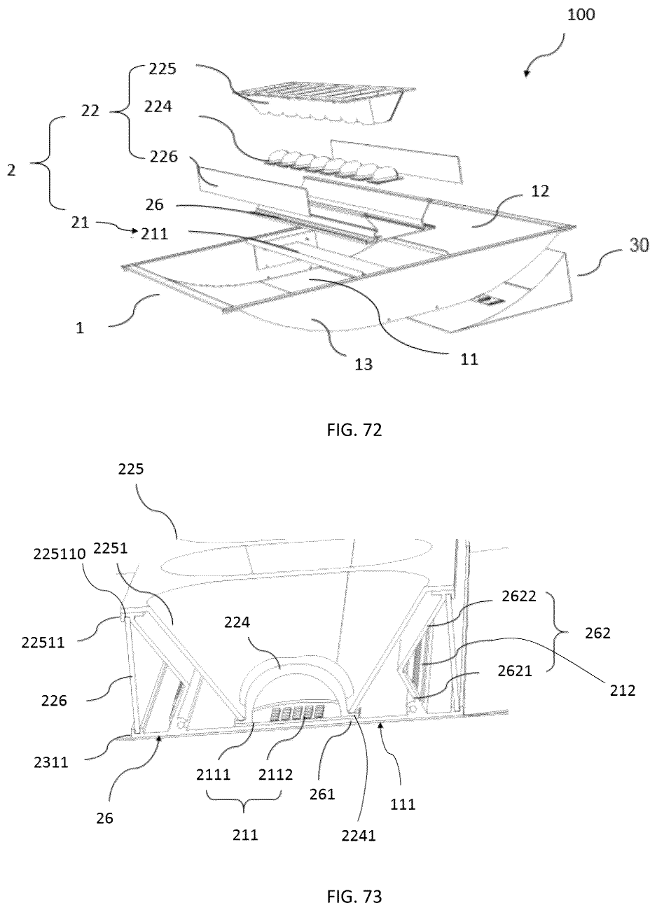

FIG. 72 shows a schematic exploded view of an LED lighting device in an embodiment of the present application;

FIG. 73 shows a schematic diagram of a transverse section of an optical assembly in an embodiment of the present application;

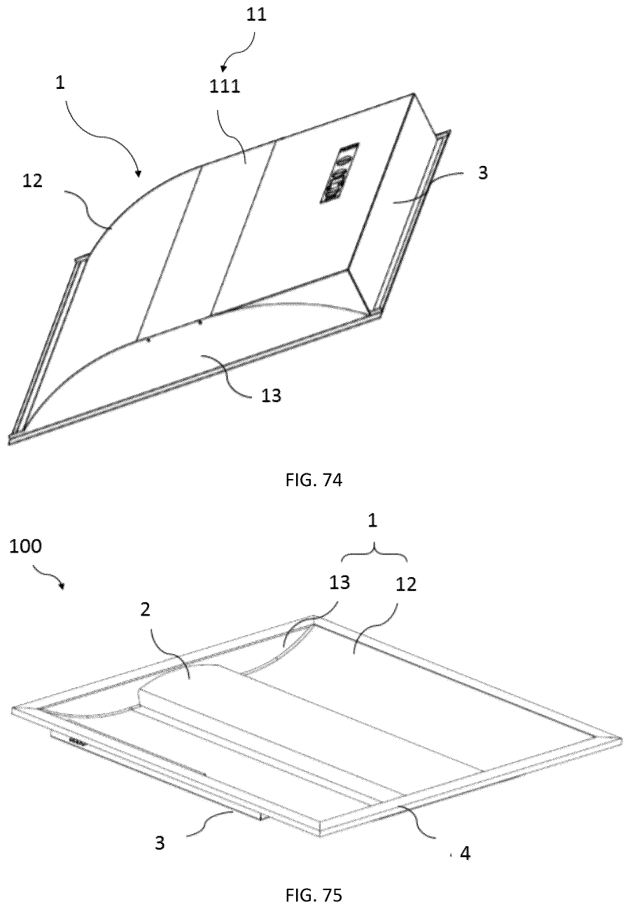

FIG. 74 shows a schematic back view of an LED lighting device in an embodiment of the present application;

FIG. 75 shows a schematic front view of an LED lighting device in an embodiment of the present application;

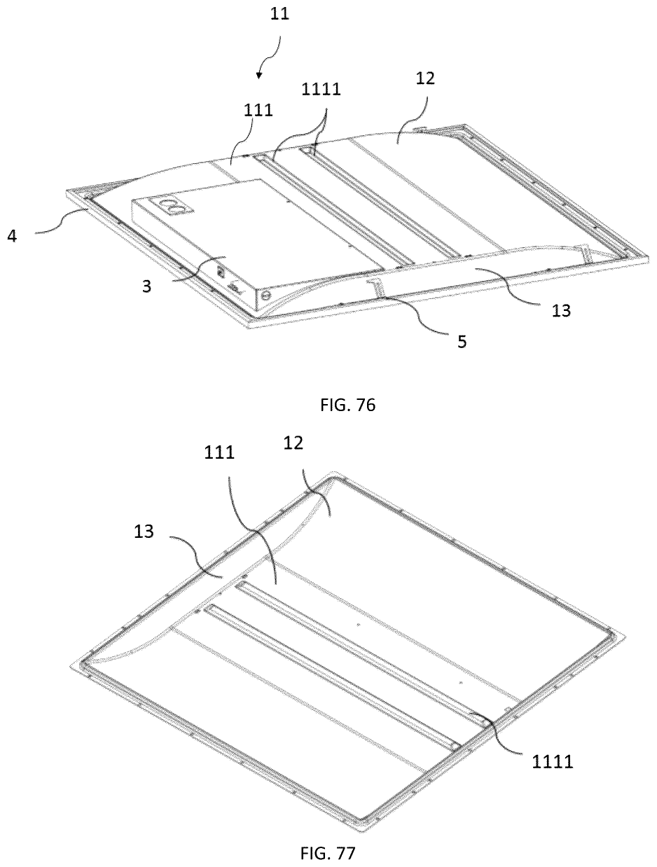

FIG. 76 shows a schematic back view of an LED lighting device in an embodiment of the present application;

FIG. 77 shows a schematic structural diagram of a base plate in an embodiment of the present application;

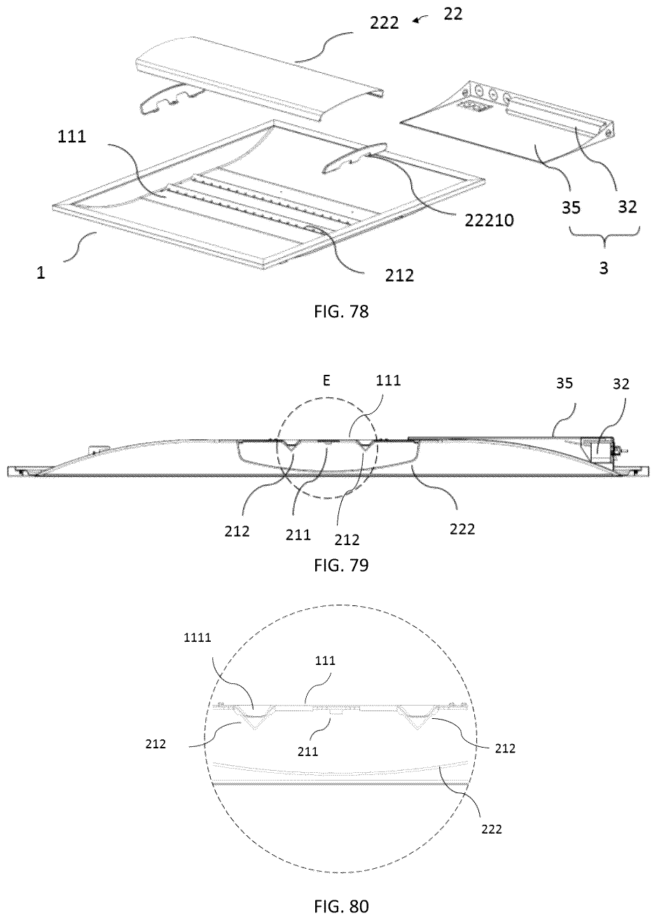

FIG. 78 shows an exploded view of an LED lighting device in an embodiment of the present application;

FIG. 79 shows a sectional view of an LED lighting device along a direction parallel to a sidewall in an embodiment of the present application;

FIG. 80 shows a partial enlarged view of part E of the present application in FIG. 79;

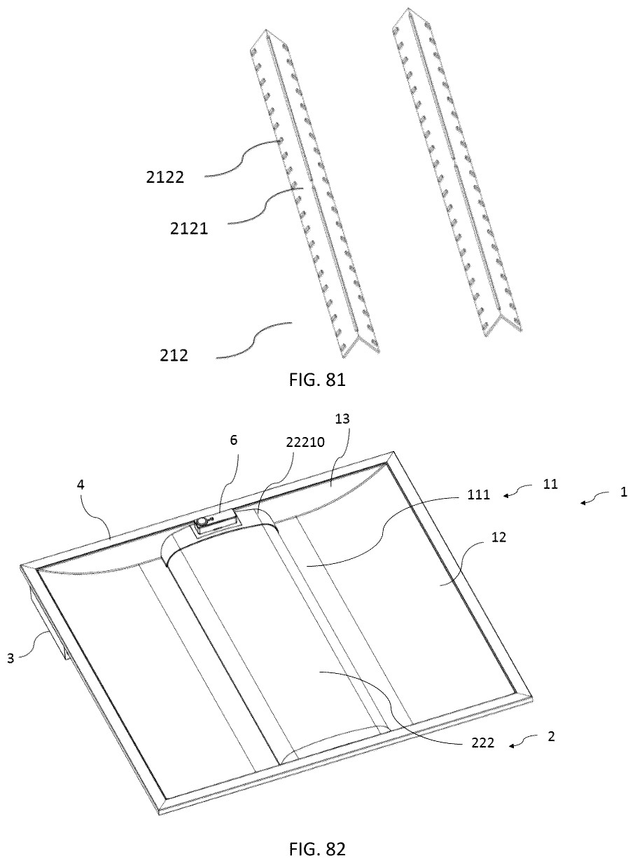

FIG. 81 shows a schematic diagram of second light source in an embodiment of the present application;

FIG. 82 is a schematic front view of an LED lighting device in an embodiment of the present application;

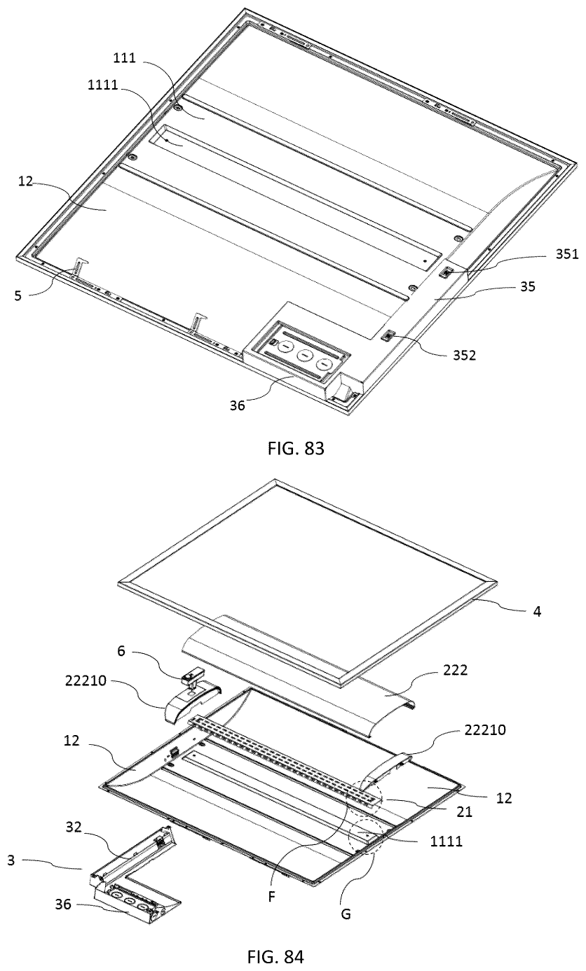

FIG. 83 is a schematic back view of an LED lighting device in an embodiment of the present application;

FIG. 84 is an exploded view of an LED lighting device in an embodiment of the present application;

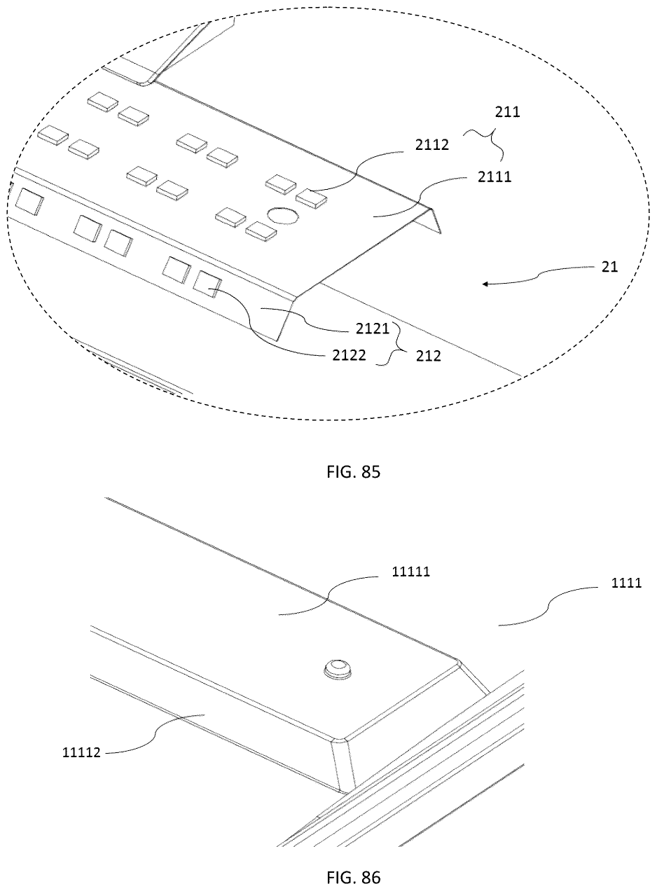

FIG. 85 is an enlarged view of part F in FIG. 84;

FIG. 86 is an enlarged view of part G in FIG. 84; and

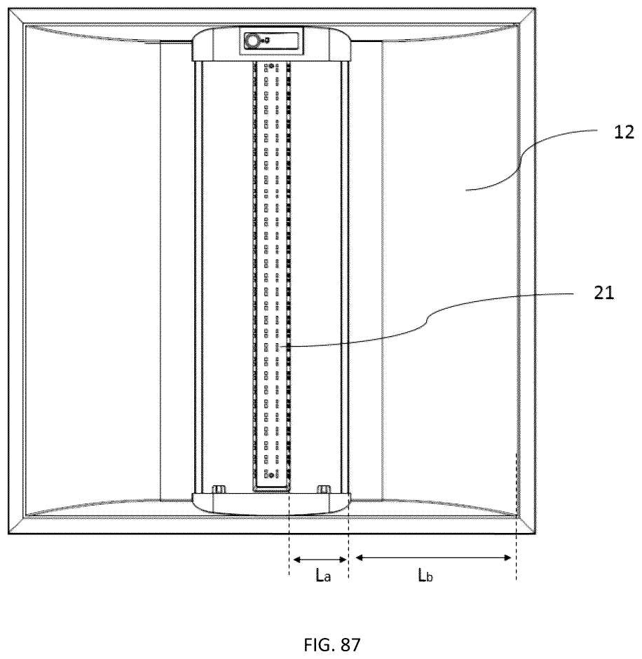

FIG. 87 is a schematic diagram of an LED lighting device without a diffusing member in an embodiment of the present application.

### DETAILED DESCRIPTION OF PREFERRED EMBODIMENTS

The implementation of the present application is illustrated by specific embodiments below, and those skilled in the art can readily understand other advantages and effects of the present application from the disclosure of this specification.

In the following description, reference is made to the accompanying drawings that describe several embodiments of the present application. It should be understood that other embodiments may also be used, and changes in module or unit composition, electrics and operation may be made without departing from the spirit and scope of the present disclosure. The following detailed description should not be considered as limiting, and the scope of embodiments of the present application is defined only by the claims of the published patent. The terms used herein are only intended to describe specific embodiments and are not intended to limit the present application.

It will be understood that although the terms “first”, “second”, etc. may be used herein to describe various elements or parameters in some examples, these elements or parameters should not be limited by these terms. These terms are only used to distinguish one element or parameter from another. For example, a first element may be referred to as a second element, and similarly, the second element may be referred to as the first element, without departing from the scope of various described embodiments. The first element and the second element both describe one element, but unless otherwise explicitly stated in the context, they are not the same element. The terms “or” and “and/or” used herein are interpreted as inclusive or imply any one or any combination. Therefore, “A, B, or C” or “A, B, and/or C” means any of the following: A; B; C; A and B; A and C; B and C; or A, B, and C. An exception to this definition occurs only when a combination of elements, functions, steps, or operations is inherently mutually exclusive in some ways.

It will be understood that when an element such as a layer, a region, or a substrate is referred to as being “located” “on” or extending “to” “a position above” another element, the element may be directly located on or directly extend to the position above another element, or an intermediate element may also exist. Rather, when an element is referred to as being “directly located” “on” or “directly extending” to “a position above” another component, no intermediate element exists. It will also be understood that when an element is referred to as being “connected” or “coupled” to another element, the element may be directly connected or coupled to another component, or an intermediate element may exist. Rather, when an element is referred to as being “directly connected” or “directly coupled” to another component, no intermediate element exists.

The relative term such as “below”, “above”, “upper”, “lower”, or “horizontal”, or “vertical” may be used herein to describe a relationship between one element, layer or region and another element, layer or region as shown in the figures. It will be understood that these terms are intended to encompass different device orientations other than those depicted in the figures. In the present application, the terms “perpendicular”, “horizontal”, and “parallel” are defined as a situation including ±10% from the standard definition. For example, “perpendicular” usually refers to an included angle of 90° with respect to the reference line, but in the present application, “perpendicular” refers to a situation including within 80° to 100°.

The terms used herein are only for the purpose of describing specific embodiments and are not intended to limit the present application. When used herein, unless the context clearly indicates otherwise, singular forms “a/an”, “one”, and “the” are intended to also include plural forms. It will also be understood that when used herein, the terms “comprise”, “comprising”, “include”, and/or “including” specify the presence of the stated features, integers, steps, operations, elements, and/or components, but do not exclude the presence or addition of one or more other features, integers, steps, operations, elements, components, and/or combinations thereof.

Unless otherwise limited, all the terms (including technical and scientific terms) used herein have the same meanings as those commonly understood by those of ordinary skill in the art to which the present application belongs. It will also be understood that the terms used herein should be interpreted as having meanings consistent with their meanings in the context of this specification and relevant fields, and should not be interpreted in an idealized or overly formal sense, unless explicitly so limited herein. For example, when some embodiments are described, the term used, such as “bearing”, may also be understood as “support”.

Unless otherwise explicitly stated, the comparative quantitative terms (e.g., “less than” and “greater than”) are intended to encompass the concept of equality.

As an example, “less than” may represent not only “less than” in the strictest mathematical sense, but also “less than or equal to”.

The present application discloses an LED lighting device in some embodiments, which may be mounted by means of hanging or fixedly mounted to a ceiling or a suspended ceiling. Based on different application forms, the LED lighting device disclosed in the present application may also be referred to as a flat panel lamp, a hanging lamp, a recessed lamp, a concave lamp, an embedded lamp, or a ceiling lamp.

Referring to FIG. 1 to FIG. 3, FIG. 23, and FIG. 36. FIG. 1 shows a schematic front view of an LED lighting device in an embodiment of the present application. FIG. 2 shows a schematic side view of an LED lighting device in an embodiment of the present application. FIG. 3, FIG. 23, and FIG. 36 show schematic diagrams of a three-dimensional structure of an LED lighting device 100 in an embodiment of the present application respectively. As shown in the figures, the LED lighting device includes a support unit 1 and a photoelectric module 2 connected to the support unit 1. In some examples, the photoelectric module 2 is connected to the support unit 1 in a replaceable (detachable) manner, so that the photoelectric module can be quickly disassembled and replaced relative to the LED lighting device 100. If the photoelectric module 2 is damaged, only the photoelectric module 2 needs to be replaced. Compared with replacement of the entire device, replacement costs can be reduced, and repair time can be shortened. The photoelectric module 2 may also be connected to the support unit 1 in a non-detachable manner, that is, the photoelectric module 2 cannot be easily disassembled after being fixed to the support unit 1. In some other examples, the photoelectric module 2 may be configured to be quickly mounted together with the support unit 1, and after mounting, the photoelectric module 2 and the support unit 1 cannot be easily disassembled. Accordingly, during packaging and transportation, the photoelectric module 2 and the support unit 1 can be packaged and transported separately, thereby saving packaging and transportation costs; and during sale or use, the photoelectric module 2 and the support unit 1 can be quickly mounted.

Referring to FIG. 1 to FIG. 4. FIG. 4 shows a schematic diagram of a three-dimensional structure of a support unit in an embodiment of the present application. As shown in the figures, the support unit 1 includes a base 11. In the embodiments shown in FIG. 2 and FIG. 4, the support unit 1 further includes a back plate 12, where the back plate 12 is disposed at a periphery of the base 11, or it may also be described that the back plate 12 is formed in a manner that the base 11 extends from its periphery. In some embodiments, the back plate may also be referred to as a sidewall of the LED lighting device. The back plate 12 is disposed around the base 11 and forms an accommodating space with the base 11. Referring to FIG. 2, FIG. 5, and FIG. 9, a rectangular coordinate system is established with a plane where a bottom plate 111 is located as a plane where XY is located and a direction perpendicular to the bottom plate is a Z axis. In this embodiment of the present application, a direction extending along a first light-emitting assembly 211 is used as an X axis, and a direction perpendicular to the first light-emitting assembly 211 is used as a Y axis. The back plate 12 may be obliquely or horizontally disposed relative to the base 11. For example, an inclination angle (an angle as shown in FIG. 2) between the back plate 12 and the base 11 may be set to 0° to 90°. As shown in FIG. 2, the inclination angle refers to an included angle a between the back plate 12 and a horizontal section X of the base 11. In a more specific example, the inclination angle between the back plate 12 and the base 11 may be 15°, 16°, 17°, 18°, 19°, 20°, 21°, 22°, 23°, 24°, 25°, 26°, 27°, 28°, 29°, or 30°. Preferably, the included angle may be set to 20°.

In an embodiment, the base 11 is located in a middle region of the lighting device, and the base 11 occupying 15% to 50% front area of the support unit 1 in front of view (e.g., approximately 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, or 50%), where the front area refers to an area of a projection in a direction perpendicular to the support unit 1 (the direction perpendicular to the support unit 1 is defined as a horizontal direction, and the section X as shown in FIG. 2 is the horizontal section). Considering that in some embodiments, the photoelectric module 2 includes at least a light-emitting unit disposed on the base 11, and an area for a light-emitting region occupying 15% to 50% of the area of the support unit 1. More specifically, considering material costs and aesthetic appearance, the area of the base 11 occupying the support unit 1 is set to account for approximately 33.3% (33.3% can be understood as an approximate value of ⅓) of the area of the support unit 1 in front of view.

Referring to FIG. 1, FIG. 3, FIG. 5, FIG. 24A, and FIG. 37. FIG. 5, FIG. 24A, and FIG. 37 show schematic diagrams of a split structure of an LED lighting device in an embodiment of the present application respectively. As shown in FIG. 5, the photoelectric module 2 includes a light-emitting unit 21 and a light processing unit 22. The light-emitting unit 21 is configured to emit light for illumination. The light processing unit 22 is configured to process the light emitted from the light-emitting unit 21 before emitting. For example, the light processing unit 22 can change a light output path of the light-emitting unit 21, that is, the light processing unit 22 is disposed on the light output path of the light-emitting unit 21. The base 11 of the support unit 1 provides at least a mounting position for the light-emitting unit 21. In other words, at least part of the light-emitting unit 21 is disposed on the base 11 or in the accommodating space of the base 11. In the present application, one side of the support unit 1 used to provide the light-emitting unit 21 is defined as a front side, and the other side opposite to the front side is defined as a back side. The base 11 may also provide a mounting position for the light processing unit 22. In other words, the light processing unit 22 may also be disposed on the base 11 or in the accommodating space formed by the base 11. In an embodiment, the base 11 may also provide mounting positions or accommodating spaces for other components, units, modules, module groups, or members in the photoelectric module 2. It should be understood that FIG. 5 is only an example of the split structure. In some embodiments, the photoelectric module 2 may not be provided with the light processing unit 22.

Referring to FIG. 6 and FIG. 7. FIG. 6 shows a schematic diagram of a three-dimensional structure of combination of a light-emitting unit and a support unit in an embodiment of the present application. FIG. 7 shows a schematic diagram of a three-dimensional structure of a light-emitting unit in an embodiment of the present application. As shown in the figures, the base 11 of the support unit 1 is provided with a bottom plate 111, and the light-emitting unit 21 includes at least one first light-emitting assembly 211, where the at least one first light-emitting assembly 211 is disposed on the bottom plate 111, and the first light-emitting assembly 211 may include a first circuit board 2111 and at least one first light-emitting body 2112 is disposed on the first circuit board. The first light-emitting body 2112 may be an LED lighting bead or other types of LED light-emitting bodies. The first circuit board 2111 is attached (e.g., attached directly or attached through an intermediate medium) to the bottom plate 111. Multiple first light-emitting bodies 2112 may be provided, and the multiple first light-emitting bodies 2112 are uniformly or partially uniformly distributed on the first circuit board 2111. The first light-emitting bodies 2112 on the adjacent first light-emitting assemblies 211 may be aligned or mutually staggered. In FIG. 6 and FIG. 7, taking a case where the number of first light-emitting bodies 2112 is set to 24 as an example, those skilled in the art can also set any number of first light-emitting bodies 2112 based on actual requirements. In some embodiments, at least two groups of first light-emitting assemblies 211 may be provided, that is, the light-emitting unit 21 is provided with at least two groups of light-emitting assemblies. At least two groups can be as two or more groups. The groups of light-emitting assemblies are disposed on the bottom plate 111 in parallel. For example, the number of the groups of first light-emitting assemblies 211 may be set to 2, 3, 4, 5, or 6. In the embodiments as shown in FIG. 6 and FIG. 7, the number of the groups of first light-emitting assemblies 211 is set to 4. In some other embodiments, for example, under the limitation of some specific mounting environments or lamp structures, the number of the groups of first light-emitting assemblies 211 may also be set to 1 only. In other words, those skilled in the art can select any number of groups of first light-emitting assemblies to be disposed on the bottom plate 111 based on actual requirements under the inspiration of the above embodiments of the present application. In another embodiment, there are at least two different gaps between the first light-emitting bodies 2112.

In an embodiment, at least two groups of first light-emitting assemblies 211 may be provided, and the two adjacent first light-emitting assemblies 211 are not parallel to each other, that is, extension lines of sides of the two adjacent first light-emitting assemblies 211 intersect, or there are at least two different gaps between the two adjacent first light-emitting assemblies 211.

Referring to FIG. 6 and FIG. 8. FIG. 8 shows a light pattern diagram of a first light-emitting assembly in an embodiment of the present application. As shown in the figures, a light pattern of the first light-emitting assembly 211 is a distribution in which the light intensity is maximum at an emission angle of 0° and continuously decreases with an increase in the emission angle. For example, the light pattern distribution of the first light-emitting assembly 211 is a Lambertian light pattern or an approximate Lambertian light pattern. In an embodiment, the light-emitting unit 21 includes only the first light-emitting assembly 211, a light pattern distribution of the LED lighting device corresponds to the light pattern distribution of the first light-emitting assembly 211. This will result in uneven illumination of the LED lighting device and high luminous intensity on an underlying region of the first light-emitting assembly 211. During use in space that needs to be illuminated, a central light spot phenomenon where the LED lighting device is bright for the middle region and dark for a peripheral region will occur in the space.

The underlying region of the first light-emitting assembly 211 mentioned here and later can be understood as a region with a preset light beam angle of the first light-emitting assembly 211. In some examples, the preset light beam angle may be set to 10° to 60° (e.g., approximately 10°, 11°, 12°, 13°, 14°, 15°, 16°, 17°, 18°, 19°, 20°, 21°, 22°, 23°, 24°, 25°, 26°, 27°, 28°, 29°, 30°, 31°, 32°, 33°, 34°, 35°, 36°, 37°, 38°, 39°, 40°, 41°, 42°, 43°, 44°, 45°, 46°, 47°, 48°, 49°, 50°, 51°, 52°, 53°, 54°, 55°, 56°, 57°, 58°, 59°, or 60°). Taking a case where the preset light beam angle is set to 10° as an example, the underlying region of the first light-emitting assembly 211 refers to a region of −5° to 5° with a center line (i.e., a main axis of the maximum light intensity) of a light beam as an angle of 0°. In some embodiments, the preset light beam angle may also be set with the light intensity as a reference. The preset light beam angle may be set to range from an included angle for 20% of the maximum light intensity to an included angle for 60% of the maximum light intensity. Taking a case where the preset light beam angle is set to the included angle for 20% of the maximum light intensity as an example, the underlying region of the first light-emitting assembly 211 refers to an angular region between two light beams with the light intensity equal to 20% of the maximum light intensity. It should be understood that in the embodiment where the first light-emitting assembly 211 is disposed in the middle region of the LED lighting device, the underlying region of the first light-emitting assembly 211 may also be referred to as the middle region of the LED lighting device or an underlying region of the LED lighting device, which will not be repeated later.

The peripheral region (e.g., left, right, front, and rear sides, also referred to as a surrounding region) of the first light-emitting assembly 211 mentioned here and later can be understood as a surrounding region of the underlying region of the first light-emitting assembly 211. In the present application, it is allowed for the peripheral region and the underlying region to overlap within a certain range at a junction. Relative to the position of the first light-emitting assembly 211, the peripheral region of the first light-emitting assembly 211 includes a front region, a rear region, a left region, a right region, etc. When it comes to a specific orientation in the peripheral region, a directional noun (e.g., a front, rear, left, or right side) is used for indication in some embodiments of the present application. When a specific orientation is not specifically indicated, the peripheral region may be directly used in some embodiments of the present application. It should be understood that in the embodiment where the first light-emitting assembly 211 is disposed in the middle region of the LED lighting device, the peripheral region of the first light-emitting assembly 211 may also be referred to as the peripheral region of the LED lighting device, which will not be repeated later.

In view of the central light spot phenomenon as shown in FIG. 8 and its description, in some embodiments, the light-emitting unit 21 may further include a second light-emitting assembly 212. By designing the structure and/or parameters of the support unit and/or the photoelectric module in the LED lighting device, the light pattern distribution of the first light-emitting assembly 211 can be combined with a light pattern distribution of the second light-emitting assembly 212 to form a light pattern distribution of the LED lighting device, thereby eliminating the central light spot phenomenon as described in FIG. 6, FIG. 8, and their descriptions, and greatly improving the illumination uniformity of the LED lighting device. More specifically, in some embodiments, relative positions of the first light-emitting assembly and the second light-emitting assembly are set, or light output angles are diversified, that is, at least two light-emitting assemblies are disposed and have at least two light output angles, so that the light-emitting unit 21 has at least two light output angles, thereby making it relatively uniform for the light pattern distribution of the LED lighting device that is formed by combination of the light pattern distributions of the first and second light-emitting assemblies, such as a bat-wing light pattern or an approximate bat-wing light pattern. The bat-wing light pattern refers to a light pattern distribution that spreads out to two sides like bat-wings, with slightly low light intensity in a middle region (i.e., a region with a small emission angle) and slightly high light intensity in two side regions (i.e., a region with a large emission angle). The approximate bat-wing light pattern refers to a non-ideal bat-wing light pattern distribution. Although the light pattern distribution does not present the standard condition of slightly high light intensity on two sides, the overall light pattern distribution presents the condition that there is not much difference in light intensity between a middle and two sides, or the difference is within an acceptable range of uniformity. The bat-wing light pattern or the approximate bat-wing light pattern may help the lamp achieve high uniformity of illumination, and enable two lamps to be mounted at a larger spacing.

Referring to FIG. 5, FIG. 7, and FIG. 9. FIG. 9 shows a schematic diagram of a three-dimensional structure of combination of a light-emitting unit and a support unit in an embodiment of the present application. The second light-emitting assembly 212 is disposed on the base 11 and on a peripheral side of the first light-emitting assembly 211, and is inclined relative to the first light-emitting assembly 211. Here, the peripheral side of the first light-emitting assembly 211 refers to a peripheral side of a region occupied by the first light-emitting assembly 211. In a case where multiple groups of first light-emitting assemblies 211 are provided, the peripheral side of the first light-emitting assemblies refers to a peripheral side of an entire region occupied by the first light-emitting assemblies 211, such as a peripheral side of the bottom plate 111. With a light output direction as a reference, the second light-emitting assembly 212 is inclined relative to the first light-emitting assembly 211, which refers to that a light output side of the second light-emitting assembly 212 is inclined towards a light output side of the first light-emitting assembly 211, or that optical axes (or extension lines of the optical axes) of the first light-emitting assembly 211 and the second light-emitting assembly 212 intersect. In other words, light emitted from the second light-emitting assembly 212 is mainly distributed in the peripheral region of the first light-emitting assembly 211. That is to say, if the first light-emitting assembly 211 contributes to the light intensity in the middle region of the LED lighting device, then the second light-emitting assembly 212 mainly contributes to the light intensity in the surrounding region of the LED lighting device, thereby greatly improving the uniformity of light intensity distribution of the LED lighting device, and avoiding the central light spot phenomenon. In other embodiments, the first light-emitting assembly 211 and the second light-emitting assembly 212 may also be vertically spaced or closely disposed.

As shown in FIG. 7, the second light-emitting assembly 212 may include a second circuit board 2121 and at least one second light-emitting body 2122 disposed on the second circuit board 2121. The second light-emitting body 2122 may be an LED lamp bead or other types of LED light-emitting bodies. The second circuit board 2121 is attached (e.g., attached directly or attached through an intermediate medium) to the base 11. Multiple second light-emitting bodies 2122 may be provided, and the multiple second light-emitting bodies 2122 are uniformly distributed on the second circuit board 2121. In FIG. 7 and FIG. 9, the number of second first light-emitting bodies 2122 is set to 24 as an example, those skilled in the art can also set any number of second light-emitting bodies 2122 based on actual requirements. In some embodiments, multiple groups of second light-emitting assemblies 212 may also be provided, and the groups of second light-emitting assemblies surround the first light-emitting assembly and are obliquely disposed on the peripheral side of the first light-emitting assembly 211 relative to the first light-emitting assembly 211.

In an embodiment, the second light-emitting bodies 2122 may be non-uniformly disposed on the second circuit board 2121. The second light-emitting bodies on the adjacent second light-emitting assemblies 212 are staggered.

In some embodiments, the second light-emitting assembly 212 may be inclined relative to the first light-emitting assembly 211 by forming a certain included angle between a mounting surface where the second light-emitting assembly 212 is located and a mounting surface where the first light-emitting assembly 211 is located.

Referring to FIG. 2, and FIG. 9 to FIG. 11. FIG. 10 shows a partial enlarged view of a base and a light-emitting unit in the embodiment of the present application shown in FIG. 9. FIG. 11 shows a schematic diagram of a sectional structure of an LED lighting device along an X-axis direction in an embodiment of the present application. As shown in the figures, the base 11 further has a first base sidewall 112, that is, the base 11 has a bottom plate 111 and a first base sidewall 112. The first base sidewall 112 is formed in a manner that an edge of the bottom plate 111 extends towards one side (i.e., a front direction of the support unit 1) of the light output direction. The first base sidewall 112 has a first inclination angle β relative to the bottom plate 111. The first base sidewall 112 is disposed around the bottom plate 111. The first light-emitting assembly 211 is disposed on the bottom plate 111 (i.e., the bottom plate 111 can be understood as the mounting surface for the first light-emitting assembly 211), and the second light-emitting assembly 212 is disposed on the first base sidewall 112 (i.e., the first base sidewall 112 can be understood as the mounting surface for the second light-emitting assembly 212), so that the inclination angle of the second light-emitting assembly 212 relative to the first light-emitting assembly is the first inclination angle β. Multiple groups of first base sidewalls 112 may be provided, and multiple groups of second light-emitting assemblies 212 corresponding to the number of first base sidewalls 112 may also be provided to emit light in different directions. For example, the bottom plate 111 of the base 11 is set to be in a shape of a polygon, the base 11 has multiple groups of first base sidewalls 112 corresponding to the number of sides of the polygon, and each group of first base sidewalls 112 is correspondingly provided with second light-emitting assemblies 212. In the embodiments shown in FIG. 9 to FIG. 11, the bottom plate 111 of the base 11 is designed to be in a shape of a quadrangle, the base 11 has four groups of first base sidewalls 112, each group of first base sidewalls 112 is correspondingly provided with second light-emitting assemblies 212, the bottom plate 111 and the first base sidewalls 112 form a bottom plate accommodating space, and at least part of the photoelectric module 2 is disposed in the accommodating space.

To ensure that the light intensity distribution of the LED lighting device 100 meets uniformity requirements, the first inclination angle β of the first base sidewall 112 relative to the bottom plate 111 is set to 15° to 45° (e.g., approximately 15°, 16°, 17°, 18°, 19°, 20°, 21°, 22°, 23°, 24°, 25°, 26°, 27°, 28°, 29°, 30°, 31°, 32°, 33°, 34°, 35°, 36°, 37°, 38°, 39°, 40°, 41°, 42°, 43°, 44°, or 45°). If the first inclination angle is less than 15°, then equivalently the first light-emitting assembly 211 and the second light-emitting assembly 212 emit light in a manner of being approximately on the same plane (e.g., the horizontal section X in FIG. 11), resulting in dispersed light emitted from the second light-emitting assembly 212 and the first light-emitting assembly 211. For example, the light emitted from the second light-emitting assembly 212 is mainly distributed on one side that is spaced a certain distance away from light emitted from the first light-emitting assembly 211. This not only fails to improve the illumination uniformity of the LED lighting device, but may even cause multiple light spots of the LED lighting device during illumination, thereby exacerbating the illumination unevenness of the LED lighting device. If the first inclination angle β is greater than 45°, then one situation (a difference between the first inclination angle β and 45° is too large, for example, the first inclination angle is greater than 60°) will cause most of the light emitted from the second light-emitting assembly 212 to face the inside of an accommodating space defined by the support unit 1, making it easy to be blocked by some components, units, modules, and members disposed on the support unit 1. For example, as shown in FIG. 5, in an example where the light processing unit 22 is disposed on the light-emitting unit 21, most of the light emitted from the second light-emitting assembly 212 will be blocked by some components in the light processing unit 22 and processed by the light processing unit 22 before being emitted. Another situation (the difference between the first inclination angle β and 45° is not significant, for example, the first inclination angle is less than 60°) will cause most of the light emitted from the two light-emitting assemblies (211, 212) to be concentrated in the same region. This will fail to enhance the illumination uniformity of the LED lighting device, and make it difficult to form the bat-wing light pattern or the approximate bat-wing light pattern. In this embodiment, more preferably, the first inclination angle β may be set to 30° to 45°. Setting the first inclination angle β within this range can enable the LED lighting device to present the bat-wing light pattern or the approximate bat-wing light pattern. Furthermore, in an embodiment, the first inclination angle 3 may be set to 20°.

It is to be noted that in the embodiment where multiple groups of first base sidewalls 112 are provided, each group of first base sidewalls 112 spreads out as a whole towards the peripheral side of the bottom plate 111. As shown in FIG. 10 and FIG. 11, four groups of first base sidewalls 112 are provided, and the four groups of first base sidewalls 112 spread out towards the up, down, left, and right sides of the bottom plate 111 respectively and each forms the first inclination angle β with the bottom plate 111. The positions of the four groups of first base sidewalls 112 are defined as up, down, left, and right positions, respectively. From the perspective of the diagram, the position of the first base sidewall 112 located on an upper side is defined as the up position, the position of the first base sidewall 112 located on a lower side is defined as the down position, the position of the first base sidewall 112 located on a left side is defined as the left position, and the position of the first base sidewall 112 located on a right side is defined as the right position. It should be understood that the figures show examples only, and the groups of first base sidewalls 112 do not necessarily need to be set to have the same first inclination angle β, as long as the first inclination angle β of the groups of first base sidewalls 112 relative to the bottom plate 111 is 15° to 45°.

Referring to FIG. 12 and FIG. 13. FIG. 12 shows a schematic diagram of light output from an LED lighting device in the embodiment of the present application shown in FIG. 11. FIG. 13 shows a light pattern diagram of an LED lighting device in the embodiment of the present application shown in FIG. 11. For ease of description and illustration, in FIG. 12, taking the second light-emitting assembly 212 disposed on the first base sidewall 112 on the left side and one group of first light-emitting assemblies 211 attached to a middle of the bottom plate 111 as an example, the light output from the LED lighting device is illustrated. The principles of other groups of first light-emitting assemblies 211 and second light-emitting assemblies 212 are similar and will not be repeated herein. FIG. 13 shows a light pattern diagram formed by combination of all first light-emitting assemblies 211 and second light-emitting assemblies 212. As shown in the figures, the light emitted from the first light-emitting assembly 211 is mainly concentrated in the underlying region of the first light-emitting assembly 211, which is also referred to as the middle region of the LED lighting device in some examples. The second light-emitting assembly 212 located on the left side is inclined to the first light-emitting assembly 211, so that light emitted therefrom is mainly distributed in the left region of the first light-emitting assembly 211. Similarly, light emitted from the second light-emitting assembly 212 located on the right side should be mainly distributed in the right region of the first light-emitting assembly 211, light emitted from the second light-emitting assembly 212 located on the up side should mainly be distributed in the up region of the first light-emitting assembly 211, and light emitted from the second light-emitting assembly 212 located on the down side should be mainly distributed in the down region of the first light-emitting assembly 211, so that the light emitted from the second light-emitting assembly 212 is mainly distributed in the peripheral region of the first light-emitting assembly 211. As shown in FIG. 12 and FIG. 13, the first light-emitting assembly 211 contributes to the light intensity in the middle region of the LED lighting device, and the second light-emitting assembly 212 mainly contributes to the light intensity in the surrounding region of the LED lighting device, so that in the formed light pattern diagram of the LED lighting device, there is not much difference in light intensity between the middle region and the peripheral region (e.g., the difference in light intensity is within a range from −40° to 40°, which is an acceptable range of uniformity), thereby greatly improving the uniformity of light intensity distribution of the LED lighting device, and avoiding the central light spot phenomenon.

In some embodiments, as described above, the photoelectric module 2 may further include the light processing unit 22, where the light processing unit 22 is configured to process the light emitted from the light-emitting unit 21. The light processing unit 22 is disposed on the base 11. To provide an accommodating space, in some embodiments, as shown in FIG. 9 to FIG. 11, the base 11 further has a second base sidewall 113. The second base sidewall 113 is connected to the first base sidewall 112 and has a second inclination angle y relative to the first base sidewall 112. In other words, the second base sidewall 113 is formed in a manner that the first base sidewall 112 is bent towards the light output direction (also referred to as the front direction of the support unit) and then continues to extend. In the embodiments as shown in FIG. 9 to FIG. 11, the number of second base sidewalls 113 is consistent with the number of first base sidewalls 112, that is, the bottom plate 111 of the base 11 is set to be in a shape of a quadrangle, four groups of first base sidewalls 112 corresponding to four sides of the quadrangle are provided, and four groups of second base sidewalls 113 are also provided.

Certainly, those skilled in the art can also design the number of second base sidewalls 113 to be different from the number of first base sidewalls 112 based on actual shape design, which is not limited here in the present application.

In some embodiments, the second base sidewall 113 may also serve as a reflective surface for the light emitted from the second light-emitting assembly 212 to reflect the light emitted at a large angle from the second light-emitting assembly 212 back to the peripheral region of the first light-emitting assembly 211 emitting the light. As shown in FIG. 12, light m is formed in a manner that the light emitted from the second light-emitting assembly 112 on the left side is projected onto the second base sidewall 113 and then reflected, so that the second base sidewall 113 can enable the light emitted from the second light-emitting assembly 212 to be more concentrated in the peripheral region of the first light-emitting assembly 211 emitting the light, thereby improving the uniformity of light emitted from the LED lighting device.

In an embodiment, the light processing unit 22 includes a light beam control assembly for changing the light output path of the light-emitting unit to achieve a better light output performance. In an embodiment, the light beam control assembly is disposed on the light output side of the second light-emitting assembly 212 and configured to change a path of at least part of the light emitted from the second light-emitting assembly 212, so that the light emitted from the second light-emitting assembly 212 is mainly distributed in the peripheral region of the first light-emitting assembly 211. For example, the light beam control assembly can change the light emitted from the second light-emitting assembly 212 and project to the underlying region of the first light-emitting assembly 211 or the middle region of the LED lighting device to project to the peripheral region of the first light-emitting assembly 211 or the peripheral region of the LED lighting device, and can also concentrate and project the light emitted at a large angle from the second light-emitting assembly 212 to the peripheral region of the first light-emitting assembly 211, so that the LED lighting device can form the bat-wing light pattern or the approximate bat-wing light pattern, thereby further improving the uniformity of the light emitted from the LED lighting device.

Referring to FIG. 14 and FIG. 15. FIG. 14 shows a schematic diagram of a sectional structure of an LED lighting device with a light beam control assembly along an X-axis direction in an embodiment of the present application. FIG. 15 shows a partial enlarged view of part A in the embodiment of the present application shown in FIG. 14. As shown in the figures, the light processing unit 22 includes a light beam control assembly 221, where the light beam control assembly 221 includes a serrated lens 2211, and the serrated lens 2211 is disposed on the light output side of the second light-emitting assembly 212. Multiple groups of serrated lenses corresponding to the number of groups of second light-emitting assemblies 212 are provided. In the embodiments shown in FIG. 14 and FIG. 15, there are four groups of serrated lenses 2211 corresponding to the number of second light-emitting assemblies 212. The serrated lens 2211 is parallel to each second light-emitting assembly 212 (in some embodiments, the serrated lens 2211 is parallel to the first base sidewall 112). The serrated lens 2211 is set as a long-strip-shaped object extending in a length direction of the second light-emitting assembly 212, so that light emitted from each second light-emitting body of the second light-emitting assembly 212 can pass through the serrated lens 2211 to change a light output path of the second light-emitting assembly 212.

Each curved surface in the serrated lens 2211 faces in a direction away from the first light-emitting assembly 211 and is configured to refract part of the light emitted from the second light-emitting assembly 212, so that part of the light is outputted at a wider angle (greater than an original emission angle), and further, the light emitted from the second light-emitting assembly 212 is distributed on two sides of the first light-emitting assembly 211, thereby making almost no contribution to the underlying region of the first light-emitting assembly 211. Specifically, referring to FIG. 15 and FIG. 16. FIG. 16 shows a light pattern diagram of an LED lighting device in the embodiment of the present application shown in FIG. 14.

As shown in FIG. 15, the travel of light of the second light-emitting assembly 212 on the right side is illustrated. The serrated lens 2211 refracts part of the light emitted from the second light-emitting assembly 212 on the right side to be outputted at the wider angle, so that the light that may be projected to the underlying region (also understood as the middle region of the LED lighting device, e.g., within a range of −10° to 10° in FIG. 16) of the first light-emitting assembly 211 by an original light output path is refracted to the left region (e.g., within a range of −15° to −40° in FIG. 16) of the first light-emitting assembly 211. As shown in FIG. 16, the light emitted from the second light-emitting assembly 212 on the right side is mainly distributed in the left region (e.g., within a range of −15° to −40° in FIG. 16) and the right region (e.g., within a range of 15° to 40° in FIG. 16). Similar to the second light-emitting assembly 212 on the right side, the light emitted from the second light-emitting assembly 212 on the left side is mainly distributed on the left and right sides. The light pattern distributions of the second light-emitting assemblies 212 on the left and right sides are combined with the light pattern distribution of the first light-emitting assembly 211 to form the bat-wing light pattern.

In FIG. 14 to FIG. 16, only the second light-emitting assemblies 212 on the left and right sides are used as an example for description. The travel of light of the second light-emitting assemblies 212 on the up and down sides are similar to that on the left and right sides. After the second light-emitting assemblies 212 on the up and down sides are acted upon by the corresponding serrated lenses 2211, the light emitted will be mainly distributed on the up and down sides. The bat-wing light pattern as shown in FIG. 16 can also be obtained in combination with the light pattern distribution of the first light-emitting assembly 211. Similarly, after the second light-emitting assemblies 212 on the up, down, left, and right sides are equipped with the corresponding serrated lenses 2211, the light emitted will be mainly concentrated on the up, down, left, and right sides, that is, around the light emitted from the first light-emitting assembly 211. The bat-wing light pattern is also obtained in combination with the light pattern distribution of the first light-emitting assembly 211, which will not be repeated herein.

In an embodiment, refer to FIG. 17. FIG. 17 shows a schematic structural diagram of a serrated lens in an embodiment of the present application. As shown in the figure, the serrated lens 2211 includes a base 22111 and multiple (or at least one) serrations 22112. The base 22111 has a certain thickness d, where the thickness d may be set to 0.5 mm to 2 mm (e.g., approximately 0.5 mm, 0.6 mm, 0.7 mm, 0.8 mm, 0.9 mm, 1 mm, 1.1 mm, 1.2 mm, 1.3 mm, 1.4 mm, 1.5 mm, 1.6 mm, 1.7 mm, 1.8 mm, 1.9 mm, or 2 mm). For example, in the embodiments shown in FIGS. 14 and 15, the thickness d is set to 1 mm. The number of serrations 22112 may be set to 6 to 9. Each serration occupies a certain width k (e.g., 3 mm) of the base and is formed in a manner that the base 22111 extends upward. Each serration 22112 is set as a curved lens with a curved surface and a vertical surface. In some examples, the height h of the vertical surface of each serration 22112 may be set to be the same, such as 2 mm to 5 mm (e.g., approximately 2 mm, 2.1 mm, 2.2 mm, 2.3 mm, 2.4 mm, 2.5 mm, 2.6 mm, 2.7 mm, 2.8 mm, 2.9 mm, 3 mm, 3.1 mm, 3.2 mm, 3.3 mm, 3.4 mm, 3.5 mm, 3.6 mm, 3.7 mm, 3.8 mm, 3.9 mm, 4 mm, 4.1 mm, 4.2 mm, 4.3 mm, 4.4 mm, 4.5 mm, 4.6 mm, 4.7 mm, 4.8 mm, 4.9 mm, or 5 mm). In some examples, the height h of the vertical surface of each serration 22112 may also be set to be different, for example, if height differences of the vertical surfaces of the two adjacent serrations 22112 are equal, the height difference may be set to approximately 0.2 mm to 0.4 mm.

In the embodiment where the serrated lens 2211 is disposed in the LED lighting device, for example, as shown in FIG. 14 and FIG. 15, the curved surface of each serration 22112 of the serrated lens 2211 faces in the direction away from the first light-emitting assembly 211. In some other embodiments, the curved surface of each serration 22112 of the serrated lens 2211 is arranged in a direction close to the first light-emitting assembly 211. Referring to FIG. 18 and FIG. 19. FIG. 18 shows a schematic diagram of a partial structure of a serrated lens and a second light-emitting unit in an embodiment of the present application. FIG. 19 shows a light pattern diagram of an LED lighting device in the embodiment of the present application shown in FIG. 18. As shown in the figures, the curved surface of each serration 22112 of the serrated lens 2211 is arranged in the direction close to the first light-emitting assembly 211. Under the refraction of part of the light emitted from the second light-emitting assembly 212 on the right side by the serrated lens 2211, although the light that may be projected to the underlying region of the first light-emitting assembly 211 by the original light output path can be refracted to the right region of the first light-emitting assembly 211, a part of the light will be refracted to the underlying region of the first light-emitting assembly 211. In combination with the light pattern diagram of light emitted from the right side in FIG. 19, it can be seen that by arranging the serrated lens 2211 as shown in FIG. 18, the light emitted from the second light-emitting assembly 212 will be distributed on the left side, right side and the underlying region of the first light-emitting assembly 211. That is to say, the second light-emitting assembly 212 not only contributes to the light intensity of the surrounding region of the LED lighting device, but also contributes to the light intensity of the middle region of the LED lighting device. Similar to the second light-emitting assembly 212 on the right side, the second light-emitting assembly 212 on the left side also contributes to the light intensity of the middle region of the LED lighting device. The light pattern distributions of the second light-emitting assemblies 212 on the left and right sides are combined with the light pattern distribution of the first light-emitting assembly 211 to form a light pattern diagram corresponding to left, middle, and right light emission as shown in FIG. 19. It can be seen that the light pattern is a non-ideal bat-wing light pattern and cannot achieve the uniformity under the action of the serrated lens 2211 arranged as shown in FIG. 14 and FIG. 15.

In FIG. 18 to FIG. 19, only the second light-emitting assemblies 212 on the left and right sides are described as an example. The travels of light of the second light-emitting assemblies 212 on the up and down sides are similar to that on the left and right sides. After the second light-emitting assemblies 212 on the up and down sides are equipped with the corresponding serrated lenses 2211, the light emitted will be concentrated on the up and down sides. A light pattern diagram similar to that in FIG. 19 can also be obtained in combination with the light pattern distribution of the first light-emitting assembly 211. Similarly, after the second light-emitting assemblies 212 on the up, down, left, and right sides are equipped with the corresponding serrated lenses 2211, the light emitted will be concentrated on the up, down, left, and right sides. A light pattern diagram similar to that in FIG. 19 is also obtained in combination with the light pattern distribution of the first light-emitting assembly 211, which will not be repeated herein.

Referring to FIG. 20 and FIG. 21. FIG. 20 shows a schematic diagram of a sectional structure of an LED lighting device with a light beam control assembly along an X-axis direction in an embodiment of the present application. FIG. 21 shows a partial enlarged view of part B in the embodiment of the present application shown in FIG. 20. As shown in the figures, the light processing unit 22 includes a light beam control assembly 221, where the light beam control assembly 221 includes a TIR lens 2212 (also referred to as a Total Internal Reflection lens), and the TIR lens 2212 is disposed on the light output side of the second light-emitting assembly 212. Multiple groups of TIR lenses corresponding to the number of groups of second light-emitting assemblies 212 may be provided. In the embodiments shown in FIG. 20 and FIG. 21, there are four groups of TIR lenses 2212 corresponding to the number of second light-emitting assemblies 212. The TIR lens 2212 is parallel to corresponding second light-emitting assembly 212 (i.e., the TIR lens 2212 is parallel to the first base sidewall 112), so as to change the light output path of the second light-emitting assembly 212.

The TIR lens 2212 is configured to refract part of the light emitted from the second light-emitting assembly 212, so that part of the light is outputted at a narrower angle (less than the original emission angle), and further, the light emitted from the second light-emitting assembly 212 is distributed in regions on two sides of the first light-emitting assembly, thereby making almost no contribution to the underlying region of the first light-emitting assembly 211 or the middle region of the LED lighting device. Specifically, referring to FIG. 21 and FIG. 22. FIG. 22 shows a light pattern diagram of an LED lighting device in the embodiment of the present application shown in FIG. 20. As shown in FIG. 21, the TIR lens 2212 refracts part of the light emitted from the second light-emitting assembly 212 on the right side to be outputted at the narrower angle, so that the light projected to the middle region of the LED lighting lamp by the original light output path is refracted to the right region. As shown in FIG. 22, the light emitted from the second light-emitting assembly 212 on the right side is mainly distributed in the left region (e.g., within a range of −15° to −20° in FIG. 22) and the right region (e.g., within a range of 15° to 25° in FIG. 20) of the LED lighting device. Similarly, the light emitted from the second light-emitting assembly 212 on the left side is also mainly concentrated on the left and right sides of the LED lighting device. The light pattern distributions of the second light-emitting assemblies 212 on the left and right sides are combined with the light pattern distribution of the first light-emitting assembly 211 to form the bat-wing light pattern.

In FIG. 20 to FIG. 22, only the second light-emitting assemblies 212 on the left and right sides are described as an example. The travels of light of the second light-emitting assemblies 212 on the up and down sides are similar to that on the left and right sides. After the second light-emitting assemblies 212 on the up and down sides are equipped with the corresponding TIR lenses 2212, the light emitted will be mainly concentrated on the up and down sides. The bat-wing light pattern as shown in FIG. 22 can also be obtained in combination with the light pattern distribution of the first light-emitting assembly 211. Similarly, after the second light-emitting assemblies 212 on the up, down, left, and right sides are equipped with the corresponding TIR lenses 2212, the light emitted will be mainly concentrated on the up, down, left, and right sides, that is, in the peripheral region of the first light-emitting assembly 211. A bat-wing light pattern similar to that in FIG. 22 is also obtained in combination with the light pattern distribution of the first light-emitting assembly 211, which will not be repeated herein.

In an embodiment, the overall height of the TIR lens 2212 is set to approximately 6 mm to 8 mm, the diameter of an opening in one side of the TIR lens facing the second light-emitting assembly 212 is set to approximately 2 mm to 6 mm, and the diameter of an opening in one side of the TIR lens away from the second light-emitting assembly 212 is set to approximately 10 mm to 12 mm. In the embodiments shown in FIGS. 20 and 21, the height of the TIR lens is set to approximately 7.5 mm, the diameter of the opening in one side facing the second light-emitting assembly 212 is set to approximately 6 mm, and the diameter of the opening in one side away from the second light-emitting assembly 212 is set to approximately 12 mm. Those skilled in the art can select a suitable TIR lens based on actual size requirements of the LED lighting lamp.

Referring to FIG. 23 to FIG. 29. FIG. 23 shows a schematic diagram of a three-dimensional structure of an LED lighting device in an embodiment of the present application. FIG. 24A shows a schematic diagram of a split structure of an LED lighting device in an embodiment of the present application. FIG. 25 shows a schematic diagram of a three-dimensional structure of combination of a light-emitting unit and a light beam control assembly in an embodiment of the present application. FIG. 26 shows a partial enlarged view of a base and a photoelectric module in the embodiment of the present application shown in FIG. 25. FIG. 27 shows a schematic diagram of a sectional structure of an LED lighting device in an embodiment of the present application. FIG. 28 shows a partial enlarged view of part C in the embodiment of the present application shown in FIG. 27. FIG. 29 shows a light pattern diagram of an LED lighting device in the embodiment of the present application shown in FIG. 27. As shown in the figures, the light beam control assembly 221 includes a light reflecting structure 2213, where the light reflecting structure 2213 is disposed on the light output side of the second light-emitting assembly 212. Multiple groups of light reflecting structures corresponding to the number of groups of second light-emitting assemblies 212 are provided. In the embodiments shown in FIG. 23 to FIG. 27, there are four groups of light reflecting structures 2213 corresponding to the number of second light-emitting assemblies 212. The light reflecting structure 2213 is configured to concentrate the light emitted from the second light-emitting assembly 212, so as to increase the light intensity in the peripheral region of the first light-emitting assembly 211. Specifically, referring to FIG. 27 to FIG. 29, the light reflecting structure 2213 reflects the light (i.e., light with a large output angle) emitted from the second light-emitting assembly 212 and shinning thereon to achieve a light concentrating effect on the second light-emitting assembly 212 (e.g., to concentrate the light emitted from the second light-emitting assembly 212 within an angle formed by the light reflecting structure 2213, which is an angle between dashed arrows along two light reflecting plates of the light reflecting structure 2213 in FIG. 28), thereby further enhancing the light intensity in the peripheral region of the first light-emitting assembly 211, and making the LED lighting device present a bat-wing light pattern shown in FIG. 29.

Referring to FIG. 25 to FIG. 30. FIG. 30 shows a schematic diagram of a three-dimensional structure of combination of a light reflecting structure and a second light-emitting assembly in an embodiment of the present application. The light reflecting structure 2213 includes a first light reflecting plate 22131 and a second light reflecting plate 22132. The first light reflecting plate 22131 and the second light reflecting plate 22132 are inclined towards two sides of a light output center line L of the second light-emitting assembly 212 respectively. Taking FIG. 30 as an example, an inclination angle of each of the first light reflecting plate 22131 and the second light reflecting plate 22132 relative to the light output center line L of the second light-emitting assembly 212 is marked as θ. The first light reflecting plate 22131 and the second light reflecting plate 22132 may be separately connected to the mounting surface for the second light-emitting assembly 212, such as the first base sidewall 112, or may be separately connected to the second circuit board 2121 (as shown in FIG. 30), as long as the first light reflecting plate 22131 and the second light reflecting plate 22132 are located on two sides of the second light-emitting body 2122 respectively. The first light reflecting plate 22131 and the second light reflecting plate 22132 form two reflective surfaces for the light emitted from the second light-emitting assembly 212 respectively to reflect light within an output angle, so as to concentrate the light emitted from the second light-emitting assembly 212 and enhance the light intensity in the peripheral region of the first light-emitting assembly 211.

In an embodiment, the inclination angle θ of each of the first light reflecting plate 22131 and the second light reflecting plate 22132 relative to the light output center line L of the second light-emitting assembly 212 may be set to 15° to 25° (e.g., approximately 15°, 16°, 17°, 18°, 19°, 20°, 21°, 22°, 23°, 24°, or 25 °). That is, the included angle formed by the light reflecting structure 2213 on which the light emitted from the second light-emitting assembly 212 is concentrated may be set to 30° to 50°. Setting the inclination angle θ within this range can enable the LED lighting device to form a better bat-wing light pattern. FIG. 31A shows a light pattern diagram of an LED lighting device where a first inclination angle β is set to 45° and an inclination angle θ of each of a first light reflecting plate 22131 and a second light reflecting plate 22132 relative to a light output center line L of a second light-emitting assembly 212 is set to 15°. At this time, the light pattern diagram of the LED lighting device presents a better bat-wing light pattern. If the inclination angle θ is less than 15°, the light reflecting structure 2213 will cause excessive concentration of the light emitted from the second light-emitting assembly 212, making it difficult to form a bat-wing light pattern. FIG. 31B shows a light pattern diagram of an LED lighting device where a first inclination angle β is set to 45° and an inclination angle θ of each of a first light reflecting plate 22131 and a second light reflecting plate 22132 relative to a light output center line L of a second light-emitting assembly 212 is set to 25°. Although the LED lighting device in FIG. 31B can still present a bat-wing light pattern, however, compared with FIG. 31A, the bat-wing light pattern begins to deteriorate. If the inclination angle θ continues to increase to greater than 25°, the concentration of the light emitted from the second light-emitting assembly 212 by the light reflecting structure 2213 will be insufficient, and the contribution of the second light-emitting assembly 212 to the light intensity in the peripheral region of the first light-emitting assembly 211 will be weakened, making it difficult to form a better bat-wing light pattern.

FIG. 30, FIG. 31A and FIG. 31B show embodiments only, in other embodiments the inclination angle θ of each of the first light reflecting plate 22131 and the second light reflecting plate 22132 relative to the light output center line L of the second light-emitting assembly 212 do not necessarily need to be set to be the same, as long as the inclination angle θ of each of the first light reflecting plate 22131 and the second light reflecting plate 22132 relative to the light output center line L of the second light-emitting assembly 212 is 15° to 25°.

The serrated lens, the TIR lens, and the light reflecting structure shown in FIG. 14 to FIG. 30 are only embodiment of the structures included in the light beam control assembly. Those skilled in the art can select any suitable component or structure as a part of the light beam control assembly based on requirements, as long as the light emitted from the second light-emitting assembly is mainly distributed in the peripheral region of the first light-emitting assembly by changing the path of part of the light emitted from the second light-emitting assembly, which is not limited in the present application. In other embodiments, the light beam control assembly may further include other components or structures for changing the light output path of the light-emitting unit to achieve better light output effect.

According to the aforementioned embodiments, the combination between light pattern distributions of any two opposite groups of second light-emitting assemblies 212 and the light pattern distribution of the first light-emitting assembly 211 can improve the illumination uniformity of the LED lighting device. Accordingly, a user can selectively turn on or off any two opposite groups or all of second light-emitting assemblies 212 by a control switch adapted to the LED lighting device based on actual illumination requirements. In this way, energy conservation can be achieved while meeting user requirements.

In some embodiments, the light pattern distribution formed by the LED lighting device is related to the first inclination angle β. Under the premise that the first inclination angle β enables the light intensity distribution of the LED lighting device to meet the uniformity requirements, the first inclination angle β is positively correlated with the light output angle of the LED lighting device. That is, the larger the first inclination angle β is, the larger the light output angle of the LED lighting device is. In the embodiments where the light pattern distribution of the LED lighting device is the bat-wing light pattern or the approximate bat-wing light pattern, the larger the first inclination angle β is, the wider an angle of the bat-wing light pattern or the approximate bat-wing light pattern is. Referring to FIGS. 32A and 32B. FIGS. 32A and 32B show light pattern diagrams of LED lighting devices with different first inclination angles in some embodiments of the present application. The LED lighting device configured with a structure as shown in FIG. 23 to FIG. 27 is an example. FIG. 32A is a light pattern diagram with a first inclination angle β configured to be 30°. FIG. 32B is a light pattern diagram with a first inclination angle β configured to be of 45°. By comparison, the first inclination angle β in FIG. 32A is smaller than that in FIG. 32B, and the angle of the bat-wing light pattern formed correspondingly is also narrower. Similarly, the first inclination angle β in FIG. 32B is larger than that in FIG. 32A and the angle of the bat-wing light pattern formed correspondingly is also wider. Therefore, those skilled in the art can adaptively configure the first inclination angle β based on actual application scenarios.

In some embodiments, power supply modes of the first light-emitting assembly and the second light-emitting assembly are further set to further improve the uniformity of the light pattern distribution of the LED lighting device, such as to make the LED lighting device present a more excellent bat-wing light pattern or approximate bat-wing light pattern. The power supply modes refer to electrical types transmitted to the light-emitting unit. In an embodiment or example where the photoelectric module further includes a power supply unit that is connected to an external power supply or a mains supply to supply power to the light-emitting unit, the power supply modes refers to the electrical types transmitted to the light-emitting unit by the power supply unit. The power supply modes include but are not limited to any of types including a supply voltage, a supply current, a supply frequency, etc. In an embodiment, the power supply mode of the second light-emitting assembly and the first light-emitting assembly are configured to be in a preset ratio, so as to improve the effect of the bat-wing light pattern formed by the LED lighting device. For example, the supply voltages of the second light-emitting assembly and the first light-emitting assembly can be configured to be in a preset ratio, so that the LED lighting device forms a light pattern distribution with low light intensity in the middle region and high light intensity in the peripheral region, namely the bat-wing light pattern. Further, the preset ratio of the supply voltages of the second light-emitting assembly and the first light-emitting assembly may be configured to be 1.5 to 3 (e.g., the ratio may be approximately 1.5, 2, 2.5, or 3), and more preferably, the preset ratio of the supply voltages of the second light-emitting assembly and the first light-emitting assembly may be configured to be 2 to 2.5.

To reduce glare of the lamp, in some embodiments, as shown in FIG. 1 to FIG. 5, FIG. 23 to FIG. 28, and FIG. 37, the light processing unit 22 further includes a diffusing member 222, where the diffusing member 222 is configured to diffuse light generated by the light-emitting unit 21. Further, in some embodiments, the diffusing member 222 is formed as an outer cover of the light-emitting unit 21 to provide shielding and protection for the light-emitting unit 21. In some embodiments, the outer cover of the light-emitting unit 22 is disposed alone as a part of the light processing unit 21, that is, the light processing unit 21 may further include multiple outer covers, such as a first outer cover and a second outer cover, which is not limited in the present application.

In some embodiments of the present application, the diffusing member 222 may also have other functions, such as convergence and light homogenization, which may also be referred to as a light converging element or others.

In an embodiment, as shown in FIG. 1 to FIG. 5, two diffusing members 222 are provided, including a first diffusing member 2221 and a second diffusing member 2222. The first diffusing member 2221 is disposed in a light output direction of the first light-emitting assembly 211 and configured to diffuse light generated by the first light-emitting assembly 211. The second diffusing member 2222 is disposed in a light output direction of the second light-emitting assembly 212 and configured to diffuse light generated by the second light-emitting assembly 212. In some embodiment, the light beam control assembly 221 is disposed on one side of the second diffusing member 2222 facing the second light-emitting assembly 212. For example, the light beam control assembly 221 is disposed on the second diffusing member 2222 by means of attachment or structural matching, so that the light emitted from the second light-emitting assembly 212 travels through the light beam control assembly 221 first and then diffused by the second diffusing member 2222. In some embodiments, the light beam control assembly 221 may also be disposed on one side of the first diffusing member 2221 facing the first light-emitting assembly 211, which is not limited in the present application. It should be understood that the case where there are two diffusing members 222 is only an embodiment. In other embodiment where the light-emitting unit 21 includes more light-emitting assemblies, more than two diffusing members 222 or at least one diffusing member 222 is provided. Each diffusing member performs light diffusion and/or shielding protection on the corresponding light-emitting assembly, which is not limited in the present application.

In an embodiment, the first diffusing member 2221 and/or the second diffusing member 2222 may be made of a PC material, which has a light diffusion function due to its material properties. For example, the first diffusing member 2221 and/or the second diffusing member 2222 is set as a milky white PC cover. In other embodiments, the first diffusing member 2221 and/or the second diffusing member 2222 may also be made of a transparent material, such as glass or plastic (e.g., acrylic sheets), and is provided with a diffusing layer on a surface to have the light diffusion function. As shown in FIG. 1 to FIG. 5, in other embodiment, the first diffusing member 2221 is an inverted trapezoidal cover structure, and the second diffusing member 2222 is a ring-shaped cover structure disposed at an outer edge of the first diffusing member 2221. When the first diffusing member 2221 and the second diffusing member 2222 are disposed on the support unit 1, they are connected to each other to cover a light-emitting surface of the light-emitting unit 21. One side of the second diffusing member 2222 facing the second light-emitting assembly 212 is provided with a mounting structure for disposing the light beam control assembly 221. The first diffusing member 2221 and the second diffusing member 2222 shown in FIG. 1 to FIG. 5 are only embodiments, and their structures and shapes can be varied based on aesthetic requirements and specific structures and shapes of the support unit 1 and the light-emitting unit 21, which is not limited in the present application.

In some embodiments, the first diffusing member 2221 may also be formed as an outer cover of the first light-emitting assembly 211 to provide shielding and protection for the first light-emitting assembly 211, and the second diffusing member 2222 may also be formed as an outer cover of the second light-emitting assembly 212 to provide shielding and protection for the second light-emitting assembly 212, where the first diffusing member 2221 may also be referred to as a first outer cover, and the second diffusing member 2222 may also be referred to as a second outer cover. In the embodiments shown in FIG. 1 to FIG. 5, the first diffusing member 2221 and/or the second diffusing member 2222 may serve as the outer covers respectively to provide shielding and protection for the first light-emitting assembly 211 and the second light-emitting assembly 212.

In an embodiment, as shown in FIG. 23 to FIG. 28, only one diffusing member 222 is provided. As shown in the figures, the diffusing member 222 includes a third diffusing member 2223. The third diffusing member 2223 is disposed in a light output direction of the first light-emitting assembly 211 and the second light-emitting assembly 212 to diffuse light generated by the two light-emitting assemblies (211, 212) during working. Further, the third diffusing member 2223 may also be formed as an outer cover of the two light-emitting assemblies (211, 212) to provide shielding and protection for the two light-emitting assemblies (211, 212).

In an embodiment, the third diffusing member 2223 is made of a PC material, which has a light diffusion function due to its material properties. For example, the third diffusing member 2223 is set as a milky white PC cover. In other embodiments, the third diffusing member 2223 is made of a transparent material, such as glass or plastic (e.g., acrylic sheets), and is provided with a diffusing layer on a surface to have the light diffusion function. As shown in FIG. 23 to FIG. 28, in an embodiment, the third diffusing member 2223 includes a connecting structure 22231 and a cover structure 22232. The connecting structure 22231 is formed on a periphery of the cover structure 22232 and configured to connect the third diffusing member 2223 to the support unit 1. For the observability reason, in the embodiments shown in FIG. 23 to FIG. 28, the cover structure 22232 is an arc-shaped cover. The cover structure 22232 is an inverted trapezoidal cover as shown in FIG. 1 to FIG. 5, which is not limited in structure and shape in the present application.

FIG. 1 to FIG. 5 and FIG. 23 to FIG. 28 are only illustrative of the diffusing member 222. The design of the number, structure, shape, etc. of diffusing members 222 only needs to ensure that the effect of the diffusing member on the light-emitting unit is not affected. Moreover, an association relationship between the diffusing member 222 and other parts of the LED lighting lamp shown in FIG. 1 to FIG. 5 and FIG. 23 to FIG. 28 is only illustrative and does not represent that the diffusing member 222 shown must correspondingly have the structure of the LED lighting device in the figures. In an embodiment, the third diffusing member 2223 used in FIG. 23 to FIG. 28 may be replaced with the first diffusing member 2221 and the second diffusing member 2222 in FIG. 1 to FIG. 5, and the first diffusing member 2221 and the second diffusing member 2222 used in FIG. 1 to FIG. 5 may also be replaced with the third diffusing member 2223 in FIG. 23 to FIG. 28.

To prevent the user from observing light beads of the light-emitting unit through the outer cover or the diffusing member, in an embodiment, four groups of first light-emitting assemblies 211 are provided and each group has 24 light-emitting bodies as shown in FIG. 5 to FIG. 7 and FIG. 24A to FIG. 26, a maximum distance between the outer cover and the first light-emitting assembly 211 is set from 12 cm to 20 cm (e.g., approximately 12 cm, 13 cm, 14 cm, 15 cm, 16 cm, 17 cm, 18 cm, 19 cm, or 20 cm), preferably 16 cm. In an embodiment the outer cover of the first light-emitting assembly 211 is the first diffusing member 2221 as shown in FIG. 5, a distance between an inverted trapezoidal bottom plate of the first diffusing member 2221 and the first light-emitting assembly 211 is set from 12 cm to 20 cm. In another embodiment, the outer cover of the first light-emitting assembly 211 is the third diffusing member 2223 as shown in FIG. 24A, a maximum distance between the third diffusing member 2223 and the first light-emitting assembly 211 is set from 12 cm to 20 cm. The range from 12 cm to 20 cm is only a reference range, and the distance is related to the number of groups and the distribution density of first light-emitting assemblies 211, the number and the distribution density of light-emitting bodies in each group of first light-emitting assemblies 211, etc. Those skilled in the art can select a suitable distance based on actual design under the inspiration of the present application.

In the embodiment where the light-emitting unit 21 includes the first light-emitting assembly 211, since a light-emitting angle of the first light-emitting assembly 211 is usually about 120°, the illumination of the first light-emitting assembly 211 will be uneven, and a dark region will be formed on the support unit 1 for supporting/bearing the first light-emitting assembly 211. For example, as shown in FIG. 6, the light-emitting unit 21 includes a first light-emitting assembly 211, where the first light-emitting assembly 211 is disposed on the base 11 of the support unit 1. Referring to FIG. 33. FIG. 33 shows a schematic diagram of light output from a first light-emitting assembly 211 in the embodiment of the present application shown in FIG. 6. As shown in the figure, since the light-emitting angle of the first light-emitting assembly 211 is approximately 120°, the light emitted from the first light-emitting assembly 211 cannot illuminate the back plate 12 located at the periphery of the base 11; alternatively, only a small region of the back plate 12 can be illuminated, so a relatively dark region will be formed on the support unit 1.

The formation of the dark region on the support unit 1 is due to the limited light-emitting angle of the first light-emitting assembly. In some embodiments, even if the support unit 1 adopts other structures, the dark region will still be formed on the support unit 1 under the light-emitting angle of the first light-emitting assembly 211. For example, referring to FIG. 34 and FIG. 35. FIG. 34 shows a schematic diagram of a three-dimensional structure of combination of a first light-emitting assembly 211 and a support unit 1 in an embodiment of the present application. FIG. 35 shows a schematic diagram of light output from a first light-emitting assembly 211 in the embodiment of the present application as shown in FIG. 34. In this embodiment, the base 11 of the support unit 1 is a planar structure, the back plate 12 is formed in a manner that the base 11 extends to the periphery, and in order to improve the uniformity of the light emitted, the back plate 12 is configured as a curved surface, namely, a curved surface formed in a manner that the base 11 extends to the periphery. In some embodiments, based on different structures and forms of the support unit 1, the base 11 and the back plate 12 may also be named in other ways. In the embodiment shown in FIG. 34, the base 11 may also be referred to as a first part/first region of the support unit 1, and the back plate 12 may also be referred to as a second part/second region of the support unit 1, which is not limited in the present application. In the structure of the support unit 1 used in FIG. 34, and as shown in FIG. 35, since the first light-emitting assembly 211 is disposed on the base 11 and has the light-emitting angle of 120°, almost no light shines on the curved surface formed by the back plate 12, thereby forming the dark region.

In order to solve the problem of the dark region is formed on the support unit 1 due to the limited light-emitting angle of the first light-emitting assembly 211, in some embodiments, as shown in FIG. 36 to FIG. 39, the light-emitting unit 21 may further include a third light-emitting assembly 213 on the basis of the first light-emitting assembly 211. A light output direction of the third light-emitting assembly 213 is designed to light the region outside the light-emitting angle of the first light-emitting assembly 211, thereby improving the uniformity of light on the surface of the support unit 1, and avoiding the above dark region.

In some embodiments, the light-emitting unit may further include other light-emitting assemblies on the basis of the first light-emitting assembly and the third light-emitting assembly, such as the second light-emitting assembly according to any of the previous embodiments. That is, the light-emitting unit may include the first light-emitting assembly, the second light-emitting assembly, and the third light-emitting assembly. In other words, the light-emitting unit includes at least one or at least two of the first light-emitting assembly, the second light-emitting assembly, or the third light-emitting assembly. The third light-emitting assembly is able to form light projected to the dark region on the support unit, and there are no restrictions on other light-emitting assemblies included in the light-emitting unit.

In an embodiment, referring to FIG. 36 to FIG. 39. FIG. 36 shows a schematic diagram of a three-dimensional structure of an LED lighting device in an embodiment of the present application. FIG. 37 shows a schematic diagram of a split structure of an LED lighting device in an embodiment of the present application shown in FIG. 36. FIG. 38 shows a schematic diagram of a three-dimensional structure of combination of a third light-emitting assembly 213 and a support unit 1 in an embodiment of the present application. FIG. 39 shows a schematic diagram of light output from a first light-emitting assembly 211 and a third light-emitting assembly 213 in the embodiment of the present application shown in FIG. 36. As shown in the figures, the light-emitting unit 21 includes a first light-emitting assembly 211 and a third light-emitting assembly 213. The first light-emitting assembly 211 is disposed on the base 11, and a center line of a light beam thereof is perpendicular to the base 11. The third light-emitting assembly 213 is located in the accommodating space defined by the support unit 1, a center line of a light beam thereof forms a certain included angle with the center line of the light beam of the first light-emitting assembly 211, and the light beam thereof faces the support unit 1 to be projected onto the back plate 12 of the support unit 1. That is, the light output direction of the third light-emitting assembly 213 faces a side surface of the device. Further, the center line of the light beam of the third light-emitting assembly 213 is perpendicular to the center line of the light beam of the first light-emitting assembly 211, and the light beam of the third light-emitting assembly is projected onto the back plate 12 of the support unit 1. In this embodiment, the light output direction is based on the center line of the light beam of the light-emitting assembly as a reference.

To fix the third light-emitting assembly 213, the support unit 1 further includes a support structure 14, where the support structure 14 is vertically (also referred to as perpendicularly) disposed on the base 11 of the support unit 1 and configured to place the third light-emitting assembly 213, that is, the third light-emitting assembly 213 is disposed on the support structure 14.

As shown in FIG. 38 to FIG. 40, in which FIG. 40 shows a schematic structural diagram of combination of a third light-emitting assembly and a support structure in an embodiment of the present application, the support structure 14 is a support plate, the support plate is perpendicularly fixed to the base 11, and the support plate has a first mounting surface 141 and a second mounting surface 142 that face in two opposite directions of the support unit 1 respectively, that is, the first mounting surface 141 and the second mounting surface 142 are two opposite surfaces of the support structure 14. Correspondingly, at least two groups of third light-emitting assemblies 213 facing in the two opposite directions of the support unit 1 respectively are provided, that is, at least one group of third light-emitting assemblies 213 is disposed on the first mounting surface 141, and at least one group of third light-emitting assemblies 213 is disposed on the second mounting surface 142. The support structure 14 is fixed to the base 11 by means of screw and nut fit. In some embodiment, the support structure 14 is fixed to the base 11 by means of adhesive materials, hot melting, welding, or be clamped on the base 11, for example, by means of structures such as clamping buckles or clamping hooks. To fix the support structure 14, a structure connected with the support structure 14 may be disposed on the base 11 for easy mounting of the support structure 14. The specific structure is not limited in the present application.

In an embodiment, the support structure 14 is disposed in a middle region of the base 11, and multiple groups of first light-emitting assemblies 211 are symmetrically distributed on two sides of the support structure 14.

In the embodiment, at least two groups of third light-emitting assemblies 213 are provided. For example, the number of groups of third light-emitting assemblies 213 may be set to 2, 3, 4, 5, or 6, as long as it is ensured that the two groups of third light-emitting assemblies face the two opposite directions of the support unit 1 respectively. The embodiment shown in FIG. 40 is used as an example. Referring to FIG. 39. In the embodiment shown in FIG. 39, six groups of third light-emitting assemblies 213 are symmetrically distributed on the first mounting surface 141 and the second mounting surface 142, that is, three groups of third light-emitting assemblies 213 are distributed on the first mounting surface 141 in parallel, and three groups of third light-emitting assemblies 213 are also disposed on the second mounting surface 142 corresponding to the first mounting surface 141. In this way, it can be further ensured that the entire front surface of the support unit 1 emits light uniformly.

The third light-emitting assembly 213 may include a third circuit board 2131 and a third light-emitting body 2132. The third light-emitting body 2132 may be an LED light bead or other types of LED light-emitting bodies. The third circuit board 2131 is attached (e.g., attached directly or attached through an intermediate medium) to the base 11. Multiple third light-emitting bodies 2132 may be provided, and the multiple third light-emitting bodies 2132 are uniformly distributed on the third circuit board 2131.

Considering that part of the light emitted from the first light-emitting assembly 211 will be projected to an edge region of the support unit 1, such as a region on one side of the back plate 12 away from the base 11, multiple groups of third light-emitting assemblies 213 continuing to project light to the region will cause the edge region of the support unit 1 to be too bright. Therefore, in some embodiments, the number of third light-emitting bodies 2132 of the third light-emitting assembly 213 is related to a distance between the third light-emitting assembly 213 and the base 11. When the distance between the third light-emitting assembly 213 and the base 11 of the support unit 1 exceeds a preset value, the number of third light-emitting bodies 2132 is reduced. Taking FIG. 40 as an example, on the first mounting surface 141, the number of third light-emitting bodies 2132 of the two groups of third light-emitting assemblies 213 closer to the base 11 is set to 48, and the number of third light-emitting bodies 2132 of the rest one group of third light-emitting assemblies 213 farthest from the base 11 is set to 26.

Referring to FIG. 41 to FIG. 43. FIG. 41 shows a light pattern diagram of an LED lighting device in the embodiment of the present application shown in FIG. 36. FIG. 42 shows an illuminance diagram of an illuminated surface at a distance of 2.5 m from an LED lighting device in the embodiment of the present application shown in FIG. 36. FIG. 43 shows an illuminance diagram of various regions in an LED lighting device in the embodiment of the present application shown in FIG. 36. The following describes the effects that the third light-emitting assembly 213 can improve the uniformity of the light emitted from the device and avoid the dark region with reference to FIG. 41 to FIG. 43.

As shown in FIG. 41, adding the third light-emitting assembly 213 on the basis of the first light-emitting assembly 211 in the LED lighting device will not have a negative impact on the light pattern of the LED lighting device, but will make the LED lighting device present the Lambertian light pattern or the approximate Lambertian light pattern. Further, the illuminance diagram of illuminated surface at the distance of 2.5 m from the LED lighting device is shown in FIG. 42 and also conforms to illuminance characteristics of the Lambertian light pattern or the approximate Lambertian light pattern, with uniform and soft illumination. As shown in FIG. 43, multiple regions of the back plate in the LED lighting device are selected and marked as E, F, G, and H respectively, and their corresponding illuminance diagrams are marked as (e), (f), (g), and (h) respectively. A corresponding region of the base of the LED lighting device is selected and marked as I, and its corresponding illuminance diagram is marked as (i). From comparison between the region I with the regions E, F, G, and H, it can be seen that the illuminance of the LED lighting device conforms to the characteristics of the Lambertian light pattern or the approximate Lambertian light pattern, that is, the region I has the highest illuminance, and the side regions E, F, G, and H have relatively low illuminance.

From comparison among the regions E, F, G, and H, it can be seen that the illuminance of each region in the side regions is generally within the same range, that is, the side regions (e.g., the back plate) of the LED lighting device are uniform as a whole, and there are no dark regions in the regions E, F, G, and H.

To reduce glare of the device, as described above, the light processing unit 22 includes the diffusing member 222. Further, in the embodiment as shown in FIG. 37, the diffusing member 222 includes a fourth diffusing member 2224, where the fourth diffusing member 2224 is disposed in a light output direction of the first light-emitting assembly 211 and the third light-emitting assembly 213, and is configured to diffuse light generated by the first light-emitting assembly 211 and the third light-emitting assembly 213 during working. With reference to the above description of the diffusing member in FIG. 1 to FIG. 5 and FIG. 23 to FIG. 28, the material and function of the fourth diffusing member 2224 are similar to those of the diffusing member used in FIG. 1 to FIG. 5 and FIG. 23 to FIG. 28, which will not be repeated herein.

Continuously referring to FIG. 39, since a light-emitting angle of the third light-emitting assembly 213 is also 120°, only the light from the first light-emitting assembly 211 contributes to the light intensity in the middle region of the device.

That is, the third light-emitting assembly 213 cannot illuminate a region between −30° to 30° with a vertical direction of the support structure 14 as a center line. However, in a region between −30° to −60 ° and a region between 30° to 60° with the vertical direction of the support structure 14 as the center line, both the first light-emitting assembly 211 and the third light-emitting assembly 213 contribute to the light intensity, so that the LED lighting device may have high illumination brightness contrast, thereby causing glare to human eyes.

As shown in FIG. 36 to FIG. 45, in which FIG. 44 shows a schematic diagram of a split structure of a light processing unit in the embodiment of the present application shown in FIG. 37, and FIG. 45 shows a schematic diagram of a sectional structure of an LED lighting device in the embodiment of the present application shown in FIG. 36, the light processing unit 22 further includes a shading assembly 223. The shading assembly 223 is connected and fixed to the diffusing member 222. The shading assembly 223 includes a shading portion 2231. The shading portion 2231 is disposed in the vertical direction of the support structure 14 and is close to one side of the support structure 14 away from the support unit 1. The shading portion 2231 extends along a length direction of the support structure 14, or extends along a length direction of the third light-emitting assembly 213, so that a region (e.g., the region of −30° to 30° with the vertical direction of the support structure 14 as the center line) not projected with the light from the third light-emitting assembly 213 can be shaded, thereby reducing discomfort of the human eyes.

In an embodiment, the shading portion 2231 is disposed on an outer side of the fourth diffusing member 2224 and is attached to the fourth diffusing member 2224. The shading portion 2231 is a metal long-strip-shaped object that fits in shape with the fourth diffusing member 2224. To facilitate the configuration of the shading portion 2231, the shading assembly 223 further includes a frame portion 2232. The frame portion 2232 can be formed in a manner that the shading portion 2231 continues to extend, can fix the shading portion 2231 to the outer side of the fourth diffusing member 2224, and can also be configured to position the fourth diffusing member 2224 on the support unit 1. In view of this, the fourth diffusing member 2224 has an outer surface that fits in shape with the shading portion 2231 and the frame portion 2232, making it convenient for the fourth diffusing member 2224 to be fixed without affecting the aesthetic appearance of the lamp.

The frame portion 2232 and the shading portion 2231 are integrally formed metal frame structure or are detachably or fixedly connected, or the frame portion 2232 wraps the shading portion 2231, which is not limited in the present application.

In other embodiments, the shading portion 2231 may also be disposed on an inner side of the fourth diffusing member 2224, and the fourth diffusing member 2224 is provided with a corresponding accommodating structure to facilitate configuration of the shading portion 2231.

In some other embodiments of the present application, the number of support structures 14 is greater than zero, or at least one. Multiple support structures 14 are arranged in parallel to better solve the problem with dark regions.

In some other embodiments of the present application, the number of support structures 14 is greater than zero, or at least one. The support structures 14 are arranged in a mutually staggered manner at a certain included angle, such as 90° or 45°. For example, the support structures are arranged in a “+” structure or occur in an “I”-shaped structure in some devices with large difference in length-width ratio, so that the light-emitting assemblies 213 located on the support structures 14 can project light to various corners of the LED lighting device, greatly reducing dark regions.

In some embodiments, the photoelectric module 2 may further include the power supply unit (not shown in the figures). The power supply unit is disposed on the support unit 1 and is electrically connected to the light-emitting unit 21, so as to be connected to the external power supply or the mains supply. Referring to FIG. 2, FIG. 3, and FIG. 36. To protect the power supply unit, the support unit 1 further includes a power supply module 3. The power supply module 3 includes a power supply box for providing a mounting space for the power supply module. In the embodiments shown in FIG. 2, FIG. 3, and FIG. 36, the power supply module 3 is disposed on a back surface of the support unit 1, and the power supply unit is disposed in the power supply box. In other examples, the power supply box may not be provided, and the power supply unit (the individual power supply unit may also be referred to as the power supply module) is directly disposed on the front surface or the back surface of the support unit 1. The power supply unit may include several electronic components and wiring components. The several electronic components are disposed on a corresponding circuit board of the power supply unit. In some embodiments, some of electronic components are disposed on a corresponding circuit board of the light-emitting unit 21 to share the same circuit board with the light-emitting unit 21.

Referring to FIG. 46 to FIG. 53 which show an LED lighting device in an embodiment of the present application. The device can emit light at multiple angles and can be referred to as a full-angle luminous LED lighting device. The device is a linear lamp mounted by means of hanging or a lamp fixedly mounted to the ceiling or the suspended ceiling. A spatial position of the LED lighting device is located in a Cartesian coordinate system as shown in FIG. 46 or FIG. 50. The LED lighting device includes a support unit 1, a photoelectric module 2, and a diffusing member 222 (the diffusing member may also be referred to as the light processing unit), where a plane where the support unit 1 is located is parallel to an x-y plane, the photoelectric module 2 emits light roughly along a z-axis direction, and the diffusing member 222 itself is roughly parallel to the x-y plane.

Referring to FIG. 46 to FIG. 47A, the supporting unit 1 has a portion of the structure extending from the edge toward the center that arches toward one side (for example, along the positive direction of the z-axis) to form a back plate 12. Specifically, an opened end of the back plate 12 connected to the support unit 1 serves as a bottom of the back plate, a closed end of the back plate 12 away from the support unit 1 serves as a top of the back plate, and an inner wall connected to the bottom of the back plate and a top surface of the back plate may be referred to as a sidewall. As a preference, the support unit 1 and the back plate 12 may be formed by means of stamping or injection molding of metal or plastic to improve the production efficiency and ensure the structural strength of a housing of the lamp. More preferably, the support unit 1 and the back plate 12 may be made of aluminum alloy to reduce the overall mass of the LED lighting lamp. Meanwhile, as the support unit 1 and the back plate 12 of the LED lighting device are made of the aluminum alloy, good thermal conductivity is achieved, and heat generated by the photoelectric module 2 can be fully transferred to the atmospheric environment, thereby improving the heat dissipation performance of the LED lighting device, and ensuring that the LED lighting device is always in a working environment with suitable temperature. Generally speaking, the working life of the LED lighting device can be effectively guaranteed under the condition that the ambient temperature does not exceed 35 °C. In some embodiments, the back plate 12 and the support unit 1 are integrally formed. In some other embodiments, the back plate 12 and the support unit 1 may be independently formed before assembly.

The specific shape of the support unit 1 is not limited and may be a strip shape, a circular shape, a rectangular shape, or other special-shaped structures. In this embodiment, the overall shape of the support unit 1 is a rectangular structure, and the edge of the support unit 1 may be designed to be folded upwards. Through edge folding treatment, a round edge that does not need to be extra processed and has high safety for use and mounting is formed. Meanwhile, edge folding enhances the structural strength of the edge of the support unit 1, and prevents the edge from deformation. Further, the appearance of the support unit 1 can be improved by edge folding. A right-angled corner of the support unit 1 is designed to be an arc-shaped chamfer, so that a sharp corner is avoided, thereby improving the safety during transportation and mounting.

Referring to FIG. 47A to FIG. 49B and FIG. 51A to FIG. 53, the photoelectric module 2 is disposed on the back plate 12. The photoelectric module 2 is connected to the back plate 12 in a detachable manner. For example, the photoelectric module 2 and the back plate 12 are connected using a clamping buckle/a snap-fitting structure, the photoelectric module 2 is connected to the top of the back plate 12 by screws, or the photoelectric module 2 may be adsorbed to the inside of the back plate 12 by means of magnetic attraction. The detachable connection manner facilitates replacement of the photoelectric module 2 of the faulty LED lighting device or components on the photoelectric module 2. In an embodiment, the photoelectric module 2 is fixed to the top of the back plate 12, but is not easily disassembled.

At least part of light emitted from the photoelectric module 2 is directed and projected to a periphery (also understood as a sidewall) of the back plate 12. Specifically, the photoelectric module 2 includes multiple rows of light strips (LED light beads or LED arrays, i.e., multiple light-emitting diodes/bodies) with different light output directions and angles, or at least two light output angles. The light strips are arranged along an x-axis direction and/or a y-axis direction, where some light strips are directed towards a groove opening of the back plate 12 and/or a top region of the back plate for light output, and some light strips can be directed towards the sidewall of the back plate 12 for light output. By dispersing the light emitted, dark regions around the back plate 12 are illuminated, until the brightness is equal to that at a central region of the back plate 12, thereby solving the problem of uneven brightness of the LED lighting device as a whole, and effectively improving the light output effect. The diffusing member 222 is disposed on one side of the photoelectric module 2 away from the top of the back plate 12. The diffusing member 222 covers at least part of the photoelectric module 2, that is, a projection of the diffusing member 222 in the z-axis direction is completely or at least partially cover the photoelectric module 2. As a preference, the diffusing member 222 completely covers the photoelectric module 2 to facilitate divergence of most of the light emitted from the photoelectric module 2, thereby making the light emitted from the LED lighting device more uniform and softer, and avoiding the problem of dazzle or glare caused by excessive concentration of the light emitted in the central region of the back plate 12. The photoelectric module 2 has at least two directions of light output. At least two light strips (LED light beads or LED arrays, i.e., at least two light-emitting bodies) are disposed on at least two mounting surfaces. From another perspective, optical axes or extension lines of optical axes of at least two light strips (LED lamp beads or LED arrays) are intersected. In an embodiment, at least two light strips (LED lamp beads or LED arrays) are disposed on upper and lower surfaces of the same mounting component.

A cover surface of the diffusing member 222 is slightly arched along a negative direction of the z axis to form a convex structure, that is, an arc-shaped structure, to better achieve light diffusion. The diffusing member 222 may be made of a light-transmitting material. As an example, the diffusing member 222 may also be made of a light-transmitting material such as glass or acrylic, and is provided with a diffusing layer or a diffusing film on a surface to achieve light diffusion. Alternatively, the diffusing member 222 may also be made of a partially transparent material. In an embodiment, the diffusing member 222 is a milky white PC cover with certain haze. Due to its material properties, the PC cover also has a light diffusion function, thereby making the emitted light softer.

Referring to FIG. 47A, FIG. 47B, and FIG. 51A. In an embodiment, the top of the back plate 12 is provided with a mounting hole 15. The mounting hole 15 may be located in the central region and/or the edge region of the top of the back plate 12. The number and shape of mounting holes are both not limited. The mounting holes 15 can be used with connectors such as bolts, hanging rods, and hanging chains to hang or mount the housing (i.e., the support unit 1 and the back plate 12) of the LED lighting device to the ceiling, thereby achieving the mounting of the LED lighting device.

In an embodiment, the mounting holes 15 is formed at the bottom of the back plate, such as at four corners of the bottom of the back plate. The LED lighting device is embedded in the mounting surface such as a ceiling. The bottom of the back plate is basically parallel to the mounting surface such as a ceiling. The height/thickness of the back plate 12 is hidden inside the ceiling. The surface of the bottom plate of the LED lighting device and the surface of the ceiling are coplanar and have a height difference of no more than twice the thickness of the edge of the plate. The overall surface formed between the mounted lamp and a mounting plane is flat, with a good visual effect.

In an embodiment, part of a region of the top of the back plate 12 is recessed towards the photoelectric module 2 to form a reinforcing rib 16, that is, different height regions are provided on the top surface of the back plate 12. By designing the reinforcing rib 16, the structural strength of part of the region of the top of the back plate 12 can be significantly improved, and the problems of warping and deformation of the LED lighting device during mounting can be avoided. In one embodiment, the reinforcing rib 16 may be of a single or multiple straight line structure or a reticular or divergent structure, without specific limitations. In an embodiment, the reinforcing rib 16 is of a single straight line structure extending along the y-axis direction, and the length of the reinforcing rib 16 does not exceed the length of the top of the back plate 12. Moreover, there are two mounting holes 15 formed in two ends of the reinforcing rib 16 respectively to balance the force on two ends of the LED lighting device and improve the stability and reliability after mounting. Certainly, if the back plate 12 itself has sufficient strength, the reinforcing rib 16 may also be omitted, thereby simplifying the production process.

Referring to FIG. 46 and FIG. 50, in some embodiments, the inner wall of the back plate 12 is provided with a reflective surface. Specifically, the reflective surface is an inner wall surface of the top and the sidewall of the back plate 12. The reflective surface can redistribute the light emitted by the photoelectric module 2 from different light output directions and angles to enhance the illumination uniformity of the light emitted and improve the illumination effect. In some embodiments, the reflective surface is a diffuse reflection surface, which can be obtained by means of machining or chemical treatment. The diffuse reflection surface can reflect the light in various directions to disperse the light, thereby reducing glare and local strong light. At the same time, the LED lighting lamp can emit the light in most light output direction, thereby avoiding local dark regions, and further improving the light output effect.

Referring to FIG. 46 to FIG. 49B, in an embodiment, the photoelectric module 2 of the LED lighting device includes a first bracket 210, a first light-emitting assembly 211′, and a second light-emitting assembly 212′, where the first light-emitting assembly and the second light-emitting assembly are described as a part of the light-emitting unit.

Referring to FIG. 47A to FIG. 47C, the first bracket 210 is disposed on the back plate 12, and the first bracket 210 is in a “concentric-rectangles”-shaped structure. In an embodiment, the first bracket 210 is in a vertical state or a nearly vertical state as a whole and is fixed to the back plate 12. The first bracket 210 includes two parts: an inner bracket 2101 and an outer bracket 2102 (see FIG. 47C and FIG. 49A). The inner bracket 2101 and the outer bracket 2102 are preferably made of an opaque material, such as opaque plastic, aluminum alloy, and carbon fibers, to reduce the weight of the LED lighting device. Both the inner bracket 2101 and the outer bracket 2102 have positions for mounting the LED light strips. The inner bracket 2101 and the outer bracket 2102 are spaced a certain distance from each other, and may have different included angles relative to the back plate 12. The inner bracket 2101 is surrounded by the outer bracket 2102. The inner bracket and the outer bracket may be of a sheet-like annular structure (the “concentric-rectangles”-shaped structure).

The first light-emitting assembly 211′ includes a first light-emitting body 2112′ and a first light-emitting body 2112″, where the first light-emitting body 2112′ is disposed on the back plate 12, preferably in the central region of the top of the back plate. The number of first light-emitting bodies 2112′ may be one, two, or more, and specifically is selected based on the actual required illumination brightness. In an embodiment, the first light-emitting body 2112′ is horizontally disposed at the reinforcing rib 16 of the back plate 12, and the first light-emitting body 2112′ emits the light approximately along the z-axis direction towards the central region of the diffusing member 222. The first light-emitting body 2112″ is disposed on the inner bracket 2101 of the first bracket 210, or on one surface of the inner bracket 2101 facing a first lamp strip 211. The number of first light-emitting bodies 2112″ may be two, four, or more, and specifically is varied based on the brightness effect of the first light-emitting body 2112′. In an embodiment, there are two first light-emitting bodies 2112″ symmetrically disposed on two sides of the first light-emitting body 2112′. The first light-emitting bodies 2112″ are vertically or obliquely mounted on the inner bracket 2101. In an embodiment, the inner bracket 2101 is provided with an inclined mounting surface. The inclined mounting surface causes more light to be emitted from the diffusing member 222, that is, there is high degree of overlap between a light output angle and a diffusing cover. The first light-emitting body 2112″ is obliquely disposed on the mounting surface, and a light output direction of the first light-emitting body 2112″ intersects with the negative direction of the z axis, so that the light emitted is emitted towards the edge region of the diffusing member 222. By the cooperation of the first light-emitting body 2112′ and the first light-emitting body 2112″, all parts of the diffusing member 222 of the LED lighting device can be uniformly illuminated, thereby improving the light output effect.

The second light-emitting assembly 212′ is an LED light strip. The second light-emitting assembly 212′ is disposed on an outer edge region, namely the outer bracket 2102 of the first bracket 210. The number of second light-emitting assemblies 212′ may be one, two, four, or more. The second light-emitting assembly 212′ may also be vertically or obliquely mounted on the outer bracket 2102 to achieve light output from different directions and angles. In an embodiment, there are four second light-emitting assemblies 212′ uniformly disposed in a vertical state around the outer bracket 2102. The second light-emitting assembly 212′ emit light along the x-axis and y-axis directions to uniformly illuminate the top region and the sidewall region of the back plate 12, so that the brightness of all regions of the entire device tends to be consistent, thereby improving the aesthetics and illumination effect of the LED lighting device.

Referring to FIG. 49B that is a schematic structural diagram of a first bracket 210 in the present application. Referring to FIG. 46 to FIG. 49A, a part close to the inner side surface of the first bracket 210 in the vertical state may be referred to as the inner bracket 2101, and a part close to the outer side surface thereof in the vertical state may be referred to as the outer bracket 2102. At one end of the inner bracket 2101 and the outer bracket 2102 facing the diffuser 222, a certain length of eave extends outward. The eave may be horizontal or have a certain angle, and plays a role in shading. For ease of description, the eave is referred to as a shading eave 23 hereinafter. The angles of the inner bracket 2101, the outer bracket 2102, and the shading eave 23 can be specifically designed based on actual requirements and are not only limited to the examples in the embodiments of the present application. The inner bracket 2101, the outer bracket 2102, and the shading eave 23 may be integrally formed or may be assembled into a whole after being formed separately.

Overall, the photoelectric module 2 in the full angles luminous LED lighting device according to an embodiment has a simplified structure and a beautiful shape. By establishing different directions and angles of light output paths, light is reflected and diffused by the back plate 12 and the diffusing member 222, so that the light output effect of the LED lighting device is effectively improved.

Referring to FIG. 49A, an included angle a between a plane where the first light-emitting body 2112″ is located and a plane where the top of the back plate 12 is located is greater than 90°. In an embodiment, the included angle a is greater than 90° and less than 150°. Within this range of angle a, it can be ensured that the first light-emitting body 2112″ emits light towards the edge region or the central region of the diffusing member 222. In an embodiment, the included angle a between the plane where the first light-emitting body 2112″ is located and the plane where the top of the back plate 12 is located is 120°. The light output direction of the first light-emitting body 2112″ is towards the edge region of the diffusing member 222, which can reduce the range of overlap with the light emitted from the first light-emitting body 2112′, thereby making the first light-emitting assembly 211′ emit light dispersedly, and improving the uniformity of illumination.

In an embodiment, a periphery of one end of the first bracket 210 away from the top of the back plate 12 extends radially to form the shading eave 23. Specifically, the shading eave 23 is formed in a manner that one end of the inner bracket 2101 of the first bracket 210 is bent and extends out in a nearly horizontal state. The shading eave 23 is an annular structure as a whole (see FIG. 47A and FIG. 49B). After the shading eave 23 is formed, the shading eave 23 form a shading region with the outer side surface of the first bracket 210. An outer LED light strip is located in the shading region. By providing the shading eaves 23 to perform shading, the surrounding outer LED light strip cannot be visible to the naked eyes within a certain range. As the outer LED light strip is hidden in the shading region, even if people look directly at the LED lighting device, there will be no problem of glare or dazzle.

In addition to having the functions of shading and glare prevention, the shading eave 23 can also be used as an additional mounting surface. The second light-emitting assembly 212′ is not limited to being mounted on the outer bracket 2102, but may also be horizontally or obliquely disposed on a surface (not shown) of the shading eave 23 facing the diffusing member 222 or away from the diffusing member 222, thereby playing a role in light supplementation, and avoiding the problem of dark regions caused by excessive darkness of local regions. Moreover, the shading eaves 23 serves as an additional installation surface to alleviate the problem of lack of installation locations on the outer bracket 2102, and are beneficial to the layout and installation of the outer light source.

In an embodiment, the diffusing member 222 is in an arc-shaped plate-like structure. The diffusing member 222 in such shape is attractive and can more evenly disperse light, thereby reducing the glare effect of the LED lighting device. In addition, a contour area of the diffusing member 222 is greater than a contour area of the first bracket 210 to fully shield the photoelectric module 2. Even if there is no shading eave 23, the diffusing member 222 with a large area can also play a role in shielding, thereby avoiding the problem of glare or dazzle caused by directly looking at the outer LED light strip. A farthest point of the diffusing member 222 along the light output direction of the LED lighting device is smaller than any point on the bottom plate of the base 1, that is, the diffusing member 222 is completely accommodated in the LED lighting device.

Referring to FIG. 49C that is a brief schematic diagram of light output from an LED lighting device in an embodiment of the application, where a dashed line is a brief illustration of light. An outer side of the first bracket 210, namely the outer bracket 2102 emits light towards a sidewall with a specific radian and reflective effect. The light emitted from the outer bracket 2102 is reflected through at least one layer and then emitted from an outer edge region of the LED lighting device, so that the outer edge of the LED lighting device has a better light output effect. The diffusing member 222 performs light processing (e.g., homogenization or diffusion) on the light emitted from the second light strip on the inner bracket 2101 and the light emitted from the first light strip 221 on the reinforcing rib 16, and then the light is emitted from the relatively central region of the LED lighting device. Accordingly, the edge and center of the LED lighting device have approximately the same light output and have nearly the same brightness in visual effect, that is, almost all regions of the LED lighting device, such as more than 90% of the regions, have the light output effect.

In some other embodiments, the proportion of the regions of the LED lighting device with the light output effect may also be more than 50%, more than 60%, and so on.

Referring to FIG. 50 to FIG. 53, in an embodiment, the photoelectric module 2 of the full angles luminous LED lighting device includes a second bracket 220, a first light-emitting assembly 211″, a second light-emitting assembly 212″, and a strip lens 25.

The second bracket 220 is fixed to the back plate 12. in an embodiment, the second bracket 220 can be suspended in the back plate 12. A hanging portion 24 is disposed between the second bracket 220 and the top of the back plate 12, and the second bracket and the top of the back plate are connected by the hanging portion 24, that is, the hanging portion 24 has one end fixed to the back plate 12 and the other end fixed to the second bracket 220. In an embodiment, the hanging portion 24 may be of a hollow tubular structure to reduce weight, and the wiring can be arranged or not according to the needs. The height of the hanging portion 24 determines the position of the second bracket 220. In order to fully illuminate an upper half region of the back plate 12, a distance from the second bracket 220 to the top of the back plate 12 is greater than a distance from the second bracket 220 to the bottom plate of the back plate 12. The second bracket 220 is roughly in a “closed-rectangle”-shaped structure, and upper and lower surfaces thereof are both provided with mounting positions for easy mounting of the first light-emitting assembly 211″ and the second light-emitting assembly 212″.

Referring to FIG. 51A to FIG. 51D, the first light-emitting assembly 211″ and the second light-emitting assembly 212″ are also LED light strips, where the first light-emitting assembly 211″ is disposed on an upper surface of the second bracket 220, and the first light-emitting assembly 211″ emits light approximately along the positive direction of the z axis to provide illumination for the top and the upper half sidewall of the back plate 12. The number of first light-emitting assemblies 211″ may be two, four, or more. The second light-emitting assembly 212″ is disposed on a lower surface of the second bracket 220, and the second light-emitting assembly 212″ emits light approximately along the negative direction of the z axis to provide illumination for the bottom and the lower half sidewall of the back plate 12. The number of second light-emitting assemblies 212″ may also be two, four, or more. In an embodiment, the number of first light-emitting assemblies 211″ is four, and the number of second light-emitting assemblies 212″ is four; in an embodiment, the number of first light-emitting assemblies 211″ is two, and the number of second light-emitting assemblies 212″ is two; in one embodiment, the number of first light-emitting assemblies 211″ is two, and the number of second light-emitting assemblies 212″ is four. The number of first light-emitting assemblies 211″ and the number of second light-emitting assemblies 212″ are not specifically limited, as long as the light can be emitted uniformly and the illumination effect can be improved. In an embodiment, there are two first light-emitting assemblies 211″ symmetrically disposed on two sides of the upper surface of the second bracket 220, and there are four second light-emitting assemblies 212″ disposed on four sides of the lower surface of the second bracket 220 respectively. By arranging the light-emitting assemblies on the four sides of the second bracket 220, the light can be emitted more uniformly, and the illumination effect can be improved.

Referring to FIG. 51C and FIG. 51D, both the strip lens 25 and the diffusing member 222 have corresponding cavities for accommodating the LED light strips, and the cavities form enclosed spaces with the upper and lower surfaces of the second bracket 220 respectively to provide protective structures for the LED light strips. Further, the cavities of the strip lens 25 and the diffusing member 222 are both designed with specific surface shapes to achieve different light effects, where the total length of the LED light strip is less than the total length of the cavity.

In addition, the second bracket 220 may also be in a “I”-shaped structure (not shown), the upper and lower surfaces of the second bracket are also provided with mounting positions, and the first light-emitting assembly 211″ and the second light-emitting assembly 212″ can be rectilinearly disposed on the upper and lower surfaces of the second bracket 220, which also achieves a relatively uniform light output effect. In some other embodiments, the second bracket 220 is other structures, such as wavy or rectangular surfaces.

The photoelectric module 2 in the above full angles luminous LED lighting device is hung in design, also has a simplified structure and a beautiful shape, and can improve the aesthetics and illumination effect of the LED lighting device. In an embodiment of the present application, one end of the hanging portion 24 is fixed to the back plate 12 near the mounting hole 15 and disposed in the support unit 1, that is, in the light output direction of the device, one end of the hanging portion is fixed by means of screws, glue, clamping buckles/snap fitting, etc., and the other end of the hanging portion is fixed to one surface of the second bracket 220, where the hanging portion 24 and the second bracket 220 may be integrally formed or fixed to each other after being formed separately.

In an embodiment of the present application, the hanging portion 24 may also be fixed by passing through the mounting hole 15, that is, the hanging portion 24 has a large end and a small end, a projection area of the large end along the Z axis is greater than the mounting hole 15, and a projection area of the small end is less than the mounting hole 15. During mounting, the small end of the hanging portion 24 passes through the mounting hole 15, and the large end is stuck on the outer side of the bottom plate 1, that is, in an opposite direction of the light output direction of the lamp, fixation may also be achieved under the gravity without additional fixation (see FIG. 53).

As shown in FIG. 51A to FIG. 53, the upper part of the first light-emitting assembly 211″ is covered by the strip lens 25. The strip lens 25 is in a strip shape and is configured to guide light emitted from an upper LED source to be dispersed towards two sides, so as to more evenly illuminate the middle and surrounding regions of the support unit 1.

Along a direction perpendicular to the length of the strip lens 25, that is, a radial direction, a cross-section of the strip lens 25 is of a semi-circular structure or an arc-shaped structure as a whole. A light strip cavity 250 is formed inside the strip lens 25. A section of the light strip cavity 250 may be in a triangular shape, an arc-shaped shape, or a semi-circular shape parallel to the semi-circular shape of the cross-section of the strip lens 25, which is not limited to this, and can be set based on actual light output requirements. In the present application, the light strip cavity 250 has a smooth surface, but in other embodiments, the surface is an uneven surface, such as a frosted surface, a continuous concave-convex surface, or a Fresnel lens surface, to meet different light effects, such as diffuse reflection. Specifically, when the light emitted from the first light-emitting assembly 211″ is emitted out from the light strip cavity 250, the light will be refracted. The luminous flux of any first light-emitting assembly 211″ facing the middle of the back plate 12 will be less than the luminous flux facing the surrounding region of the support unit 1. However, after the luminous fluxes of two first light-emitting assemblies 211″ facing the middle of the back plate 12 are superimposed, the superimposed luminous flux will almost be consistent with the luminous flux of any first light-emitting assembly 211″ facing the surrounding region of the back plate 12, so that the entire LED lighting device will not have dark regions, thereby improving the illumination effect. The length of the light strip cavity 250 in the strip lens 25 is more than 80% of the total length of the strip lens 25. Two ends of the strip lens 25 may be integrally formed closed surfaces or separate closed surfaces, or the lamp strip cavity 250 completely penetrates through the strip lens 25.

In an embodiment, the strip lens 25 are formed by arranging independent individual lenses.

In an embodiment, the brightness of the second light-emitting assembly 212″ after passing through the diffusing member 222 is one-third to one-fifth of the brightness of the first light-emitting assembly 211″ after passing through the strip lens 25, preferably one-quarter. In an embodiment, the first light-emitting assembly 211″ provides about 80% of the light source upwards, and the second light-emitting assembly 212″ provides about 20% of the light source downwards. The light is reflected by the back plate 12 and then emitted, which can effectively improve the illumination effect.

In an embodiment, the diffusing member 222 is in a “concentric-rectangles”-shaped structure and is fixedly connected to the second bracket 220; and the second light-emitting assembly 212″ is located in the diffusing member 222, and the light is dispersed and atomized by the diffusing member 222 to achieve the better light output effect.

Referring to FIG. 46 and FIG. 50, in an embodiment, the diffusing member 222 is located on the back plate 12 or flush with the plane where the opening of the back plate 12 is located, so as to improve the appearance of the LED lighting device.

In an embodiment, the LED light strip in the above embodiments of the present application is composed of LED lamp filament, LED light bead arrays, lamp bulbs, or other forms not limited to this.

In an embodiment of the present application, light source boards in different directions are further disposed so that the photoelectric module has more diverse and uniform light output directions, thereby further improving the uniformity of the light emitted. Through the arrangement of the light source boards, more mounting spaces are provided for mounting the light-emitting assemblies in the photoelectric module. According to the definition of the XYZ rectangular coordinate system established in FIG. 54, one side located in the positive direction of the X axis is defined as a right side, and one side located in the negative direction of the X axis is defined as a left side; one side located in the positive direction of the Y axis is defined as a front side, and one side located in the negative direction of the Y axis is defined as a rear side; one side located in the positive direction of the Z axis is defined as an upper side, and one side located in the negative direction of the Z axis is defined as a lower side.

The following describes the LED lighting device (hereinafter referred to as the LED lighting device) proposed in the present application with reference to the accompanying drawings.

As shown in FIG. 54 and FIG. 55, an LED lighting device proposed in the present application includes: a support unit 1, a diffusing member 222 (or a light processing unit), a power supply module 3, and a photoelectric module 2. The device is fixed to a mounting surface, such as an indoor ceiling, by the support unit 1 to achieve indoor illumination. Two ends of the diffusing member 222 extending along the X-axis direction, namely the length direction of the device, are fixedly connected to the support unit 1 by diffusing member end caps 22210. The illumination uniformity of the device is improved by the diffusing member 222.

Meanwhile, the curved surface of the diffusing member 222 is combined with the support unit 1 to form a light output surface with complete surface shape in the light output direction of the lamp, namely the positive direction of the Z axis, thereby ensuring visual integrity, and enhancing the external aesthetics of the device. A light source is powered by the power supply module 3. The photoelectric module 2 is disposed between the support unit 1 and the diffusing member 222, and provides a first light-emitting assembly 211″ and a second light-emitting assembly 212″ to expand the illumination range. The diffusing member 222 covers the photoelectric module 2. More specifically, the diffusing member at least partially or completely covers the photoelectric module 2, or at least partially or completely covers the light-emitting assembly.

As shown in FIG. 55, the support unit 1 specifically includes a base 11. The base 11 is fixed and connected to the mounting surface by means of screws, clamping buckles, embedding, or the like. The base 11 is an arc-shaped structure or a square structure based on actual requirements.

As shown in FIG. 54, FIG. 55, and FIG. 61, in an embodiment, the base 11 is a square structure. Front and rear ends of the base 11 are connected to sidewalls extending upwards, which may also be first base sidewalls 112′. The base 11 and the first base sidewalls 112′ at two ends is an integrated structure, which is integrally formed by means of a stamping process, so that the production process is relatively simple, and the structural strength is relatively high. The base and the first base sidewalls may also be set to be of a split structure, so that the disassembly is convenient, and it is convenient for a staff to carry out maintenance and other work. The support unit 1 further includes a back plate 12. The back plate 12 is stacked on the base 11. The back plate 12 is set to be of a structure with wide top and narrow bottom. Specifically, the width of an upper end of the back plate 12 in a front-rear direction is D1, the width of a lower end of the back plate 12 in the front-rear direction is D2, and the width of upper ends of the two first base sidewalls 112′ on both sides of the base 11 in the front-rear direction is D3, where D1 is greater than or equal to D2. To ensure that the back plate 12 can be conveniently placed into the support unit 1, D3 is greater than D2, D3 is slightly greater than or equal to D1, and the height of the base 11 in an up-down direction is greater than that of the back plate 12, thereby ensuring that the base 11 and an upper edge of the back plate 12 can be closely attached without a gap or light leakage. In a specific embodiment, the back plate 12 is a square structure or an arc-shaped structure with sides connected to a support plate.

As shown in FIG. 55, a central axis of the back plate 12 extending along the length direction is provided with an upward protrusion 123, an accommodating cavity is formed between the back plate and the base 11, the power supply module 3 is disposed inside the accommodating cavity and fixedly connected to the base 11, a position of the base 11 corresponding to the power supply module 3 is provided with an opening, and a wiring board 33 is electrically connected to an external circuit through the opening. The power supply module 3 is disposed on the support unit 1 to achieve space reuse, which can effectively save space and reduce the overall height of the device. Meanwhile, the power supply module 3 and the support unit 1 do not need to be separately packaged, thus decreasing the packaging size, and reducing costs.

As shown in FIG. 59, the protrusion 123 extends left and right along the length direction of the lamp. From a cross-sectional perspective, the shape of the protrusion 123 is similar to a trapezoid. An upper end surface of the protrusion is set as a relatively flat horizontal plane, so that it is convenient for the photoelectric module 2 to be mounted on the upper end surface of the protrusion 123. Two side surfaces of the protrusion are set as inclined surfaces with a certain inclination angle, so that light emitted from a lateral light source of the photoelectric module 2 can be reflected to a certain extent, thereby further enhancing the lateral light output of the device, reducing dark regions, avoiding excessive concentration of the light emitted, and enhancing the uniformity of illumination.

As shown in FIG. 62, in another specific embodiment, the base 11 is an arc-shaped structure with an upward opening. The arc shape of the base 11 is up-warped to form a certain space. The power supply module 3 is disposed in the space formed by up-warping the arc shape of the base 11. Outside the support unit 1, the power supply module can be disposed without increasing the overall thickness of the device.

A central axis of the base 11 extending along the length direction is provided with an upward protrusion. The power supply module 3 is disposed inside the protrusion and fixed to the mounting surface. The power supply module 3 is disposed in the support unit 1, so that the height and size of the lamp are not additionally increased, and the aesthetics of the lamp is improved. The protrusion has the same function as in the above embodiment, and the relatively flat upper surface thereof can be used to fix a light source module, which will not be repeated herein.

As shown in FIG. 55, the power supply module 3 includes a power supply circuit board 31. The power supply circuit board 31 is fixed to the support unit 1 by means of screws, adhesion, or snap fitting. The power supply circuit board 31 is provided with a wiring board 33. The wiring board 33 is connected to the external circuit by a lead. A first power supply 32 is disposed closed to the wiring board 33.

The first power supply 32 is electrically connected to the wiring board 33.

As shown in FIG. 55, FIG. 58, FIG. 59, and FIG. 60A, the back plate 12 is provided with a photoelectric module 2. The photoelectric module 2 includes a light source board 201. A central axis of the light source board 201 is provided with a groove 202. Two sides of an upper surface of the light source board 201 are symmetrical with respective to the groove 202 as a center. A surface of the groove 202 intersects with a plane where the upper surface is located, and an included angle between the surface and the upper end surface can be regulated. In an embodiment of the present application, the surface is approximately perpendicular to the upper surface. The upper surface is provided with two groups of first light-emitting assemblies 211″. The symmetrical arrangement can effectively ensure the illumination uniformity of front light. Each group of first light-emitting assemblies 211″ includes a first circuit board 2111′ disposed on the light source board 201. The first circuit board 2111′ is provided with several first light-emitting bodies 2112″ arranged in a manner of extending along the length direction in two rows. When the first light-emitting body 2112″ is powered on, the first light-emitting body 2112″ emits upward illuminating light. The number of first light-emitting bodies 2112″ can be varied based on the actual required illumination intensity. The larger the number of the first light-emitting bodies 2112″ is, the higher the front illumination intensity of the LED lighting device is. In this embodiment, the first circuit boards 2111′ on two sides are each provided with at least one row of first light-emitting bodies 2112″ (e.g., one row or two rows). That is, the photoelectric module 2 has at least two directions of light output. The base 11 includes a bottom plate 111. The bottom plate 111 and the first base sidewall 112′ (or the sidewall) form an accommodating cavity in combination with a second end cap 4. The photoelectric module 2, the power supply module 3, and the back plate 12 are disposed in the accommodating cavity. The height of the diffusing member 222 is less than or equal to the height of the first base sidewall 112′ along the positive direction of the Z axis, so as to ensure the overall mounting aesthetics of the lamp and prevent the diffusing member 222 from protruding from the support unit 1. When the diffusing member 222 protrudes from the support unit 1, the diffusing member is easily contacted (collided) by an outside object to be damaged. The back plate 12 further includes a light output curved surface 121 and a combining portion 122, where the light output curved surface 121 corresponds to the lateral light emitted from the diffusing member 222, and the lateral light emitted from the diffusing member 222 is processed and then emitted from the light output direction. The light output curved surface 121 may have a reflection function, a transmission function, a refraction function, a diffusion function, etc., or have at least two or more light processing functions at the same time. When the lateral light emitted from the diffusing member 222 reaches the light output curved surface 121, part of the light is directly reflected, and part of the light penetrates through the light output curved surface 121 and reaches the support unit 1, and then is reflected by the support unit 1 and transmitted from the light output curved surface 121. The above process can occur for one or more times. In an embodiment, all of the lateral light emitted from the diffusing member 222 is reflected from the light output curved surface 121 without reaching the support unit 1. The back plate 12 further has a combining portion 122. The combining portion 122 is combined with an end part of the first base sidewall 112′, namely one end along the positive direction of the Z axis, by means of clamping buckles. In an embodiment, when the combining portion 122 is a bent structure, and the end part of the first base sidewall 112′ has a matched bend. Fixation can be completed by pressing the combining portion 122 to the end part of the first base sidewall 112′. In an embodiment, in other means, fixation may also be implemented by forming a bent snap-fitting portion through hot pressing, or by additional components such as screws, fixing frames, etc.

As shown in FIG. 58 and FIG. 59, two opposite outer side surfaces of the groove 202 are provided with second light-emitting assemblies 212″. The bottom of the groove 202 is fixed to the protrusion of the back plate 12 by means of screws (or glue, welding, or clamping buckles), so that there is a certain height difference between the second light-emitting assembly 212″ and the back plate 12, thereby effectively expanding the illumination range of the second light-emitting assembly 212″, namely expanding the light-emitting range of the second light-emitting assembly 212″ to a certain extent. The second light-emitting assembly 212″ includes a second circuit board 2121′ disposed on an outer sidewall of the groove 202. The second circuit board 2121′ is provided with several second light-emitting bodies 2122″ arranged in a manner of extending along the direction of a long axis. When the second light-emitting body 2122″ is powered on, the second light-emitting body 2122″ emits lateral illuminating light. The number of second light-emitting bodies 2122″ can be varied based on the actual required illumination intensity. The larger the number of second light-emitting bodies 2122″ is, the higher the lateral illumination intensity of a lamp body is. In this embodiment, the second circuit boards 2121′ on two sides are each provided with a row of second light-emitting bodies 2122″.

In some other embodiments of the present application, the light beads may also be disposed on the lower surface of the light source board 201, the inclined surface of the protrusion 123, or other positions. That is, the light emitted from the photoelectric module 2 can be arranged at different positions through multiple light beads, so that the light output angle covers a range of 180° along the light output direction based on the plane where the bottom plate 111 is located.

Referring to FIG. 60A, FIG. 60B, and FIG. 60C, the light source board 201 is used, that is, the light source board 201 has mounting surfaces at different angles for mounting the light-emitting bodies. The light-emitting bodies at different angles emit light to form light emitted from the LED lighting device. Compared with a conventional LED lighting device, the light output angle is larger, and the light emitted is softer. With the bottom plate 111 as a reference plane, the light output angle of the LED lighting device is 180°, that is, all corners of the LED lighting device along the light output direction can be illuminated by the light emitted, thereby avoiding dark regions in the LED lighting device.

Referring to FIG. 60B, the light-emitting unit 21 is simplified, and the structure is represented by that as shown in the figure. Multiple light-emitting bodies are arranged in different directions, so that the light output range of the light-emitting unit 21 on any plane can reach a sector range of 180° centered on the light-emitting unit 21, as shown by a in the figure, namely a hemispherical range centered on the light-emitting unit 21 in stereoscopic space, as shown in FIG. 60D.

Referring to FIG. 60C, the light-emitting unit 21 is provided with light-emitting bodies in different directions, so that light-emitting angles b1 and b2 of light emitted from the light-emitting unit 21 towards two sides along a perpendicular bisector of the light-emitting unit 21 can reach the maximum angle of 90° defined by the perpendicular bisector and the bottom plate 111, thereby avoiding dark regions in the light output direction of the LED lighting device.

As shown in FIG. 54, FIG. 55, and FIG. 64A, a diffusing member 222 is disposed above the photoelectric module 2, an accommodating cavity 2225 for accommodating the photoelectric module 2 is formed in the diffusing member 222, the diffusing member 222 is fixedly connected to the support unit 1, and the photoelectric module 2 is disposed between the diffusing member 222 and the support unit 1. The diffusing member 222 is made of a material with a light-transmitting characteristic and light diffusion performance. Preferably, the diffusing member 222 is made of, but not limited to, a PP (Polypropylene) diffusing plate. The diffusing member 222 made of the PP diffusing plate not only has high light transmittance, but also has good light diffusion effect, which can avoid the problem of glare. An arc-shaped or square structure of the diffusing member 222 can be selected based on specific implementation effects, which improves the aesthetics of the lamp while enhancing the diffusion effect of light.

As shown in FIG. 60A that is a schematic sectional view of an LED lighting device along a direction perpendicular to a photoelectric module in an embodiment of the present application, at least a part of the light emitted from the photoelectric module 2 located in the accommodating cavity 2225 points to the back plate 12, that is, at least part of the light emitted is emitted from the diffusing member 222 and part of the light is projected to the back plate 12 and finally is emitted from the LED lighting device after being reflected by the back plate 12.

In an embodiment of the present application, the back plate 12 has reflection and projection functions. After the light emitted from the photoelectric module 2 is processed by the diffusing member 222, at least a part of the light is reflected by the back plate 12 before being emitted, and at least a part of the light is projected onto the base 11 through the back plate 12 and then is reflected by the base 11 and transmitted the back plate 12.

As shown in FIG. 55 and FIG. 58, in an embodiment, the inner surface or the outer surface of the diffusing member 222 can be patterned, that is, a specific pattern structure, such as a striped structure, a point-like protrusion or recess, or a frosted structure, namely optical microstructures arranged in an array, i.e., optical microarray structures, is formed on the inner surface or the outer surface. When the photoelectric module 2 is accommodated in the accommodating cavity 2225 and emits light, the excessively concentrated light can be effectively dispersed after being subjected to optical processing such as diffuse reflection or refraction by the patterned structure of the inner surface or the outer surface, thereby avoiding the problem of dazzle or glare caused by a point light source in the lamp body, and achieving a uniform light-emitting effect and softer light. In this embodiment, a striped structure 2227 is disposed on the inner surface of the diffusing member 222.

As shown in FIG. 60A that is a schematic diagram of emission in a simple light path, the first light-emitting assembly 211″ emits light upwards. Through the arc-shaped structure of the diffusing member 222 and the patterned structure on the diffusing member, the diffusion effect of light is enhanced, and the glare is avoided. For the light emitted from the second light-emitting assembly 212″, part of the light is reflected to the two sides of the lamp under the light reflecting effect of the lower surface of the light source board 201 and/or the inclined surface of the protrusion 123, thereby improving the uniformity of illumination, and reducing the dark regions.

As shown in FIG. 54 to FIG. 56, two ends of the diffusing member 222 along the length direction are provided with diffusing member end caps 22210. A bottom of the diffusing member end cap 22210 is attached to the support unit 1. A snap-fitting groove 222101 is formed in a position of the diffusing member end cap 22210 corresponding to the light source board 201. The light source board 201 is clamped in the snap-fitting groove 222101. The diffusing member 222 is connected to the photoelectric module 2 by the diffusing member end caps 22210, thus effectively preventing light leakage at the two ends of the diffusing member 222.

As shown in FIG. 54 to FIG. 57, two ends of the support unit 1 are provided with second end caps 13, an outer side of the diffusing member end cap 22210 is provided with an insertion block 222102, and an insertion hole 131 is formed in a position of the second end cap 13 corresponding to the insertion block 222102. The mutual cooperation between the insertion block 222102 and the insertion hole 131 makes it faster and more convenient for the diffusing member end cap 22210 and the second end cap 13 to be mounted and fixed. The insertion block 222102 is inserted into the corresponding insertion hole 131 to achieve the connection between the diffusing member end cap 22210 and the second end cap 13, so as to complete the assembly of the overall structure of the lamp body.

As shown in FIG. 54, the diffusing member end cap 22210 may further be provided with a sensor 6. The sensor 6 can sense an external environmental state, such as light intensity, temperature, humidity, or other data. A light output state of the lamp is regulated based on external data.

As shown in FIG. 54 and FIG. 55, in an embodiment, the LED lighting device is further provided with an emergency power supply module 34 that is disposed on the power supply module 3 and shares the power supply circuit board 31. The emergency power supply module 34 includes an emergency power supply 341 and an energy storage battery 52 that are disposed on the power supply circuit board 31. The emergency power supply 341 and the energy storage battery 52 are electrically connected by leads. Once the first power supply 32 loses power, the emergency power supply 341 is triggered to start and continue to supply power. Preferably, the diffusing member end cap 22210 is correspondingly provided with an emergency test switch 343 and an emergency indicator light 344. The emergency test switch 343 is used as a switch for checking safety and maintenance of the LED lighting device. After the emergency test switch 343 is pressed, the emergency indicator light 344 is turned on to indicate whether the emergency power supply module 34 works normally.

As shown in FIG. 63A that is a schematic diagram of surface brightness of a lampshade in a square state according to an embodiment of the present application, the brightness of the lampshade changes with a distance between the light beads and a distance between the light beads and the lampshade changes. FIG. 63A is a schematic diagram of surface brightness of a square lampshade in a state where a distance between light beads and the lampshade is 32.8 mm and a distance between the light beads is 8 mm. FIG. 63B is a schematic diagram of illuminance of an illuminated surface at a distance of 2.5 m. FIG. 63C is a light distribution curve at this distance.

FIG. 64A is a schematic diagram of surface brightness of a lampshade in a state where a distance between light beads and the arc-shaped lampshade is 32.8 mm. FIG. 64B is a schematic diagram of illuminance of an illuminated surface at a distance of 2.5 m. FIG. 64C is a light distribution curve at this distance.

In some embodiments, the top and side surfaces of the diffusing member 222 have the same light transmittance.

In some embodiments, there may be significant difference in the light transmittance of the top and side surfaces of the diffusing member 222, such as transparency or semi-transparency.

In an embodiment of the present application, referring to FIG. 24B, in an embodiment of the present application, one side of the base 11 close to the back plate 12 is provided with at least one protrusion with a trapezoidal or V-shaped cross section along the length or width direction, that is, a protrusion structure integrally formed on the base 11 has an inclined surface pointing to the back plate. The inclined surface may be provided with at least one light-emitting unit 21. The inclined surface may also be provided with a light-emitting assembly. In this embodiment, at least one first light-emitting assembly or second light-emitting assembly is disposed on the inclined surface. The first light-emitting assembly or the second light-emitting assembly is attached to the inclined surface, so that at least a part of the light emitted from the light-emitting unit 21 (or the first light-emitting assembly or the second light-emitting assembly) points to the back plate 12. The back plate 12 may be an inclined plane or an arc surface. The base 11 is further provided with a light processing unit 22. The light processing unit 22 may be a diffusing member 222.

The diffusing member 222 at least partially covers a part of the light-emitting unit 21, and can emit and diffuse the light emitted from the light-emitting unit. The back plate 12 has a light reflection function. At least part of the light processed by the light processing unit 22 is directly emitted from the light processing unit, and at least part of the light processed by the light processing unit 22 (or the diffusing member 222) is projected to the back plate 12 and finally is emitted from the LED lighting device after being reflected by the back plate 12, making the LED lighting device emit light more uniformly. In an embodiment of the present application, a power supply module 3 is disposed on one side of the back plate 12 close to the base 11. The height of the power supply module 3 is less than or equal to a distance between a highest end of the back plate 12 and the bottom plate 111 of the base 11.

Referring to FIG. 65 and FIG. 66. FIG. 65 is a schematic front view of an LED lighting device in an embodiment of the present application. FIG. 66 is a schematic back view of an LED lighting device in an embodiment of the present application. As shown in FIG. 65, the LED lighting device includes a support unit 1. The support unit 1 serves as a main frame of the LED lighting device. Other components of the LED lighting device are mounted based on the support unit 1, and the support unit 1 is configured to determine the overall shape of the LED lighting device. In an embodiment of the present application, the support unit 1 is roughly in a horn shape, that is, an opening in one end of the support unit is smaller than an opening in the other end thereof. The diffusing member 222 is disposed at the end with the small opening. The diffusing member 222 is disposed at the end of the support unit 1 with the small opening. The diffusing member 222 bears against the support unit 1 and forms a relatively complete light output surface together with the support unit 1.

Referring to FIG. 66, the support unit 1 is also connected to the base 11, that is, the base 11 covers the small end of the support unit 1, and the base 11 and the diffusing member 222 abut against each other and form a relatively closed accommodating space. Some electronic elements and optical devices are disposed in the relatively closed accommodating space.

Referring to FIG. 67. FIG. 67 is an exploded view of an LED lighting device in a front direction in this embodiment. As shown in the figure, the support unit 1 includes multiple back plates 12. The back plates 12 are connected end to end to form a barrel-shaped structure. The back plates 12 are inclined relative to the horizontal plane, so that an opening of the barrel-shaped structure formed by the back plates 12 is large at one end and small at the other end, that is, a horn-shaped structure is formed. One end of the back plate 12 along the light output direction of the LED lighting lamp, namely one end with the large opening is bent along the horizontal direction to form a combining portion 122 with a certain length. The combining portion 122 is flat and forms a plane. When the LED lighting device is mounted, the combining portion 122 is usually attached to the mounting plane, such as a ceiling. The combining portion 122 with the flat surface can make the LED lighting device have a better appearance when used in bottom-up line of sight after mounting. The other end of the back plate 12, namely one end with the small opening is provided with multiple connecting portions 124 or at least one connecting portion 124. The connecting portion 124 extends from one end of the back plate 12 and is configured to connect and fix the bottom plate 11. The connecting portion 124 is provided with at least one open hole. The open hole corresponds to an open hole on the bottom plate 11. A bolt or a rivet passes through the open hole in the connecting portion 124 and the open hole on the bottom plate 11 to fix the bottom plate 11 and the support unit 1. One end of the bottom plate 11 is provided with at least one first base sidewall 112 and two second base sidewalls 113.

In this embodiment, the first base sidewall 112 is formed in a manner that the bottom plate 11 extends to one side, and the second base sidewall 113 is formed separately. One first base sidewall 112 and two second base sidewalls 113 are mutually combined to form a semi-closed accommodating space for accommodating the power supply module 3. The semi-closed space formed by the first base sidewall 112 and the second base sidewalls 113 is attached to the back plate 12 to form a relatively sealed space for accommodating the power supply module. In this way, it is not necessary to separately provide a power supply box for accommodating the power supply module 3, thereby reducing costs of the lamp.

In this embodiment, a light-emitting unit 21 is further included. The light-emitting unit 21 is disposed on the bottom plate 11 and completely covered by the diffusing member 222. The diffusing member 222 is clamped and fixed by the support unit 1 and the bottom plate 11. During assembly, only the bottom plate 11 and the support unit 1 need to be locked to achieve the fixation of the diffusing member 222, and there is no need for additional fixation of the diffusing member 222. A conventional diffusing member is generally disposed on one side of a certain component and fixed by means of, for example, adhesion or others, and the other side of the diffusing member is the relatively weak side in fixation. In this embodiment, the diffusing member 222 is clamped and fixed by the support unit 1 and the bottom plate 11, so that two sides of the diffusing member 222 can be both limited by the components, and there is no risk of falling of the diffusing member 222. Moreover, the way of connection between the diffusing member 222 and the support unit 1 and the bottom plate 11 is different from a conventional connection way of adhesion or welding. During replacement of the components, the disassembly is simple without damaging the original components.

Referring to FIG. 68. FIG. 68 is a schematic structural diagram of an LED lighting device after combination of a bottom plate 11 and a diffusing member 222 in this embodiment. As shown in the figure, in this embodiment, the two first base sidewalls 112 and the four second base sidewalls 113 form two semi-closed accommodating spaces, where at least one semi-closed accommodating space is used to accommodate the power supply module 3, and the other semi-closed accommodating space can be used to accommodate other electronic elements or emergency power supplies. The edge of the diffusing member 222 is further provided with multiple (at least one) limiting members 2226. The limiting members extend along a direction parallel to the bottom plate 11 and extend beyond the small opening of the support unit 1 to interfere with one end of the back plate 12 so as to restrict the movement of the diffusing member 222 along the light output direction of the LED lighting device.

Referring to FIG. 69. FIG. 69 is a schematic structural diagram of an LED lighting device after combination of a bottom plate 11 and a diffusing member 222 in the present application from another perspective. As shown in the figure, multiple (or at least one) reinforcing structures 114 are disposed on the bottom plate 11. The reinforcing structures 114 are of a groove-shaped structure and protrude in a direction opposite to the light output direction of the LED lighting device, that is, the surface provided with the light-emitting unit 21 is in a groove structure. The light-emitting unit 21 is disposed in the reinforcing structure 114 (the groove structure), which can effectively achieve the positioning of the light-emitting unit.

Referring to FIG. 70 that is a schematic diagram in which a light-emitting unit 21 is disposed in a reinforcing structure 114. The light-emitting unit 21 includes multiple first light-emitting assemblies 2111, with the structure as in the previous description of the light-emitting assemblies.

Referring to FIG. 71 and FIG. 74. FIG. 71 is a schematic structural diagram of an LED lighting device in an embodiment of the present application. FIG. 74 is a schematic diagram of an LED lighting device in an embodiment of the present application from another perspective. The LED lighting device 100 includes a support unit 1. The support unit 1 serves as a main structure of the LED lighting device 100. The support unit 1 includes a base 11 and a back plate 12. In this embodiment of the present application, the base 11 and the back plate 12 are integrally formed. The base 11 includes a bottom plate 111. The bottom plate 111 is a flat surface. The back plate 12 is a curved surface extending outwards from two ends of the base 11 (or the bottom plate 111). The base 11 has a groove structure in which the photoelectric module 2 is disposed. One side facing the light output direction of the LED lighting device is referred to as a front side, and one side facing away from the light output direction of the LED lighting device is referred to as a back side. The back side of the base 11 is provided with a power supply module 3. The power supply module 3 is attached to the base 11, or the power supply module 3 is attached to the back side of the support unit 1, and at least part of the power supply is disposed in a space formed by the radian of the back plate 12. The overall shape of the LED lighting device 100 is rectangular, and the photoelectric module 2 extends along the length or width direction of the LED lighting device.

Referring to FIG. 72 that is a schematic exploded view of an LED lighting device 100 in an embodiment of the present application. As shown in the figure, the support unit 1 of the LED lighting device 100 includes a base 11, a back plate 12 extending integrally at two ends of the base 11, and two sidewalls 13. The base 11, the back plate 12, and the two sidewalls 13 are mutually connected to form an accommodating space. One end of the back plate 12 is connected to the base 11, and one end thereof away from the base 11 up-warps and extends towards one side of the light output direction of the lamp, or at least two ends up-warp in the same direction relative to a plane. Further, the back plate 12 may be formed in a manner that two opposite ends of a rectangular panel are bent in the same direction.

In an embodiment of the present application, the back plate 12 is a rectangular panel in a non-bent state, and a long edge thereof is bent towards the center, that is, the long edge is symmetrically bent to form an arc-shaped back plate 12.

In an embodiment of the present application, the bottom plate 111 is a flat bottom plate, and the back plate 12 is an arc plate extending from the two sides of the bottom plate 111. The arc surface is bent in the same side of the bottom plate 111.

In an embodiment of the present application, the back plate 12 is an arc-shaped back plate, two sides of the bottom plate 111 are both provided with back plates 12, and the back plates 12 on the two sides of the bottom plate 111 are symmetrical to each other with respect to the bottom plate 111. The sidewall 13 matches with the back plate 12 to form an arc-shaped space. The photoelectric module 2 is disposed in the arc-shaped space. One edge of the sidewall 13 is connected to an arc edge of the back plate 12, that is, one edge of the sidewall 13 is an arc-shaped edge as same as the arc edge of the back plate 12, and the other opposite edge is a straight edge. The arc-shaped edge of the sidewall is attached to the long edge of the back plate 12, and the straight edge of the sidewall forms a plane with the short edge of the back plate 12, thus forming a regular arc-shaped space.

The photoelectric module 2 is disposed in the arc-shaped space and is perpendicular to the surface of the sidewall 13, that is, the photoelectric module is disposed along the short edge direction of the back plate 12. The photoelectric module 2 includes a mounting bracket 26, a light-emitting unit 21, and a light processing unit 22. The light-emitting unit 21 includes a first light-emitting assembly 21. The light processing unit 22 includes a first optical member 224, a second optical member 225, and a third optical member 226. The mounting bracket 26 is disposed along the short edge direction of the back plate 12 (or the bottom plate 111), that is, the mounting bracket is disposed between two parallel sidewalls 13, and the mounting bracket is attached to the bottom plate 111. Preferably, the mounting bracket 26 is disposed in the middle of the length of the bottom plate 111.

Referring to FIG. 72 and FIG. 73. FIG. 73 is a schematic diagram of a cross-section of a photoelectric module 2 along its width direction in an embodiment of the present application.

As shown in the figure, the mounting bracket 26 is disposed on the bottom plate 111. The mounting bracket 26 has a first mounting base 261 and a second mounting base 262, where the second mounting base 262 is inclined relative to the first mounting base surface 261. In an embodiment of the present application, there are two second mounting bases 262 disposed along the length direction of the mounting bracket 26, where the first mounting base 261 is attached to the bottom plate 111 directly or indirectly, and the two second mounting bases 26 are fixed by means of glue, welding, clamping buckles, embedding, screws and nuts, etc.

Referring to FIG. 73, a surface of the first mounting base 261 relatively far away from the bottom plate 111 is provided with a first light-emitting assembly 211. The first light-emitting assembly 211 extends along the length direction of the first mounting base 261 and includes a first circuit board 2111 and at least one first light-emitting body 2112 disposed on one side of the first circuit board 2111 away from the first mounting base surface 261, where the first circuit board 2111 is a board capable of directly or indirectly achieving electrical conduction, such as a PCB, an FPC, an aluminum substrate, or a BT substrate. The first light-emitting body 2112 includes an array composed of multiple LED chips, or an array composed of other light sources or a single light source. In an embodiment of the present application, the first circuit board 2111 is provided with at least one first light-emitting body 2112, and a light output direction of the first light-emitting body 2112 points to a direction away from the bottom plate 111. Along the light output direction of first light-emitting body 2112, a first optical member 224 is correspondingly provided. The first optical member 224 is a roughly hemispherical structure, and completely covers the first light-emitting body 2112, so that the first light-emitting body 2112 is accommodated in a relatively sealed space formed by the first optical member 224 and the first mounting base 261, and the first light-emitting body 2112 is relatively isolated from the external environment, thereby protecting the first light-emitting body 2112. The first optical member 224 is roughly in a spherical structure with multiple protrusions, and can diffuse light emitted from the first light-emitting body 2112. At least part of the light emitted from the first light-emitting body 2112 is directly emitted from the first optical member 224.

In an embodiment of the present application, the first optical member 224 has an extension portion 2241 attached to the first mounting base 261, and the extension portion 2241 is disposed along the edge of the first optical member 224. The first optical member 224 has a specific surface shape. In an embodiment, its radial section is an outwards protruding arc surface, which can achieve light transmission and light diffusion functions.

The second optical member 225 is disposed along the length direction of the mounting bracket 26. In an embodiment, the second optical member 225 is composed of multiple light reflecting cups 2251. The multiple light reflecting cups 2251 are integrally formed to form the second optical member 225. The light reflecting cup 2251 is empty from top to bottom, and an opening at one end is smaller than an opening at the other end. That is, a projection of the large end perpendicular to the direction of the first mounting base surface 261 can fully contain a projection of the small end in the direction of the first mounting base surface 261. In other words, the light reflecting cup 2251 has a small opening and a large opening. The small (opening) end of the light reflecting cup 2251 abuts against the extension portion 2241 of the first optical member 224, so that the first optical member 224 is contained in a cup body of the light reflecting cup 2251, and the first optical member 224 is tightly pressed on the first circuit board 2111. In the present application, the height of the first optical member 224 is less than or equal to the height of the light reflecting cup 2251, that is, the height of the first optical member is less than or equal to the height of the second optical member 225 (the height is only along the light output direction).

In an embodiment of the present application, the first optical member 224 is a free-form surface lens, and matches with the light reflecting cup 2251 to achieve large-angle light output of the bat-wing light pattern. The free-form surface lens, namely the first optical member 224 achieves the large-angle light output and light distribution of uniform illuminance, and the light reflecting cup 2251 constrains a light output angle and mixes light spots to a certain extent to facilitate the effect of uniform illuminance.

The second mounting base 262 of the mounting bracket 26 is disposed along its length direction. The two second mounting base 262 are spaced apart by a certain distance, so that the first light-emitting assembly 211 is placed between the two second mounting base 262. That is, the minimum spacing between the two second mounting base 262 along the width direction of the mounting bracket 26 is greater than or equal to the size of the first light-emitting assembly 211 along the width direction of the mounting bracket 26. In other words, the two second mounting base 262 of the mounting bracket 26 form an accommodating space with the first mounting base 261, and the first light-emitting assembly 211 is disposed in the accommodating space. The second mounting base 262 is integrally formed with the mounting bracket 26. The second mounting base 262 includes a first bent plate 2621 and a second bent plate 2622. A second light-emitting assembly 212 is disposed on an outer side surface of the first bent plate 2621, that is, the second light-emitting assembly 212 is disposed outside the accommodating space. The composition of the second light-emitting assembly 212 is the same as that of the first light-emitting assembly 211. The second light-emitting assembly 212 achieves lateral light output. That is, light is emitted towards a bent arc surface of the back plate 12. In other words, the first light-emitting assembly 211 and the second light-emitting assembly 212 provide light output in different directions. One end of the first bent plate 2621 is connected to the first mounting base 261, and the other opposite end thereof is connected to the second bent plate 2622. One end of the second bent plate 2622 is connected to the first bent plate 2621, and the other opposite end thereof is provided with a connecting portion 22511. The connecting portion 22511 is a flat bearing surface for bearing the second optical member 225, namely bearing the large opening end of the light reflecting cup 2251. One side of the connecting portion 22511 facing the first mounting base 261 is provided with a first insertion groove 225110, and correspondingly, the first mounting base 261 is also provided with a second insertion groove 2311. A third optical member 226 which is a sheet-like light processing element is inserted into the first insertion groove 225110 and the second insertion groove 2311 to be fixed, and is located in the light output direction of the second light-emitting assembly 212. The third optical member 226 includes at least two light processing functions of light diffusion and light transmission. In some embodiments, the third optical member 226 may be a diffusing plate. In this embodiment, as the mounting bracket 26 has two second mounting base 262, two second light-emitting assemblies 212 are disposed on two first bent plate 2621 respectively, that is, two third optical members 226 are disposed in the light output directions of the two second light-emitting assemblies 212 respectively. In other embodiments of the present application, only one second light-emitting assembly 212 and one third optical member 226 are provided. The first light-emitting assembly 211 and the second light-emitting assembly 212 are matched with the first optical member 224, the second optical member 225, and the third optical member 226, so that the LED lighting device 100 has at least two different forms of light output. That is, one part of light is emitted after the light emitted from the first light-emitting assembly 211 is processed by the first optical member 224 and the second optical member 225; and the other part of the light is emitted from the second light-emitting assembly 212, which is projected to the bottom plate 111 (or the back plate 12) through the third optical member 226 and finally is emitted from the LED lighting device 100 after being reflected by the bottom plate 111 (or the back plate 12). In this way, the LED lighting device has good light output in its center and side direction, emits light uniformly, and is prevented from possible dark regions, has uniform illuminance in the center and periphery, and drops in glare.

In an embodiment of the present application, the second mounting base 262 and the first mounting base 261 are independently formed and then assembled.

In an embodiment of the present application, the first bent plate 2621 and the second bent plate 2622 are provided with at least one second light-emitting assembly 212.

In an embodiment of the present application, the second mounting base 262 is a flat rectangular panel.

In an embodiment of the present application, the third optical member 226 is an arc surface that protrudes outward along the light output direction of the second light-emitting assembly 212.

In an embodiment of the present application, the third optical member 226 is an arc surface that is recessed inwards along the light output direction of the second light-emitting assembly 212.

In an embodiment of the present application, at least a part of light emitted from the first light-emitting assembly 211 is directly emitted from the LED lighting device 100 after being processed by the first optical member 224;, at least a part of the light processed by the first optical member 224 is refracted onto an inner wall (one side of the light reflecting cup 2251 close to the first light-emitting assembly 211) of the light reflecting cup 2251, reflected once by the inner wall of the light reflecting cup 2251, and then directly emitted.

In an embodiment of the present application, at least a part of light emitted from the first light-emitting assembly 211 is processed by the first optical member 224, refracted to the inner wall of the light reflecting cup 2251 (one side of the light reflecting cup 2251 close to the first light-emitting assembly 211), and reflected at least once by the inner wall of the light reflecting cup 2251, and then reflected at least once by the outer wall of the first optical member 224 (the surface of the first optical member 224 away from the first light-emitting assembly 211), and emitted from the LED lighting lamp 100.

Referring to FIG. 74, a schematic back view of an LED lighting device in an embodiment of the present application. The LED lighting device 100 further includes a power supply module 3. The power supply module 3 is disposed on one side of the support unit 1 facing away from the light output direction and is attached to the arc surface of the back plate 12. The arc surface of the back plate 12 serves as a part of the packaging structure of the power supply module 3, thereby reducing production costs. The power supply module 3 can control the light sources of the LED lighting device 100. Specifically, the power supply module can control the first light-emitting assembly 211 and the second light-emitting assembly 212 separately. The light dimming and color regulating functions of the LED lighting device are achieved by match between the first light-emitting assembly 211 and the second light-emitting assembly 212.

In an embodiment of the present application, the light dimming and color regulating functions of the LED lighting device may also be achieved by simultaneously controlling the first light-emitting assembly 211 and the second light-emitting assembly 212 through the power supply module 3.

In an embodiment of the present application, the base 11 and the sidewall 13 are integrally formed, for example, the base and the sidewall are formed by integrally stamping a metal material.

Referring to FIG. 75 and FIG. 76. FIG. 75 is a schematic front view of an LED lighting device in an embodiment of the present application. FIG. 76 is a schematic back view of an LED lighting device in this embodiment of the present application.

As shown in FIG. 75, the LED lighting device 100 includes a support unit 1.

The support unit includes a base 11, two back plates 12 disposed on two sides of the base 11 respectively, and two sidewalls 13. The base 11, the back plates 12, and the sidewalls 13 are connected to one another. The support unit 1 serves as a main frame of the LED lighting device and is configured to mount relevant components of the LED lighting device. The base 11 includes a bottom plate 111. The bottom plate 111 is a flat surface. The back plate 12 is an arc-shaped structure with two sides bending and extending in the same direction, that is, the base 11, the two back plates 12, and the two sidewalls 13 form a concave structure or an accommodating space.

At least two ends of the bottom plate of the back plate 12 are up-warped in the same direction. Further, the back plate 12 can be formed in a manner that two opposite ends of a rectangular panel are bent in the same direction.

In an embodiment of the present application, the back plate 12 is a rectangular panel in a non-bent state, and a long edge thereof is bent upward, that is, the long edge is symmetrically bent to form an arc-shaped back plate 12.

In an embodiment of the present application, the base 11 has a flat bottom plate 111. The sidewall 13 matches with the back plate 12 and the base 11 to form an arc-shaped concave (with a relatively flat middle). The photoelectric module 2 is disposed in the arc-shaped concave. One edge of the sidewall 13 is connected to an arc edge of the back plate 12, that is, one edge of the sidewall 13 is an arc-shaped edge as same as that of the back plate 12, and the other opposite edge is a straight edge. The straight edge of the sidewall is coplanar with the edge of the back plate 12 away from the bottom plate 111, thus forming a regular arc-shaped concave. One end of the support unit 1 along the light output direction is provided with an outer frame 4. The outer frame 4 is fixed to the sidewall 13 and the back plate 12 to enhance the structural strength of the LED lighting device and improve the aesthetics of the LED lighting device. At the arc-shaped portion of the back plate 12, a power supply module 3 (or a driving module) is disposed outside the arc-shaped concave of the support unit 1.

Referring to FIG. 76. FIG. 76 is a schematic back view of an LED lighting device in an embodiment of the present application. As shown in the figure, the power supply module 3 is attached to the outside surface of the arc-shaped back plate 12 and at least partially overlaps with the bottom plate 111, which can minimize the size of the LED lighting device. The LED lighting device 100 further includes a hanging support member 5. The hanging support member 5 can be disposed on the sidewall 13, the bottom plate 111, the back plate 12, or the outer frame 4. In an embodiment of the present application, the hanging support member is disposed on one or more positions on the outer frame 4 by means of screws or welding, and is configured to connect and fix the LED lighting device to a usage environment. The bottom plate 111 is provided with a bottom plate mounting portion 1111. The bottom plate mounting portion 1111 protrudes toward the light output direction of the LED lighting device, that is, it is a groove structure when viewed from the back surface of the LED lighting device. The bottom plate mounting portion is also referred to as a bottom plate reinforcement structure. In this embodiment of the present application, there are two bottom plate mounting portions 1111 perpendicular to the sidewall 13. The two bottom plate mounting portions 1111 are parallel to each other. The bottom plate mounting portion 1111 is integrally formed with the bottom plate 111 by means of a stamping process, that is, the bottom plate mounting portion 1111 is directly formed by stamping the bottom plate 111 without additional materials.

Referring to FIG. 77. FIG. 77 is a schematic structural diagram of a base plate in an embodiment of the present application. As shown in the figure, the bottom plate mounting portion 1111 is integrally formed on the bottom plate 111, that is, the bottom plate 111 is integrally stamped along the light output direction of the LED lighting device to form the bottom plate mounting portion 1111. The bottom plate mounting portion protrudes toward the light output direction of the LED lighting device, and is a groove structure when observed from outside of the bottom plate 111, and extends along the length direction of the bottom plate 111. In some embodiments, the bottom plate mounting portion may also extend in other directions, such as the width direction. In this embodiment, the bottom plate mounting portion 1111 is a polygonal frustum structure extending along the length direction of the bottom plate 111, and has a flat top surface and two side surfaces, where the top surface is roughly parallel to the bottom plate 111 and the side surfaces roughly points to the back plate 12. In the present application, on one hand, the bottom plate mounting portion 1111 may achieve the function of a reinforcing rib, that is, the planar structure of the bottom plate 111 is a three-dimensional spatial structure without additional materials to improve its overall strength; and on the other hand, the bottom plate mounting portion 1111 may also be used as a light source mounting portion, that is, its polygonal frustum surface can be attached with a light source board, and multiple polygonal frustum surfaces are simultaneously provided with light source boards to achieve light output in multiple directions.

Referring to FIG. 78 to FIG. 80. FIG. 78 shows an exploded view of an LED lighting device in an embodiment of the present application. FIG. 79 shows a sectional view of an LED lighting device along a direction parallel to a sidewall in an embodiment of the present application. FIG. 80 shows an enlarged view of part E in FIG. 79. Referring to FIG. 78 and FIG. 79, in an embodiment of the present application, the photoelectric module 2 includes a light processing unit 22. The light processing unit 22 includes a diffusing member 222 and diffusing member end caps 22210 disposed at two ends of the diffusing member 222. The diffusing member 222 is in an arched shape, that is, the middle is flat and two sides are bent down. The diffusing member 222 is fixed to the relatively flat part of the bottom plate 111 or the back plate 12, and two ends thereof are sealed by the diffusing member end caps 22210.

With reference to FIG. 78 and FIG. 79, the bottom plate 111 is provided with a first light-emitting assembly 211 and two second light-emitting assemblies 212, where the first light-emitting assembly 211 is disposed between the two second light-emitting assemblies 212, the diffusing member 222 completely covers the first light-emitting assembly 211 and the second light-emitting assemblies 212, and the diffusing member 222, the bottom plate 111, and the diffusing member end caps 22210 are combined to form an enclosed space for accommodating the first light-emitting assembly 211 and the second light-emitting assemblies 212.

The power supply module 3 includes a power supply box 35 and a first power supply 32. With reference to FIG. 78 and FIG. 79, the first power supply 32 is disposed in the power supply box 35, and parts of the power supply box 35 are attached to the back plate 12, thereby minimizing the impact of the arrangement of the first power supply 32 on the size of the LED lighting device while ensuring the appearance integrity of the lamp.

Referring to FIG. 79 and FIG. 80, the bottom plate 111 is provided with a first light-emitting assembly 211 and two second light-emitting assemblies 212, where the first light-emitting assembly 211 is directly attached to the bottom plate 111. The second light-emitting assembly 212 is disposed on the bottom plate mounting portion 1111, that is, the second light-emitting assembly is attached to the inclined surface of the bottom plate mounting portion 1111 in the light output direction of the LED lighting device, and the light output direction of the second light-emitting assembly 212 roughly faces the back plate 12. In this embodiment of the present application, the included angle between the second light-emitting assemblies 212 is acute, that is, one ends of the two second light-emitting assemblies 212 away from the bottom plate 111 are close to each other. The inclined edge of the second light-emitting assembly exactly covers the inclined surface of the bottom plate mounting portion 1111. The first light-emitting assembly 211 is directly attached to the bottom plate 111. In an embodiment, the bottom plate 111 may also be provided with a groove structure to accommodate the first light-emitting assembly 211. The first light-emitting assembly 211 and the second light-emitting assembly 212 have different light output directions, that is, the light source of the LED lighting device has at least two different directions of light output, thereby reducing or avoiding the formation of obvious dark regions on the LED lighting device. After light emitted from the second light-emitting assembly 212 is processed by the diffusing member 222, at least part of the light is directly emitted out of the LED lighting device from the diffusing member 222 (or the light processing unit 22), and at least part of the light is projected to the back plate 12 and finally is emitted from the LED lighting device after being reflected by the back plate 12.

In an embodiment of the present application, after light emitted from the second light-emitting assembly 212 is processed by the diffusing member 222, at least part of the light is directly emitted out of the LED lighting device from the diffusing member 222 (or the light processing unit 22), and at least part of the light is projected to the back plate 12, is reflected to the diffusing member 222 (or the light processing unit 22) again after being reflected by the back plate 12, and finally is emitted from the LED lighting lamp after being reflected by the diffusing member 222 (or the light processing unit 22).

In an embodiment of the present application, after light emitted from the first light-emitting assembly 211 is processed by the diffusing element 222 (or the light processing unit 22), at least part of the light is directly emitted out of the LED lighting device from the diffusing member 222 (or the light processing unit 22), and at least part of the light is projected to the back plate 12 and finally is emitted from the LED lighting device after being reflected by the back plate 12.

In an embodiment of the present application, after light emitted from the first light-emitting assembly 211 is processed by the diffusing element 222 (or the light processing unit 22), at least part of the light is directly emitted out of the LED lighting device from the diffusing member 222 (or the light processing unit 22), and at least part of the light is projected to the back plate 12, is reflected to the diffusing member 222 again after being reflected by the back plate 12, and finally is emitted from the LED lighting device after being reflected by the diffusing member 222.

In an embodiment of the present application, at least a part of light emitted from the first light-emitting assembly 211 is directly emitted after being processed by the diffusing member 222 (or the light processing unit 22).

Referring to FIG. 81 which is a schematic diagram of a second light-emitting assembly 212 in an embodiment of the present application. The second light-emitting assembly 212 includes two second circuit boards 2121 arranged at an acute angle. A second light-emitting bodies 2122 are disposed on the second circuit board 2121 along the length direction. The second light-emitting bodies 2122 may be an LED chip array.

In an embodiment of the present application, the diffusing member 222 (or the light processing unit 22) is made of a material such as glass, resin, or PC.

In an embodiment of the present application, the diffusing member 222 (or the light processing unit 22) has one or more functions of light transmission, light refraction (or diffusion), light reflection, and light diffraction due to its own material.

In an embodiment of the present application, the surface of the diffusing member 222 (or the light processing unit 22) is patterned, for example, a special microstructure array is provided on its surface to change the light output effect, such as to reduce glare of the lamp.

Referring to FIG. 82 and FIG. 83. FIG. 82 is a schematic front view of an LED lighting device in an embodiment of the present application. FIG. 83 is a schematic back view. As shown in the figures, the basic structure of the LED lighting device is basically the same as described above, including a support unit 1 as a main body of the lamp. The support unit 1 includes a base 11, two back plates 12 respectively connected to a long edge of the base 11, and two sidewalls 13 respectively connected to a short edge of the base 11 and two short edges (curved edges) of the two back plates 12. The base 11, the back plates 12, and the sidewalls 13 are mutually connected to form a concave-shaped accommodating space for accommodating a photoelectric module 2, that is, at least part of the photoelectric module 2 is accommodated in the accommodating space. The base 11 includes a flat bottom plate 111. The back plate 12 includes an arc-shaped curved surface. A front surface of the curved surface is an inwards recessed diffuse reflection surface for diffusing and reflecting light, and a back surface of the curved surface is an outwards protruding surface for mounting a power supply module 3. Long edges of the base 11 is connected to the back plate 12, and the long edges on two sides of the base 11 are both connected to the back plate 12. In some embodiments, the base 11 and the back plate 12 are designed separately and assembled. In some embodiments, the base 11 and the back plate 12 are integrally formed. The photoelectric module 2 is disposed on the base 11. The photoelectric module 2 includes a diffusing member 222. Two ends of the diffusing member 222 are provided with diffusing member end caps 22210. The diffusing member end caps 22210 fix the diffusing member 222 to the base 11 and form an enclosed space with the base 11. A sensor 6 is disposed on the diffusing member end cap 22210 to sense external environmental information and transmit the environmental information to the power supply module 3 (as shown in FIG. 83). The power supply module 3 control light output of the LED lighting device based on the information transmitted by the sensor 6. The LED lighting device further includes an outer frame 4. The outer frame 4 is disposed on the sidewall 13 and the back plate 12 to further fix the sidewall 13 and the back plate 12. The power supply module 3 is disposed on the back surface of the back plate 12. The power supply module 3 includes a power supply box 35 and a junction box 36. The power supply box 35 is integrally formed with the junction box 36, and the power supply box 35 and the junction box 36 are perpendicular to each other, that is, the power supply box and the junction box are disposed on adjacent edges of the LED lighting device. In an embodiment of the present application, the junction box 36 is fixed to the back surface of the back plate 12 and attached to the curved surface of the back plate 12. The power supply box 35 is further connected to the sidewall 12. The power supply box 35 is provided with a color temperature regulating switch 351 and a light intensity regulating switch 352, so that the LED lighting device can achieve different color temperatures and light intensity outputs under the control of the color temperature regulating switch 351 and the light intensity regulating switch 352.

In an embodiment of the present application, the base 11 is provided with an integrally formed bottom plate mounting portion 1111. The bottom plate mounting portion 111 is implemented as a protrusion inside the accommodating space formed by the base 11, the back plates 12, and the sidewalls 13, and is a trapezoidal protrusion.

Referring to FIG. 84 that is an exploded view of an LED lighting device in an embodiment of the present application. As shown in the figure, the photoelectric module 2 further includes a light-emitting unit 21. The light-emitting unit 21 is disposed on the bottom plate mounting portion 1111 of the base 11 that is on the trapezoidal protrusion structure, and the light-emitting unit 21 extends along the length direction of the bottom plate mounting portion 1111. The diffusing member 222 is disposed in the light output direction of the light-emitting unit 21 in a covering manner and completely covers the light-emitting unit 21.

Referring to FIG. 85 that is an enlarged view of part F in FIG. 84. As shown in the figure, the light-emitting unit 21 includes a first light-emitting assembly 211 and two second light-emitting assemblies 212. The first light-emitting assembly 211 is roughly parallel to the bottom plate 111, and includes a first circuit board 2111 and at least one first light-emitting body 2112 disposed on the first circuit board 2111. The first light-emitting bodies 2112 are uniformly distributed on the first circuit board 2111.

The second light-emitting assembly 212 includes a second circuit board 2121 and at least one second light-emitting body 2122 disposed on the second circuit board 2121. The second light-emitting bodies 2122 are uniformly distributed on the second circuit board 2121.

The second light-emitting assembly 212 and the first light-emitting assembly 211 are inclined to each other, where an included angle between the surface of the second light-emitting assembly 212 that is provided with the second light-emitting body 2122, and the bottom plate 111 is greater than or equal to 90°, thereby making it easier for light emitted from the second light-emitting body 2122 to be emitted from the LED lighting device.

Referring to FIG. 86 which is an enlarged view of part G in FIG. 84. As shown in the figure, the trapezoidal protrusion of the bottom plate mounting portion 1111 has a top surface 11111 parallel to the bottom plate 111 and two side surfaces 11112 inclined relative to the bottom plate 111, where the first light-emitting assembly 211 is disposed on the top surface 11111 and attached to it, and the two second light-emitting assemblies 212 are respectively disposed on the two side surfaces 11112 and attached to it. That is, the top surface 11111 and the side surface 11112 are inclined to each other, so that the first light-emitting assembly 211 disposed on the top surface 11111 and the second light-emitting assembly 212 disposed on the side surface 11112 are inclined to each other, and the light-emitting unit 21 has at least two directions of light output.

At least a part of the light emitted from the first light-emitting assembly 211 is directly emitted from the diffusing member 222, and at least a part of the light is projected onto the back plate 12 after being emitted from the diffusing member 222 and is emitted out of the LED lighting device after being reflected by the back plate 12. At least a part of the light emitted from the first light-emitting assembly 212 is directly emitted from the diffusing member 222, and at least a part of the light is projected onto the back plate 12 after being emitted from the diffusing member 222 and is emitted out of the LED lighting device after being reflected by the back plate 12.

In some embodiments, all the light emitted from the first light-emitting assembly 211 is directly emitted from the diffusing member 222.

Referring to FIG. 87 that is a schematic diagram of an LED lighting device without a diffusing member in an embodiment of the present application. As shown in the figure, a shortest distance from the light-emitting unit 21 to the long edge of the diffusing member 222 is La, and a vertical distance from the long edge of the diffusing member 222 to the edge of the back plate 12 is Lb, wherein 0.5≤Lb/La≤2, and further 1≤Lb/La≤1.5. In the present application, if the height of the LED lighting device is set to Lc, or a distance from the bottom plate 111 to a highest point of the back plate 12 is Lc, then 1≤La/Lc≤2, and 1≤Lb/Lc≤6.

It is to be noted that the technical features of the above embodiments may be combined arbitrarily. For simplicity of description, all possible combinations of the technical features in the above embodiments are not described. However, the combinations of these technical features should all be considered to be within the scope of this specification as long as there is no contradiction between them.

In summary, on one hand, for the LED lighting device disclosed in the present application, the second light-emitting assembly is obliquely disposed at the periphery of the first light-emitting assembly, so that the light emitted from the second light-emitting assembly is projected to the peripheral region of the first light-emitting assembly, thereby being combined with the light emitted from the first light-emitting assembly to form the high-uniformity light pattern distribution; and further, the light beam control assembly for changing the light output path is disposed on the light output side of the second light-emitting assembly to change the light originally projected to the underlying region of the first light-emitting assembly to be projected to the peripheral region of the first light-emitting assembly, so that the light emitted from the second light-emitting assembly is mainly distributed in the peripheral region of the first light-emitting assembly and is combined with the light emitted from the first light-emitting assembly to form the bat-wing light pattern or the approximate bat-wing light pattern, thereby further improving the uniformity of the light emitted from the lamp. On the other hand, the LED lighting device disclosed in the present application is provided with the third light-emitting assembly of which the center line of the light beam faces the support unit of the LED lighting device, so that regions on the support unit that cannot be illuminated by the first light-emitting assembly can be illuminated, thereby improving the uniformity of light on the surface of the support unit, and avoiding dark regions.

The above embodiments are only illustrative of the principles and effects of the present application, and are not intended to limit the present application. Any of those skilled in the art can modify or change the above embodiments without departing from the spirit and scope of the present application. Therefore, all equivalent modifications or changes made by those of ordinary skill in the art without departing from the spirit and technical ideas of the present application should still be encompassed by the claims of the present application.

1-33. (canceled)

34. An LED lighting device, comprising:
a support unit comprising:
a base plate with four sides, the base plate comprising a mounting portion having a top surface parallel to the base plate and two side surfaces connected to the base plate and the top surface;
two back plates connected to two opposite sides of the base plate respectively, wherein each back plate is an arc-shaped structure; and
two sidewalls connected to another two opposite sides of the base plate respectively, each sidewall further connected to the two back plates, wherein the base plate, the two back plates and the two sidewalls form an accommodating space in the support unit; and
a photoelectric module comprising:
a light-emitting unit mounted on the mounting portion, the light-emitting unit comprising a first light-emitting assembly mounted on the top surface of the mounting portion and two second light-emitting assemblies mounted on the two side surfaces of the mounting portion respectively;
a power supply module disposed outside the accommodating space and connected to one of the back plate, the power supply module electrically connected to the light-emitting unit; and
a light processing unit disposed in the accommodating space and covering the light-emitting unit,
wherein a part of the light emitted from the second light-emitting assembly is emitted to the back plate after passing through the light processing unit.

35. The LED lighting device according to claim 34, wherein the LED lighting device further comprises an outer frame disposed on the two back plates and the two sidewalls and fix to the back plates and the sidewalls.

36. The LED lighting device according to claim 35, wherein the light processing unit comprises a diffusing member and two diffusing end caps disposed at two ends of the diffusing member respectively, the diffusing member is fixed to the base plate through the two diffusing end caps, the diffusing member and diffusing end caps form an enclosed space with the base plate, and the light-emitting unit is disposed in the enclosed space.

37. The LED lighting device according to claim 36, wherein the mounting portion is a protruding strip on the base plate protruded toward the accommodating space.

38. The LED lighting device according to claim 37, wherein a cross-section of the mounting portion is trapezoidal protruding structure, the two side surfaces of the mounting portion are two lateral sides of the trapezoid, the light-emitting unit extends along a length direction of the mounting portion and the diffusing member covers the light-emitting unit.

39. The LED lighting device according to claim 38, wherein an angle between one of the two side surfaces and the top surface is an obtuse angle.

40. The LED lighting device according to claim 39, wherein a light emission direction of the first light-emitting assembly is different from a light emission direction of any one of the two light-emitting assemblies.

41. The LED lighting device according to claim 40, wherein the first light-emitting assembly comprises a first circuit board and a plurality of first light-emitting bodies disposed on the first circuit board, one of the second light-emitting assemblies comprises a second circuit board and a plurality of second light-emitting bodies disposed on the second circuit board.

42. The LED lighting device according to claim 41, wherein a surface of one of the back plates is a diffusive reflective surface.

43. The LED lighting device according to claim 42, wherein the diffusing member is an arc-shaped structure and is made of light-transmitting material.

44. The LED lighting device according to claim 43, wherein the diffusing member comprises microarray structure disposed on a surface thereof.

45. The LED lighting device according to claim 43, wherein the LED lighting device further comprises a sensor disposed on one of the diffusing end caps.

46. The LED lighting device according to claim 45, wherein the power supply module comprises a power supply box and a junction box connected to a back side of one of the back plates.

47. The LED lighting device according to claim 46, wherein the power supply box comprises a color temperature regulating switch and a light intensity regulating switch.

48. The LED lighting device according to claim 47, wherein the power supply module comprises an emergency power supply and an energy storage battery electrically connected to the emergency power supply.

49. The LED lighting device according to claim 43, wherein a shortest distance from the light-emitting unit to a long edge of the diffusing member is La, and a vertical distance from the long edge of the diffusing member to an edge of the back plate is Lb, wherein 0.5≤Lb/La≤2.
